(19) United States
(12) Patent Application Publication
(10) Pub. No.: US 2017/0197854 A1
(43) Pub. Date: Jul. 13, 2017

(54) WATER TREATMENT, FILTRATION AND MANAGEMENT SYSTEMS

(71) Applicant: Chandler Systems, Inc., Ashland, OH (US)

(72) Inventors: William D. Chandler, JR., Ashland, OH (US); Cody A. Harbaugh, Ashland, OH (US); Aaron R. Wolfe, Ashland, OH (US)

(21) Appl. No.: 14/698,399

(22) Filed: Apr. 28, 2015

Related U.S. Application Data
(63) Continuation-in-part of application No. 14/024,918, filed on Sep. 12, 2013, now abandoned.
Application No. 14/024,918 is a continuation-in-part of application No. 13/492,354, filed on Jun. 8, 2012, now Pat. No. 8,535,540.
(60) Provisional application No. 61/986,423, filed on Apr. 30, 2014.
(60) Provisional application No. 62/069,897, filed on Oct. 29, 2014.
(60) Provisional application No. 62/119,507, filed on Feb. 23, 2015.
(60) Provisional application No. 61/607,343, filed on Mar. 6, 2012.
(60) Provisional application No. 61/513,450, filed on Jul. 29, 2011.
(60) Provisional application No. 61/494,449, filed on Jun. 8, 2011.

(51) Int. Cl. C02F 1/74

(52) U.S. Cl. CPC C02F 1/74; C02F 2303/04

(57) ABSTRACT

A water treatment and filtration apparatus includes an enclosed water treatment tank. The water treatment tank includes an upper area with an air pocket and a lower area including filter media. A tube extends in the tank between the upper and lower areas and includes a tube opening in the upper area. A fluid control valve is operative to receive untreated water including oxidizable contaminants. The valve is selectively operative to cause untreated water to be passed through the tube and into the air pocket where the contaminants undergo oxidation. The water is filtered through the media in the tank and passed through the valve which delivers filtered water therefrom. The valve is also selectively operative to enable backflushing of the filter media, air to be released from the upper area of the tank, and air and disinfectant to be introduced into the tank.

### CROSS-REFERENCE TO RELATED APPLICATIONS

This application claims benefit pursuant to 35 U.S.C. §119(e) of Provisional Application Nos. 61/986,423 filed Apr. 30, 2014; 62/069,897 filed Oct. 29, 2014; and 62/119,507 filed Feb. 23, 2015, the disclosures of each of which are incorporated herein by reference in its entirety.

This application is also a continuation-in-part of U.S. Ser. No. 14/024,918 filed Sep. 12, 2013; which is a continuation-in-part of U.S. Ser. No. 13/492,354 filed Jun. 8, 2012 which claims benefit to 35 U.S.C. §119(e) of Provisional Application Nos. 61/607,343 filed Mar. 6, 2012; 61/513,450 filed Jul. 29, 2011; and 61/494,449 filed Jun. 8, 2011, the disclosures of each of which is incorporated herein by reference in its entirety.

### TECHNICAL FIELD

This application relates to water treatment, filtration and management systems and components thereof. Exemplary embodiments include water treatment and management devices such as water filters and water softeners, and components such as valves, sensors and control devices used in such systems.

### BACKGROUND

Water sources such as wells, lakes, reservoirs and public water systems are often not suitable for drinking and/or other residential and commercial uses. Water treatment systems have been devised for removing undesirable materials from water to make the water better suited for drinking and other residential and commercial purposes. However, known water treatment and management systems and components thereof have limitations and may benefit from improvements.

### SUMMARY

Exemplary embodiments provide improvements in systems used for managing and treating water in residential and commercial applications, as well as improved components and control capabilities for such systems.

### BRIEF DESCRIPTION OF DRAWINGS

FIGS. 1-5 are cross sectional views of an exemplary embodiment of a water treatment system during various phases of operation.

FIG. 6 is an exploded view of a control valve assembly according to the exemplary embodiment of FIGS. 1-5 as viewed from the back.

FIG. 7 is an exploded view of elements of the system of FIGS. 1-5 as viewed from the back.

FIG. 8 is a top and rear perspective view of a portion of the system of FIGS. 1-5 illustrating the drive arrangements for the brine valve and piston valve.

FIG. 9 is a rear and left perspective view of the portion of the system of FIG. 8.

FIG. 10 is a rear perspective view of a cam of the system of FIGS. 1-5.

FIG. 11 is a bottom perspective view of a portion of the system of FIGS. 1-5 illustrating a removable cover.

FIG. 12 is a partially cut away schematic side view of the system of FIGS. 1-5.

FIG. 13 is a schematic side view of a portion of the system of FIGS. 1-5 but with another exemplary brine valve for controlling fluid flow through three ports.

FIG. 14 is a schematic side view of an exemplary arrangement for detecting the salt level in the brine tank of a water softener system.

FIG. 15 is a top view of a bypass valve assembly operatively mounted to a first control valve of the system of FIGS. 1-5 and a second control valve of the system of FIGS. 1-5.

FIG. 16 is a side view of the bypass valve assembly operatively mounted to two control valves of FIG. 15.

FIG. 17 shows a portion of the first control valve of the system of FIGS. 1-5.

FIG. 18 shows a portion of the second control valve of the system of FIGS. 15 and 16.

FIG. 19 is a schematic block diagram illustrating an electronic platform of a water softener system.

FIGS. 20-24 are cross sectional views of another exemplary embodiment of a water treatment system during various phases of the operation.

FIGS. 25-29 are cross sectional views of still another exemplary embodiment of a water treatment system during various phases of the operation.

FIG. 30 is a rear perspective view of an alternative arrangement of the retaining plate and the piston rod of the system.

FIG. 31 is a right side perspective view of the retaining plate of FIG. 30.

FIG. 32 is a rear perspective view of the piston rod of the alternative arrangement of the retaining plate and the piston rod of the system.

FIG. 33 is a left side perspective view of the piston rod of FIG. 32.

FIG. 34 is a rear perspective view of the retaining plate and piston rod arrangement of FIGS. 30-33.

FIG. 35 is a sectional view taken along line 35-35 of FIG. 34.

FIG. 36 is a sectional view taken along line 36-36 of FIG. 35.

FIG. 37 is a schematic side view of another exemplary embodiment of a water softener system during the regeneration phase of operation.

FIG. 38 is a view similar to FIG. 37 except that the system is in the service position for normal operation.

FIG. 39 is a schematic side view of a brine tank and related elements with portions removed for illustration.

FIG. 40 is a side view of the nozzle body of the injector assembly for the system of the exemplary embodiment of FIG. 37.

FIG. 41 is an end view of the nozzle body of FIG. 40.

FIG. 42 is sectional view of the nozzle body taken along line 41-41 of FIG. 41.

FIG. 43 is a view of the nozzle body taken along line 43-43 of FIG. 40.

FIG. 44 is a side perspective view of the nozzle body of FIG. 40.

FIG. 45 is a schematic view of a portion of the water softener system of FIG. 37.

FIG. 46 is a view similar to FIG. 45 with portions removed for illustrative purposes.

FIG. 47 is a side view of the body cover for the system of the exemplary embodiment of FIG. 37.

FIG. 48 is a side and top perspective view of the body cover of FIG. 47 as viewed from the side opposite the side viewed in FIG. 47.

FIG. 49 is a side sectional view of the body cover of FIG. 47 taken through the center and viewed in the same direction as FIG. 47 and including portions of the valve body.

FIG. 50 is a side sectional view of a body cover taken through the center for an exemplary embodiment of a water treatment system.

FIG. 51 is a schematic view of the exemplary embodiment of the system mentioned in FIG. 50.

FIG. 52 is a schematic view of a portion of the system of the exemplary embodiment of FIG. 51.

FIG. 53 is a rear and right side perspective view of another exemplary indicating arrangement and related elements in the first position for detecting and indicating the salt level in the brine tank of a water softener system.

FIG. 54 is an exploded view of several elements of the exemplary indicating arrangement of FIG. 53 as viewed from the rear.

FIG. 55 is a rear and left side perspective view of the exemplary indicating arrangement of FIG. 53 but without the remote device.

FIG. 56 is a front and right side perspective view of the elements of the exemplary indicating arrangement shown in FIG. 53.

FIG. 57 is a side view of the male portion of the clip in the exemplary arrangement of FIG. 53.

FIG. 58 is an exploded view of several elements of the exemplary indicating arrangement of FIG. 55 as viewed from the front.

FIG. 59 is a rear side view of the exemplary indicating arrangement of FIG. 53 in the second position.

FIG. 60A is a rear sectional view of a portion of the exemplary indicating arrangement of FIG. 53 taken through the middle of the rotatable cover when the cover is in the first position.

FIG. 60B is a view similar to FIG. 60A except that the cover is in the second position.

FIG. 61 is a rear side view of a portion of the exemplary indicating arrangement of FIG. 53.

FIG. 62 is a sectional view taken along line 62-62 of FIG. 61.

FIG. 63 is a sectional view taken along line 63-63 of FIG. 61.

FIG. 64 is a front view of the remote device of the exemplary indicating arrangement of FIG. 53.

FIG. 65 is a rear view of the remote device of the exemplary indicating arrangement of FIG. 53.

FIG. 66 is a front perspective view with portions cut away for illustrative purposes of another exemplary embodiment of a water treatment system.

FIGS. 67-70 are front sectional views taken through the center of the exemplary embodiment of a water treatment system in various phases of the operation.

FIG. 71 is a front perspective view of a water management valve assembly and related elements according to another exemplary embodiment.

FIG. 72 is a front perspective sectional view of the water management valve assembly of FIG. 71 taken through line 73-73 of FIG. 71.

FIGS. 73 is a further sectional view taken along line 73-73 of FIG. 71.

FIGS. 74-76 are sectional views similar to FIG. 73 but with the water management valve in different operational positions.

FIG. 77 is a schematic diagram of a water management system according to another exemplary embodiment.

FIGS. 78-79 are alternative arrangements for positioning a control valve in a water treatment system to minimize exposure of the internal components of the valve to air and reduce the formation of undesirable material within the valve.

### DETAILED DESCRIPTION

Various technologies pertaining to water management and treatment systems will now be described with reference to the drawings, where like reference numerals represent like elements throughout. In addition, several functional block diagrams of example systems are illustrated and described herein for purposes of explanation; however, it is to be understood that functionality that is described as being carried out by certain system components and devices may be performed by multiple or different components and devices. Similarly, for instance, a component/device may be configured to perform functionality that is described as being carried out by multiple components/devices or vice versa.

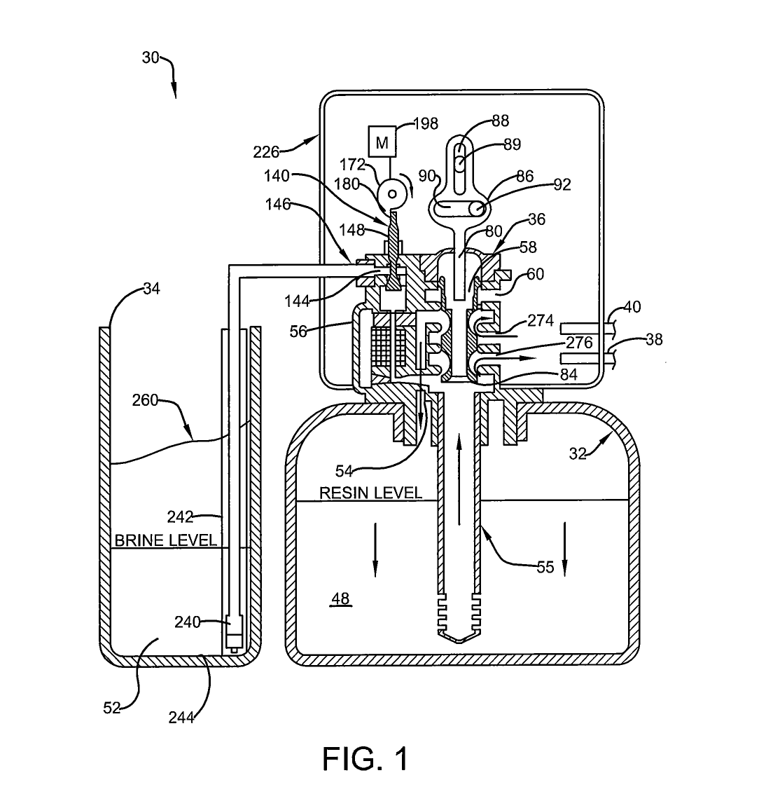

Referring to the drawings and initially to FIGS. 1-5, a water treatment system 30 is shown. The exemplary system 30 is used for removing certain chemical ions from water and may function as a water softener. The exemplary system includes a resin tank 32, a brine tank 34, and a control valve 36 threaded onto the top of the resin tank 32. When placed in service, the control valve 36 is fluidly coupled to the resin tank 32, the brine tank 34, a line 38 leading to a source of untreated water, a treated water line 40, and a drain line 46. The resin tank 32 includes a treatment medium such as an ion exchange resin bed 48, and the brine tank 34 contains particles 260 of sodium chloride, potassium permanganate, or another suitable regeneration medium which can be dissolved by water to form a brine or regenerate solution 52.

In operation, as incoming hard water enters the resin tank 32 through an opening 54 in the top of the resin tank 32, the water in the resin tank is forced through the resin bed 48 and out a distribution tube 55 extending through the center of the resin bed 48. The capacity of the resin bed 48 to exchange ions with the minerals and impurities in the incoming hard water is finite, and depends on the treatment capacity of the resin bed 48 as typically measured in kilograms of hardness or grams of CaCO₃ and the hardness of the incoming water as typically measured in grains per gallon. To regenerate the resin bed 48 once its treating capacity has been depleted, the resin bed 48 is flushed with the regenerate solution 52 from the brine tank 34 so that the minerals and other impurities can be released from the resin bed 48 and carried out of the resin tank 32. All of these operations, as well as optional attendant backwash and rinse operations, in this exemplary arrangement are controlled by the water softener control valve 36.

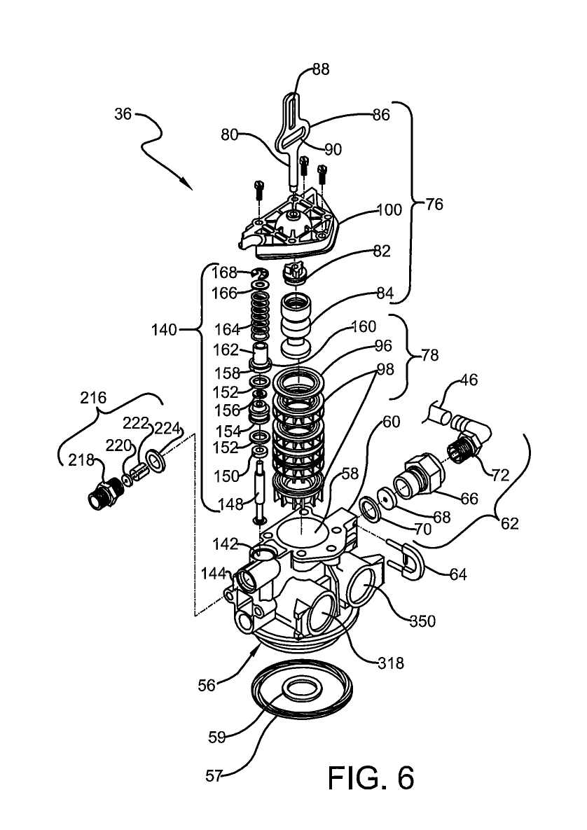

With reference to FIG. 6, the exemplary control valve 36 includes a valve body 56. The valve body 56 includes external ports in open communication with the exterior of the valve body. The valve body 56 includes internal orifices that open into a central bore 58 of the valve body 56. The external ports are fluidly connected to the untreated water line, treated water outlet line, drain, brine tank, top opening of the resin tank, and distribution tube of the resin tank, respectively. Seals 57, 59 may be provided to seal the valve body 56 to the tank opening 54 and distribution tube 55 (shown in FIG. 1). A drain port 60 provided at the valve body is in fluid communication with the central bore 58 and water drain 46. An exemplary flow control assembly 62 is mounted to the drain port 60 and is retained therein by a retainer 64. The flow control assembly 62 includes a plastic flow control valve 66. A flow control device 68 is provided in the control valve 66 and is sealed by an O-ring 70. A drain fitting 72 such as a ninety-degree elbow threads into the flow control valve 66.

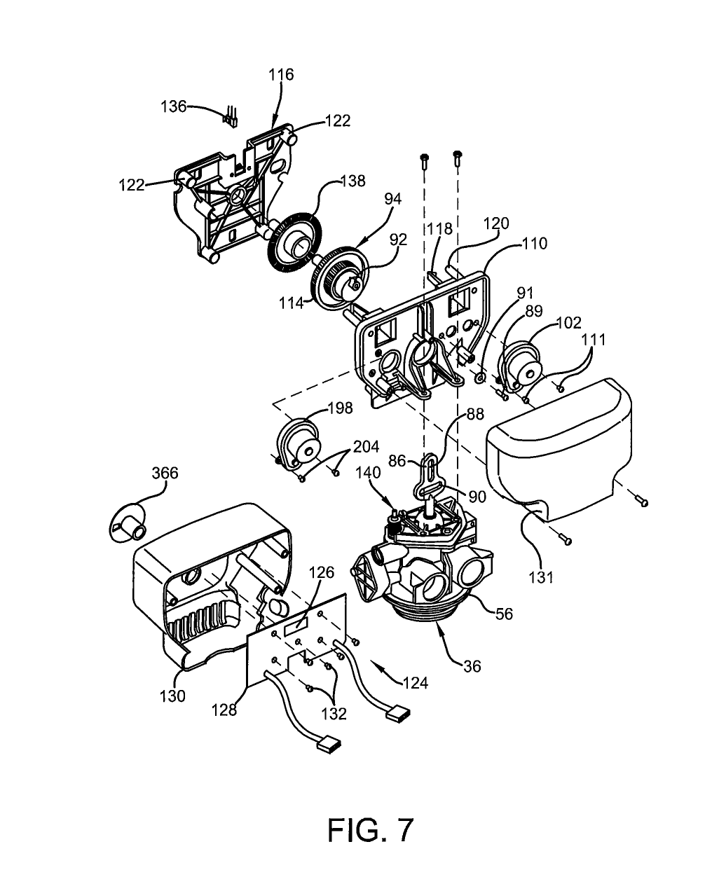

The central bore 58 is configured to slidingly receive a piston assembly 76 and a seal assembly 78. The piston assembly 76 includes a piston rod 80, rod retainer 82 and piston 84. A retaining plate 86 is integrally formed in one piece with the piston rod 80. The retaining plate 86 has a longitudinally extending upper slot 88 and a lower slot 90 that extends transverse to the upper slot 88. As shown in FIG. 7, a fastening device such as a screw 89 and washer 91 extends into the upper slot 88 and operatively mounts the retaining plate 86 to rear side 108 of a back plate 110. The lower slot 90 receives a projection 92 of a main gear 94.

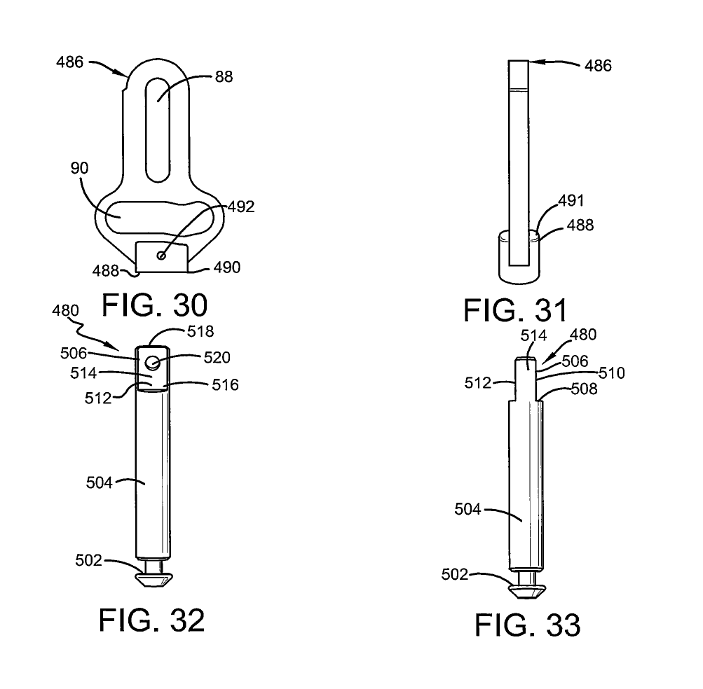

FIGS. 30-36 show an alternative arrangement of a piston rod 480 and retaining plate 486. In this arrangement the piston rod 480 and retaining plate 486 are made of plastic but are separate pieces secured together. As seen in FIGS. 30, 31 and 35, the retaining plate 486 includes a pocket portion 488 integrally molded on the bottom end of the retaining plate by any suitable process such as injection molding. The pocket portion 488 includes a generally cylindrical side wall 490 (FIG. 30), a top portion 491 (FIG. 31), and an open bottom end. As best seen in FIG. 35, lateral holes 492, 494 are formed in respective rear and front sides 496, 498 of the wall for receiving a fastener 500 such as a pin.

As seen in FIGS. 32 and 33, the piston rod 480 includes a lower end portion 502, a middle portion 504, and an upper end portion 506 formed in one piece. The middle portion 504 is cylindrical in shape. The upper end portion defines a generally rectangular tongue 506 that extends upwardly from the center of the upper axial end 508 (FIG. 33) of the middle portion 504. In particular, the tongue 506 has a rectangular flat front face 510 (FIG. 33), a rectangular flat rear face 512, left and right curved sides 514, 516 (as viewed from the FIG. 32), and a tapered upper end 518. The left and right sides 514, 516 have the same curvature as the middle portion 504 of the piston rod 480. The width of the tongue 506 or the distance between the left and right sides 514, 516 is the same as the diameter of the middle portion 504 as seen in FIGS. 32 and 36.

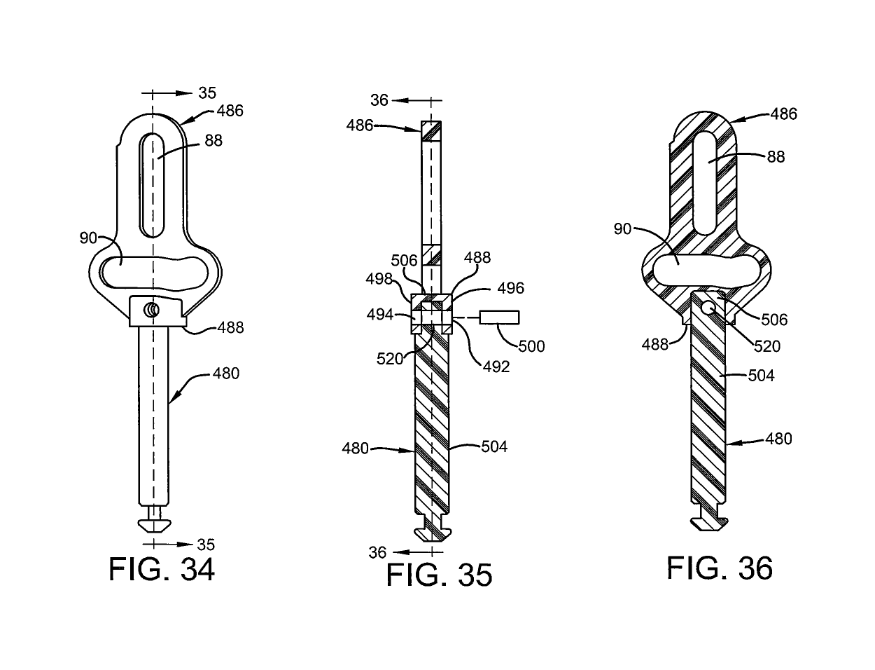

As best seen in FIGS. 33 and 35, the thickness of the tongue 506 or the distance between the front and rear faces 510, 512 is smaller than the diameter of the middle portion 504. The tongue 506 includes an aperture 520 that extends between the front and rear faces 510, 512 for receiving the pin 500. Referring to FIGS. 34 and 35, when the piston rod 480 and the retaining plate 486 are secured together, the tongue 506 slidably extends into the interior space of the pocket portion 488. The upper axial end 508 of the middle portion abuts the bottom end of the pocket portion 488 for additional support. The pocket portion 488 snugly receives the tongue 506 such that the holes 492, 494 of the pocket portion 488 are aligned with the aperture 520 of the tongue. The pin 500 extends into the holes 492, 494 and aperture 520 and is held in place by compression from the tongue 506 and pocket portion 488. Alternatively, the fastening arrangement may comprise a threaded bolt with a nut turned on the front end of the bolt to secure the tongue 506 to the pocket portion 488. The piston rod 480 and retaining plate 486 are similar in all other aspects to the piston rod 80 and retaining plate 86 and thus will not be discussed further in the interest of brevity. The piston rod 480 and retaining plate are also operatively associated with the same elements as that for the piston rod 80 and retaining plate 86. This arrangement of a piston rod 480 and retaining plate 486 provides a relatively considerable amount of surface area of the pocket portion 488 contacting or engaging the tongue 506 and thus significantly minimizes the wear between the piston rod 480 and retaining plate 486 after several water softening cycles.

Referring back to FIG. 6, the piston rod 80 or 480 is inserted into the piston rod retainer 82. The piston 84 is hollow in construction and axially receives the piston rod retainer 82. The seal assembly 78 includes seals 96 that are axially spaced by spacers 98. The piston 84 extends through the seal assembly 78 and engages the seals 96. The piston rod 80 or 480 also extends through a plug or cap 100 that is mounted to valve body 56 and covers the central bore 58 in the valve body 56. The piston assembly 76 and seal assembly 78 are configured depending on the location of the piston 84 within the seal assembly 78 to connect one or more internal orifices of the valve body 56 to one or more other internal orifices and thus creating different flow paths between the external ports of the valve body 56.

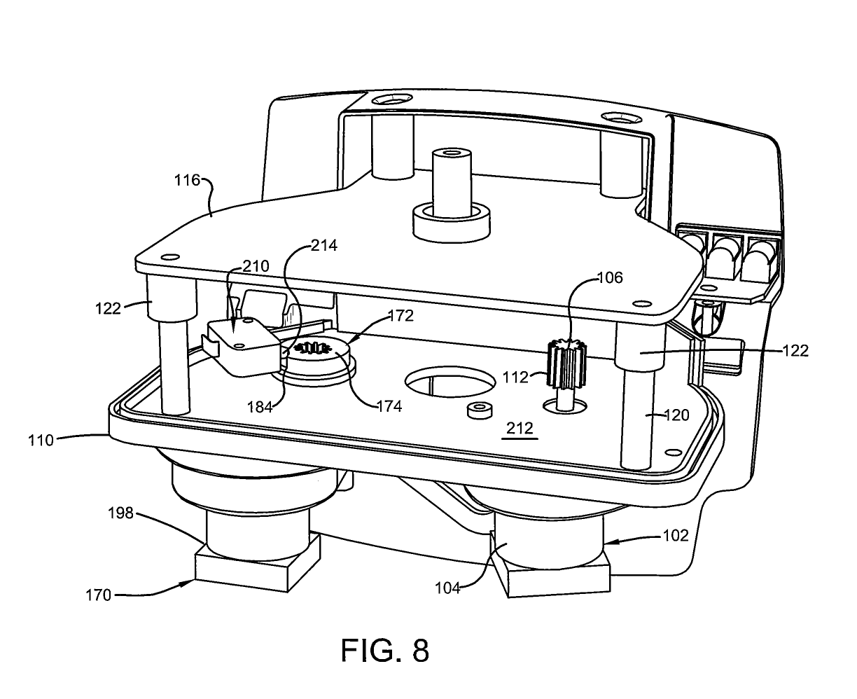

The position of piston 84 or 484 is controlled by an electric motor 102 (shown in FIG. 7) or other suitable drive that reciprocates or moves the piston 84 up and down through the bore 58 of the valve body 56. The motor 102 may be a reversible DC motor or any type that has variable torque. Alternatively, the motor 102 may be an asynchronous AC motor or a stepper motor. As seen in FIGS. 7 and 8, the motor 102 includes a casing 104 and a rotary output member such as a pinion 106. The motor casing 104 is mounted to the rear side 108 of the back plate 110 by screws 111 such that the pinion 106 extends forward through the back plate 110. The pinion 106 includes teeth 112 (FIG. 8) that meshingly engage teeth 114 (FIG. 7) of the main gear 94. The main gear 94 is rotatably mounted to the back plate 110 and a front plate 116. The back plate 110 may include forward extending hooks 118 that engage the front side of front plate 116 in a bayonet type connection to mount the front plate 116 to the back plate 110. The back plate 110 further includes forward extending bosses 120 that are inserted into recesses of rearwardly extending cylindrical projections 122 when the front and back plates 116, 110 are mounted to each other to provide lateral support. The motor 102 is controlled by a control module 124 that monitors the motion of the piston 84 and controls the operation of the motor 102 based at least partially on the current position of the piston 84. Energization of the motor 102 rotates the pinion 106, which in turn rotates the main gear 94 to move the projection 92 up and down and along the lower slot 90. This action moves the retaining plate 86 or 486 and hence, piston rod 80 or 480 up and down through the bore at selected positions.

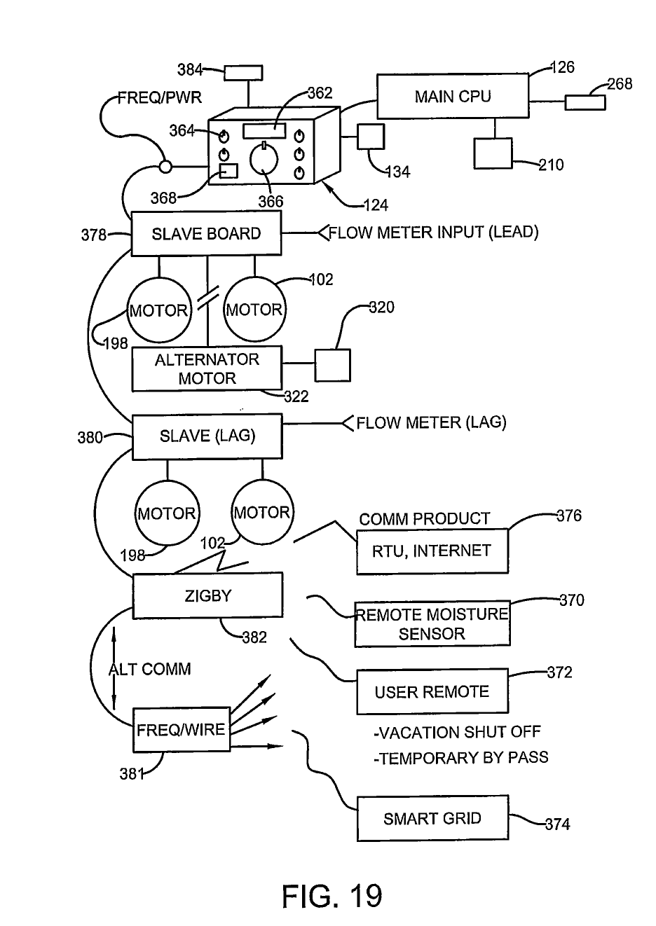

The control module 124 includes a processor or controller 126 that is mounted on a printed circuit board 128. The printed circuit board is operatively mounted to a front cover 130 by screws 132. In addition, the control module 124 may include a motor driver that in turn may include an internal current limiter for controlling the available drive current for the motor 102 and for permitting the controller 126 to determine whether the motor driver is limiting the drive current for the motor. The control module 124 is operatively connected to a position monitor 134 (schematically indicated in FIG. 19) that monitors the motion of the piston 84. The position monitor 134 comprises an encoder 136 (FIG. 7) such as a magnetic or optical encoder that monitors the rotation of the main gear 94 via an encoder wheel 138 (FIG. 7) fixedly engaged to the main gear 94. The encoder 136 senses or monitors rotation of the main gear 94 and outputs a predetermined number of pulses to the controller 126 for each revolution of the gear to the controller 126. The controller 126 receives the signals from the encoder 136 and other sensors and transmits control signals to the motor 102. For instance, because it is known that a given number of detected pulses translates into a given stroke of the piston 84, the motor 102 can be controlled to drive the piston 84 to a desired position within the bore 58 simply by counting the number of pulses from start. The position monitor 134 need not be limited to an encoder and may comprise any device for precisely and directly or indirectly monitoring movement of the piston 84 so as to permit the controller 126 to determine the piston's position within the bore 58. For example, if the motor 102 is a stepper motor, the position monitor 134 could be formed from part of the motor's internal control circuitry or could take the form of a limit switch or other mechanical position switch.

A brine valve 140 is provided in a bore 142 (FIG. 6) of the valve body 56 that fluidly communicates with the external port 144 connected to the line 146 for the brine valve 140. The brine valve 140 controls the flow of the brine from the brine tank 34. Referring to FIG. 6, the brine valve 140 includes a brine valve stem 148 that axially receives a valve seat 150. Elastomeric O-ring seals 152 are positioned upon the valve seat 150. The O-ring seals 152 are spaced from each other by a spacer 154 and a quad ring 156 positioned upon the spacer 154. A valve cap 158 is positioned upon a seal 142 and caps the seals 152, spacer 154, and quad ring 156 upon the valve seat 150. The valve cap 158 includes a head 160 and a shaft 162. A coiled valve spring 164 axially receives the shaft 162 and is seated upon the head 160. The valve stem 148 axially extends through the O-ring seals 152, spacer 154, quad ring 156, cap 158 and spring 164. The valve stem 148 is retained to the upper end of the spring 164 by a washer 166 and retaining ring 168. The spring 164 biases the valve stem 148 upwardly. In operation, the valve stem 148 axially moves within the bore 58 to open and close the brine port 144 in fluid communication with the line 146 to the brine tank 34 as illustrated in FIGS. 1-5 and 20-29. The brine valve 140 is controlled by a drive assembly 170 (FIG. 8) that reciprocates or moves the valve stem 148 up and down through the bore 58 of the valve body 56.

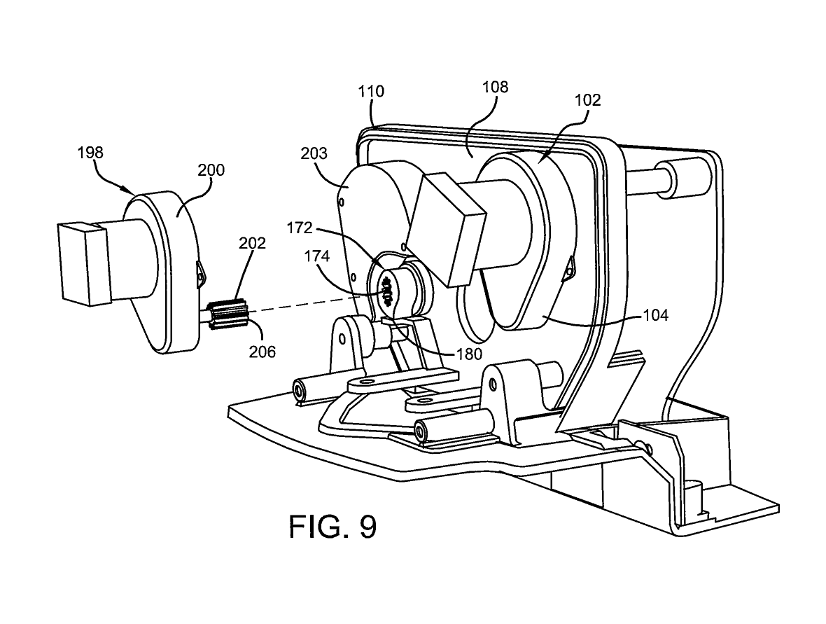

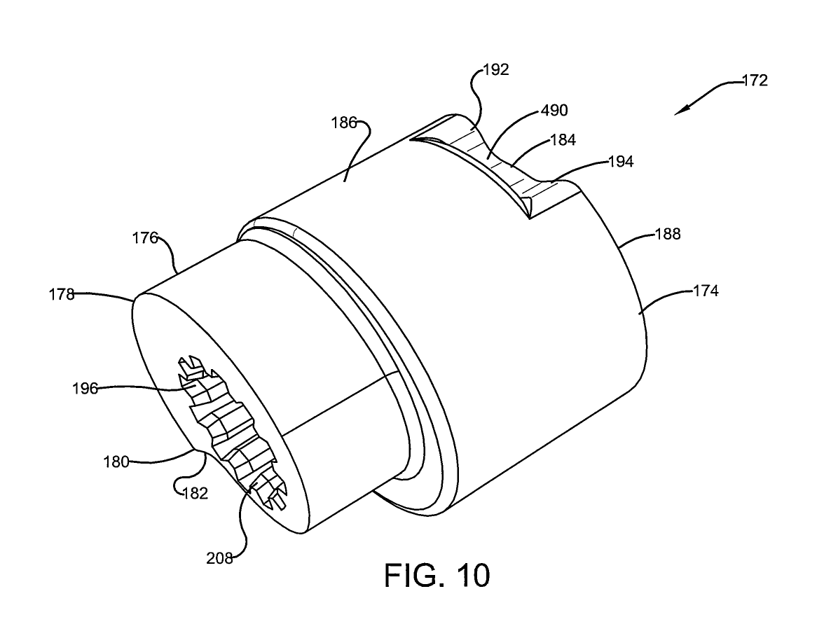

As seen in FIGS. 8-10, the drive assembly 170 includes a cam 172 that includes a cylindrical base 174 and a generally cylindrical head 176. The head 176 is coaxial with the base 174 and is of smaller size than the base 174. The head 176 includes a peripheral end 178 that gradually extends radially outwardly in the circumferential direction to define a radially extending cam projection 180. The cam projection 180 includes a concavely curved trailing end 182 (as viewed in the clockwise direction of FIG. 8) such that the cam projection 180 is hook shaped. As best seen in FIG. 10, the base 174 includes a recess 184 formed in a body 186 of the base 174 adjacent a forward axial end 188. The recess 184 is defined by a bottom face 190 (as viewed in FIG. 10) and opposite side faces 192, 194 that angle outwardly and upwardly with respect to the bottom face 190. The cam 172 includes a toothed axial bore 196 extending through the center of the cam 172. The drive assembly 170 further includes an electric motor 198 as depicted in FIGS. 7-9. The motor 198 may be a reversible DC motor or any type that has variable torque. Alternatively, the motor 198 may be an asynchronous AC motor or a stepper motor. For purposes hereof a motor shall also be deemed to include other types of actuators. As shown in FIG. 9, the motor 198 includes a casing 200 and a rotary output member such as a pinion 202. The motor casing 200 is mounted to a drive mount 203 via screws 204 (FIG. 7) that is in turn mounted the rear side 108 of the back plate 110 such that the pinion 202 extends into the bore 196 of the cam 172. The pinion 202 includes teeth 206 that meshingly engage the teeth 208 (FIG. 10) of the bore 196 of the cam 172.

Energization of the motor 198 causes the pinion 202 to rotate, which in turn rotates the cam 172 in the clockwise direction (as viewed in FIGS. 1-5 and 20-29) such that the cam projection 180 can engage or cam against the upper end of the valve stem 148 and moves the valve stem 148 down in the open position of the brine valve 140. Continued rotation of the cam 172 in the clockwise direction will disengage the cam projection 180 from the upper end of the valve stem 148 to allow the spring 164 to urge the valve stem 148 upwardly back into the closed position of the brine valve 140. The motor 198 may include control circuitry that controls the rotational speed and other aspects of the motor. The motor 198 could also reverse the rotation of the pinion and cause rotation of the cam 172 in the counterclockwise direction. As seen in FIG. 8, a microswitch 210 is mounted to front side 212 of the back plate 110 adjacent the base 174 of the cam 172. The microswitch 210 includes a push button 214 that is extended into the recess 184 when the cam projection 180 engages the valve stem 148 to move the brine valve 140 downward in the open position. The push button 214 is depressed by the cam 172 when the push button 214 is located out of the recess 184 and the cam projection 180 is disengaged from the brine valve 140 such that the brine valve 140 is urged upward by the spring 164 to the closed position. The microswitch 210 is electrically connected to the controller 126 as seen in FIG. 19. When the push button 214 is extended (FIG. 8), the microswitch 210 causes a signal to be sent to the controller 126 indicating that the brine valve 140 is in the closed position. When the push button 214 is depressed, the microswitch 210 causes a signal to be sent to the controller 126 indicating that the brine valve 140 is in the open position. The microswitch 210 may be normally open or normally closed depending on the printed circuit board design requirements. The side faces 192, 194 angle outwardly and upwardly with respect to the bottom face 190 to allow passage of a pushbutton out of the recess 184.

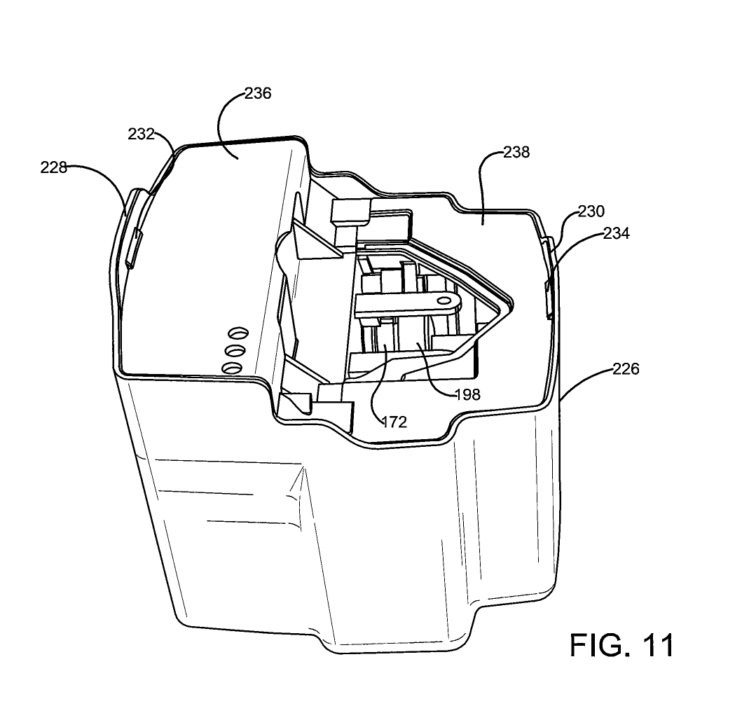

A brine line flow control assembly 216 is provided within brine port 144, which is located between the brine valve 140 and brine line 146. The brine line flow control assembly 216 includes an adapter 218 that is threaded into the brine port 144. The assembly 216 further includes a flow control button 220 that is retained by a retainer 222 and sealed by an O-ring seal 224. Front and rear covers 130, 131 cover the control valve 36, control module 124, and the components that control the control valve 36. Optionally, as seen in FIG. 11, a one piece plastic removable cover 226 may cover the components on the back and front plates 110, 116 (shown in FIG. 8) to protect them from the environment. In particular, the cover 226 may include front and rear plastic tabs 228, 230 formed at its bottom end with inwardly extending projections 232, 234. When the cover 226 covers the components, the projections 232, 234 engage the bottom sides of respective horizontal front and back support plates 236, 238, which are provided to support the components. The cover 226 is removed by grasping the tabs 228, 230 and moving them outwardly to disengage the projections 232, 234 from the support plates 236, 238.

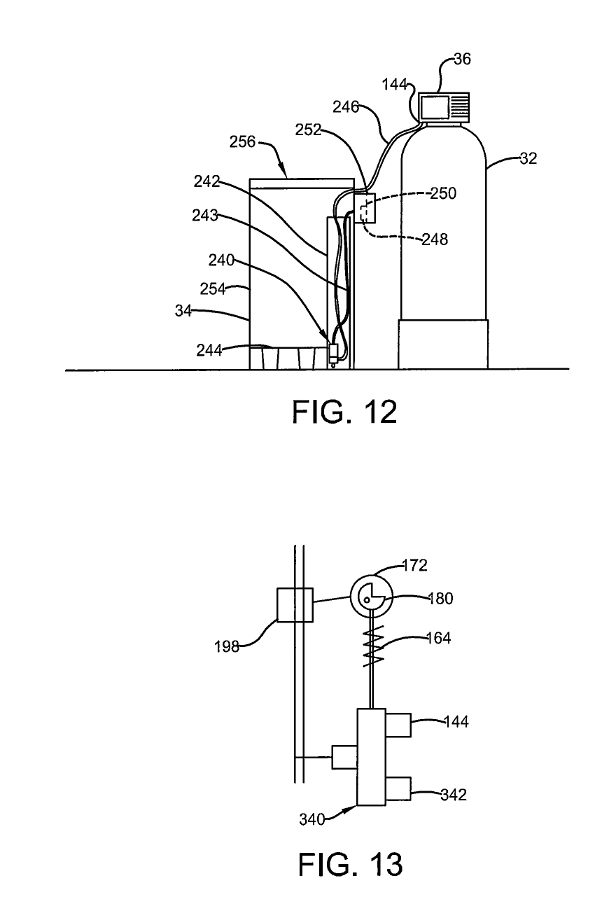

As seen in FIG. 12, the brine tank 34 may include a pump 240 to pump out the brine or regenerate solution 52 (FIGS. 1-5 and 20-29) from the brine tank 34 to the resin tank 32. Specifically, the pump 240 is inserted into a riser tube 242 that extends upwardly from the bottom 244 of the brine tank 34. The pump 240 is located near the bottom 244 of the brine tank 34 and may be submersed into the brine solution 52. The pump 240 may be of any suitable type such as a gear pump or centrifugal pump. The line 146 (shown in FIG. 1) may comprise a flexible tube 246 that extends from the outlet of the pump 240 through the riser tube 242 and to the brine port 144 of the control valve 36 to transport the brine from the brine tank 34 to the resin tank 32 and also transports treated water from the resin tank 32 to the brine tank 34. A lid 256 covers the top of the brine tank 34. The pump 240 is electrically coupled via a power cord 243 to a controller 248 mounted on a printed circuit board 250 for controlling the output of the pump 240. The controller 248 and circuit board 250 may be provided in a control valve 252 that is mounted to the sidewall 254 of the brine tank. The controller 248 may also monitor the pump current to control when the water is at the air level. This controller 248 may be operatively connected to the control module 124 (shown in FIG. 7). Alternatively, the controller 126 of the control module 124 may be used instead of the controller 248 to control and monitor the pump 240. Alternatively, a pressure switch may be provided to indicate the water level based on the detected pressure. For example, when the pressure switch detects no pressure, there is no water in the tank.

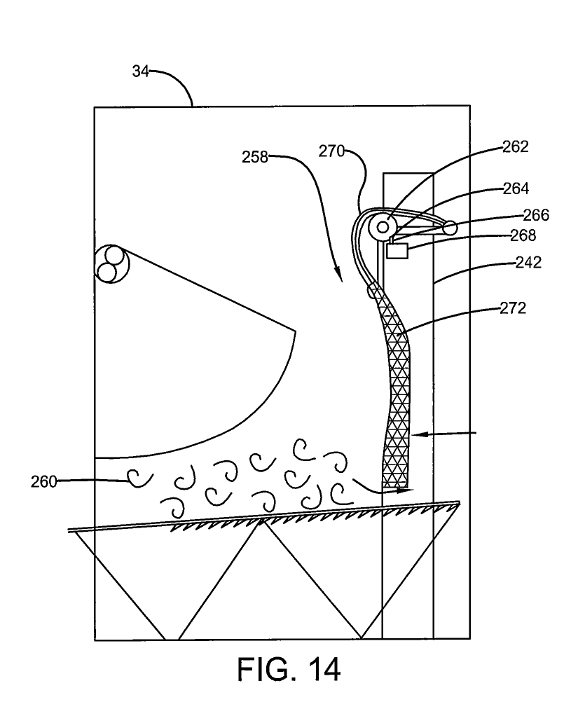

As seen in FIG. 14, the brine tank 34 may include an indicating arrangement 258 that indicates when the salt 260 in the brine tank 34 needs to be replenished. In particular, the indicating arrangement 258 includes a cam wheel 262 rotatably mounted to the riser tube 242 or tank 34. The cam wheel 262 includes a recess 264 in which a push button 266 of a microswitch 268 extends therein. The microswitch is operatively connected to the controller 126 (shown in FIG. 7). An elastomeric band 270 engages the cam wheel 262 and is connected to a paddle 272. When the salt level is above the bottom of the paddle, the paddle 272 is pushed against the riser tube 242 from the force of the salt that also overcomes the biasing force of the band 270. When the salt level goes below the paddle 272, the biasing force of the band 270 causes the cam wheel 262 to rotate the wheel 262 clockwise until the push button 266 of the microswitch 268 moves out of the recess 264 and is depressed by the cam wheel 262. The pressing of the push button 266 causes a signal to be sent to the controller 126 indicating that the salt needs to be replenished.

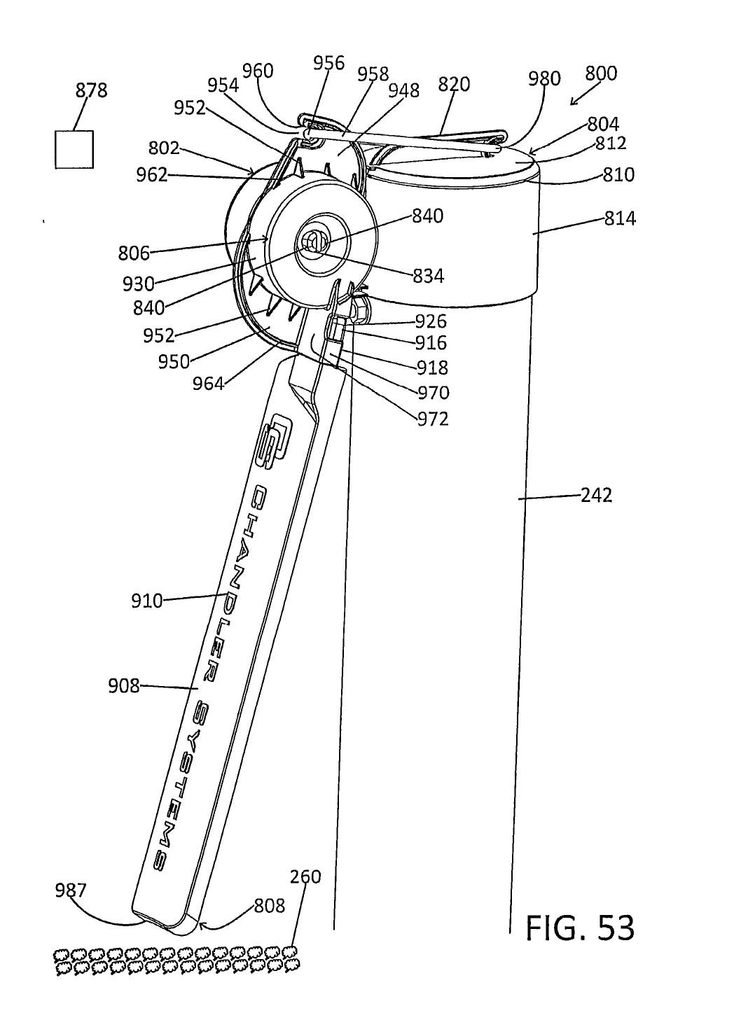

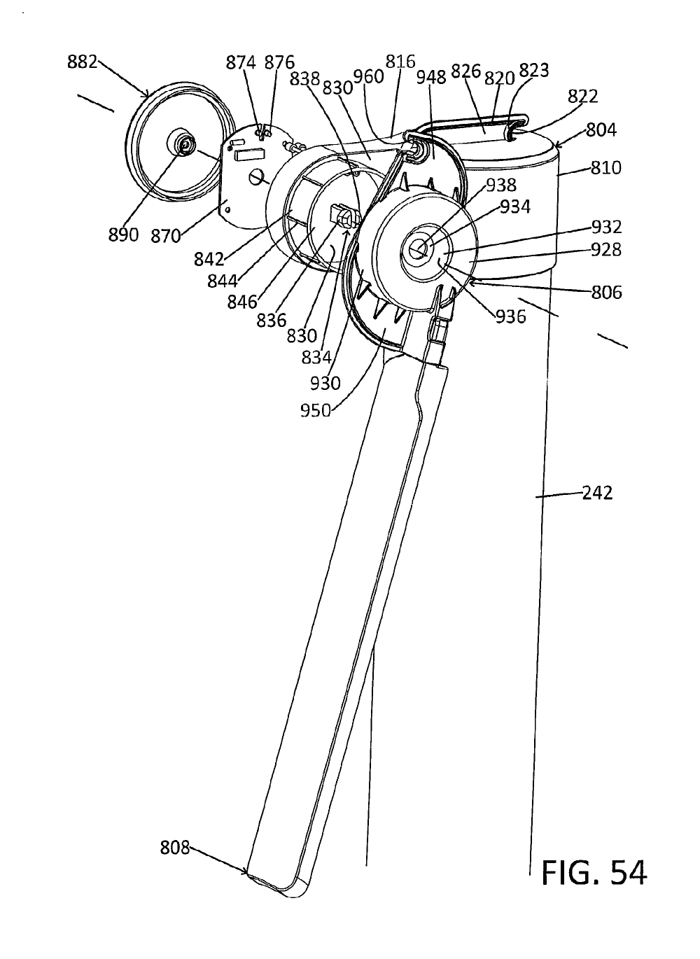

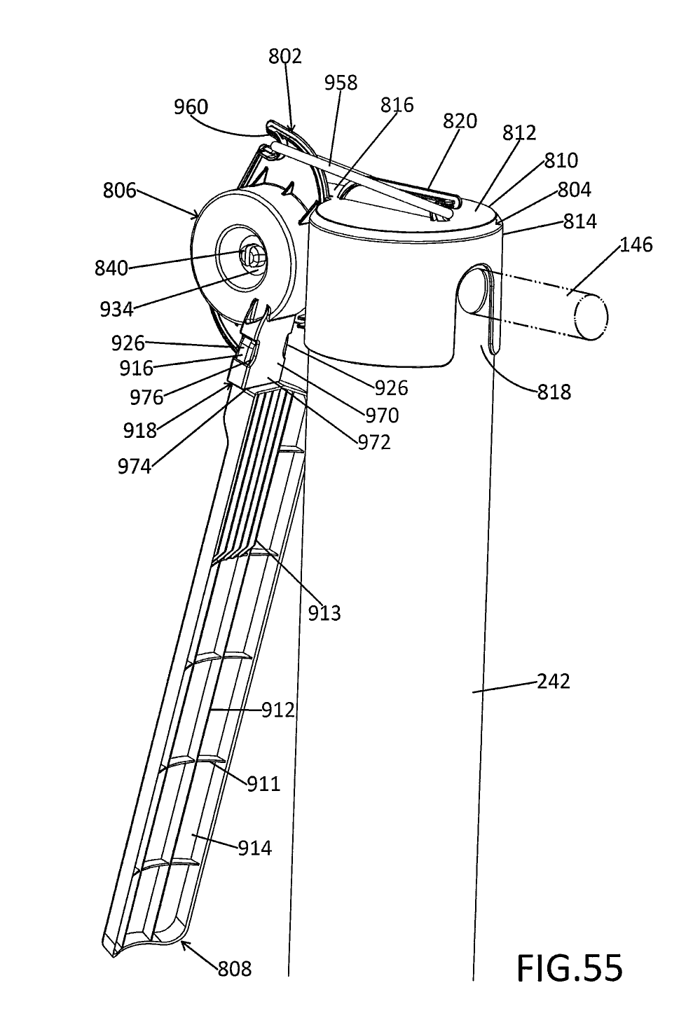

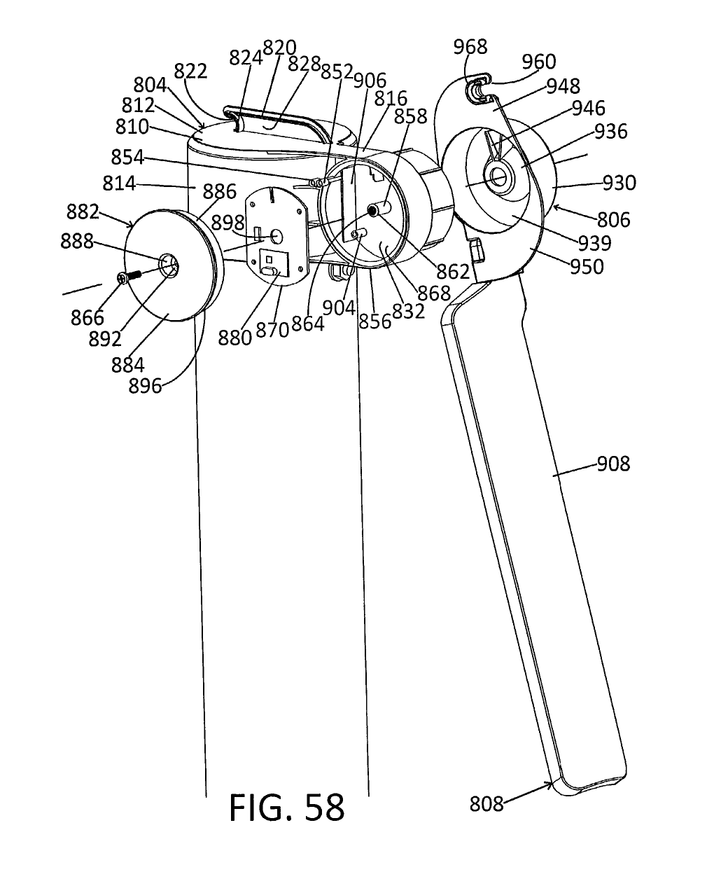

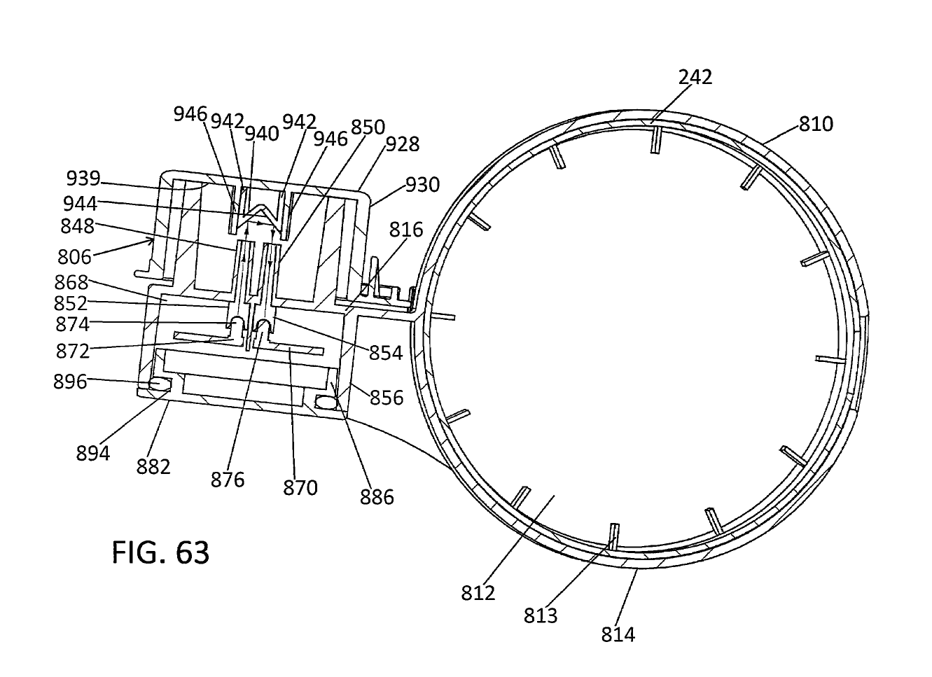

FIGS. 53-65 show another exemplary indicating arrangement 800 that indicates when the salt 260 in the brine tank 34 needs to be replenished. Referring to FIG. 53, the indicating arrangement 800 includes an apparatus 802 that comprises a plastic top portion 804, a plastic rotatable cover 806, a plastic paddle 808, and other related elements. The top portion 804 includes a cap 810. The cap 810 includes a top circular wall 812 and a side wall 814 extending downwardly from the peripheral end of the top wall 812. Stiffener ribs 813 are integrally formed by plastic injection molding on the underside of the cap 810 at the junction of the side wall 814 and top wall 812 as seen in FIG. 63. As best depicted in FIGS. 56 and 58, the top portion 804 includes a u-shaped mounting ear 816 that extends laterally from the exterior surface of the side wall 814 in a direction away from the cap 810. An inverted u-shaped cut out or notch 818 (FIG. 55) is formed in the side wall 814 at location opposite the mounting ear 816. The cut out 818 extends upwardly from the bottom end of the side wall 814 and terminates approximately at about three fourths of the height of the side wall 814. An elongated hook member 820 is integrally formed by injection molding on top of the top wall 812. Specifically, as best shown in FIGS. 55 and 58, the hook member 820 extends partially across the cap 810 from the end of the top wall 812 near the mounting ear 816 to a location on the top wall 812 near the cut out 818. The end of the hook member 820 near the cut out 818 is curved to define a notch or nose 822 (FIG. 54) of the hook member 820. As depicted in FIGS. 54 and 58, the hook member 820 includes stiffening ribs 823, 824 integrally formed by plastic injection molding on respective opposite side faces 826, 828 of the hook member 820 to provide additional support to the hook member 820.

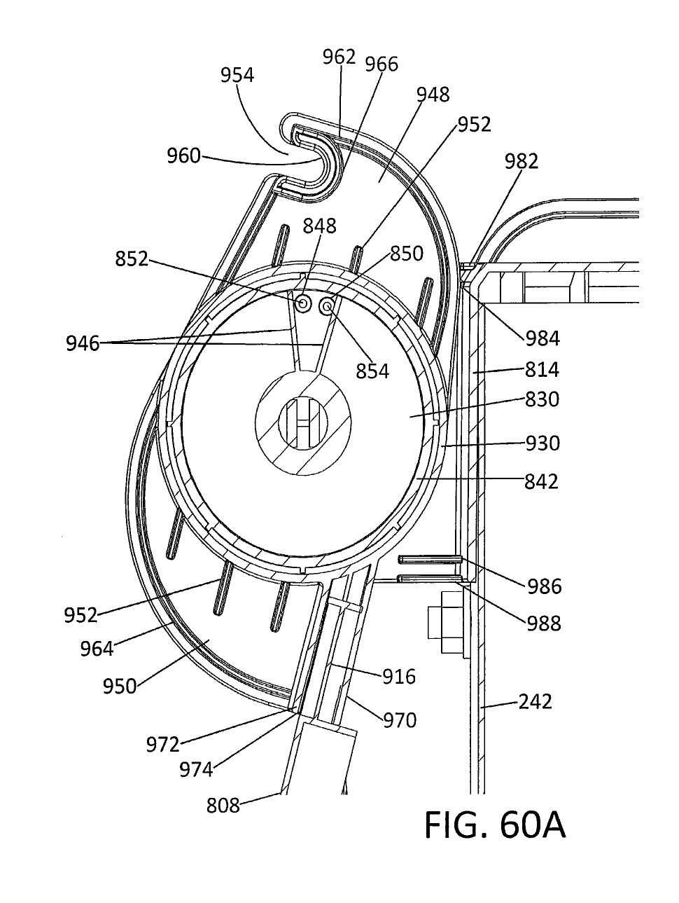

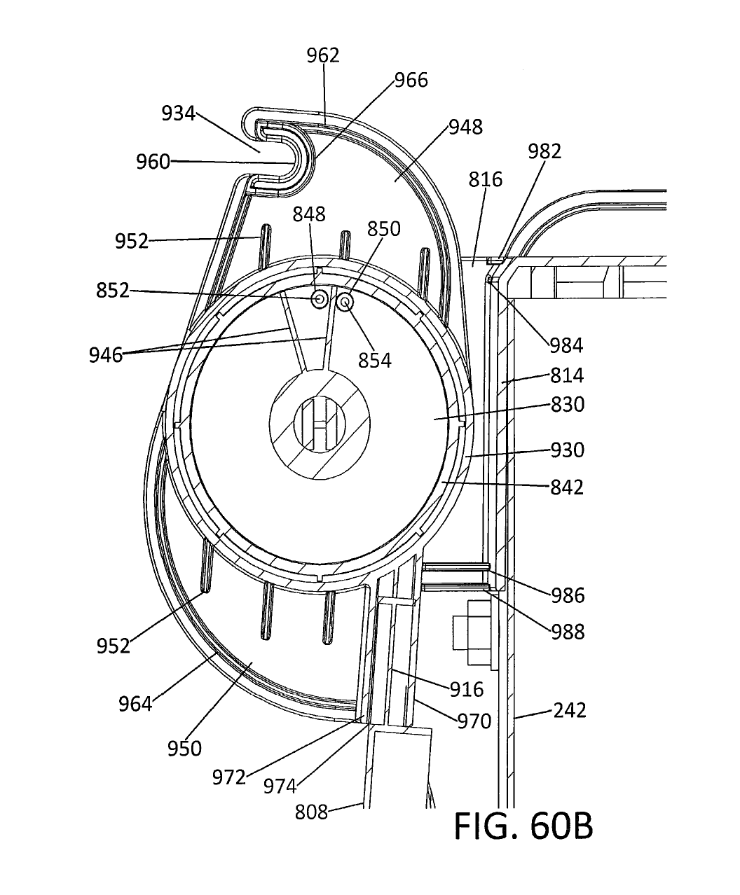

The mounting ear 816 includes rear and front faces 830, 832 (FIGS. 54 and 58). As seen in FIG. 54, a pivot axle assembly 834 is integrally formed in one piece by plastic injection molding with the rear face 830 and extends rearwardly from the rear face 830 of the mounting ear 816. The pivot axle assembly 834 comprises a pair of flexible and elastic fingers 836, 838 spaced from each other and extending rearwardly from the rear face 830 of the mounting ear 816. Each finger includes a barb 840 (indicated in FIG. 55) at its distal end. The pivot axle assembly 834 is circumferentially surrounded by a rear peripheral wall 842 that extends rearwardly from the rear face 830. The rear wall 842 includes forward extending stiffening ribs 844 integrally formed with the rear wall 842 by plastic injection molding and spaced circumferentially around the rear wall 842. The rear wall 842 defines a rear compartment 846. Two tubular supports 848, 850 (FIGS. 60A, 60B, and 63) are each integrally formed in one piece with the mounting ear 816 by plastic injection molding and extend through the faces 830, 832 of the mounting ear 816 and rearwardly from the rear face 830. The tubular supports 848, 850 securely receive a pair of transmitter and receiver light pipes 852, 854, respectively. The light pipes 852, 854 may be made of a clear polycarbonate material or other suitable material.

Referring to FIG. 58, a front peripheral wall 856 is integrally formed in one piece by plastic injection molding with the front face 832 and extends forward from the front face 832 and surrounds a boss 858. The boss 858 is integrally formed in one piece by plastic injection molding with the front face 832 and extends forward from the center of the front face 832. The distal end of the boss 858 has a smaller thickness than the other parts of the boss 858 and thus defines a step 860 (FIG. 62) for receiving an elastomeric O-ring seal 862. The boss includes a threaded bore 864 for threadily receiving a plastic mounting screw 866 as also seen in FIG. 62. The front peripheral wall 856 defines a front compartment 868 that houses a printed circuit board 870 that includes an optical sensor 872 (FIG. 62). As seen in FIGS. 54 and 63, the optical sensor 872 includes an infrared light emitting diode transmitter 874 and an infrared transistor receiver 876 surface mounted on the printed circuit board 870. The infrared light emitting diode transmitter 874 and an infrared transistor receiver 876 are aligned with their respective transmitter and receiver light pipes 852, 854.

The optical sensor 872 may be electrically coupled via a wireless connection to a remote device 878 (FIGS. 54, 64, and 65) through use of a radio frequency (RF) transmitter 880 (FIG. 58) mounted on the printed circuit board 870. A receiver may also be mounted on the printed circuit board 870 to receive signals transmitted from the remote device 878, control module 124, or other suitable device. Alternatively, a transceiver can be used instead of the transmitter and receiver. Alternatively, the optical sensor may be electrically coupled to the remote device 878 or other device by a wired connection. In another alternatively arrangement, the optical sensor may be electrically coupled to the controller 126 of the control module 124. The optical sensor 872 may be powered by a battery or other suitable power supply.

As depicted in FIG. 58, a plastic lid 882 covers the front compartment 868 and is removably mounted to the mounting ear 816 by the plastic mounting screw 866. In particular, the lid 882 includes a circular base 884 and a side wall 886 extending around the base and perpendicularly from the base 884. A recess 888 is formed in the center of the base 884 and extends from the base 884 in the same direction as the side wall 886. An aperture 890 (FIG. 54) is formed in the bottom side 892 of the recess 888. The side wall 886 includes a groove 894 (FIGS. 62 and 63) extending around side wall 886 and located adjacent the base 884. The groove 894 receives an elastomeric O-ring seal 896. As depicted in FIGS. 62 and 63, when the lid 882 is mounted to the mounting ear 816, the side wall 886 extends into the front compartment 868 and the O-ring seal 896 engages the inner surface of the peripheral wall 856 to seal the front compartment 868 at the location between the lid 882 and peripheral wall 856. Also, as shown in FIG. 62, when the lid 882 is mounted to the mounting ear 816, shank 893 of the mounting screw 866 extends through the aperture 890, an aperture 898 (FIG. 58) formed in the printed circuit board 870, and the bore 864 (FIG. 58) of the boss 858 to threadily engage the boss 858 and mount the lid 882 to the mounting ear 816. The head 900 of the mounting screw 866 engages the bottom side 892 of the recess 888. Also, when the lid 882 is mounted to the mounting ear 816, the O-ring seal 862 on the boss 858 engages the inner surface of a side wall 902 extending from the bottom side 892 of the recess 888 to seal the front compartment 868 at that location.

With reference to FIGS. 58 and 62, when the printed circuit board 870 is installed in the front compartment 868, the printed circuit board 870 is mounted on support bosses 904 via screws (not shown) or alternatively rests upon the support bosses 904 without using fasteners. The support bosses 904 are integrally formed in one piece with the mounting ear 816 by plastic injection molding and extend forward from the front face 832. The printed circuit board 870 is also positioned between support plates 906 integrally formed in one piece with the mounting ear 816 by plastic injection molding. The support plates 906 extend forward from the front face 832 and are located on opposite peripheral ends of the printed circuit board to laterally support the printed circuit board 870. The structure and arrangement of the O-ring seals 862, 896, lid 882, peripheral wall 856 and other elements provide effective sealing of the front compartment 868 to protect the printed circuit board 870 and electronic components in the front compartment 868 from the brine solution.

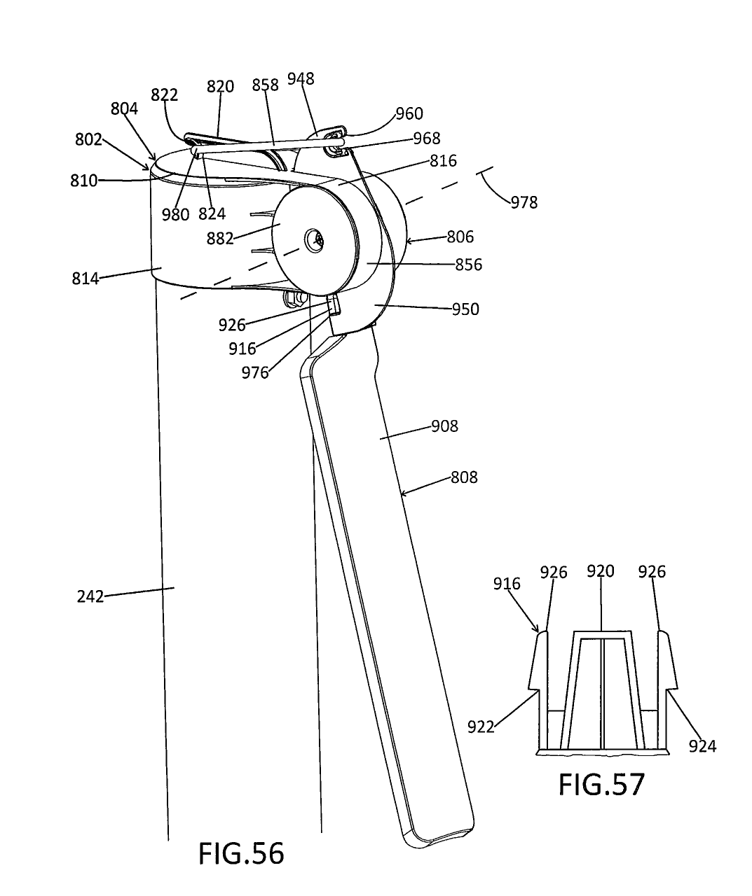

As seen in FIGS. 53-56 and 58, the paddle 808 is generally rectangular in shape and includes a generally convexly shaped smooth side 908 that faces in the direction away from the cap 810. The side 908 may alternatively include indicia 910 embossed thereon as seen in FIG. 53. An array of stiffening ribs 911, 912, and 913 are integrally formed in one piece with the paddle 808 by plastic injection molding and located on the side 914 opposite the side 908 as seen in FIG. 55. A male part 916 of a clip 918 is integrally formed in one piece with the paddle 808 by plastic injection molding and extends upwardly from the top end of paddle 808. As best depicted in FIG. 57, the male part 916 includes a tongue member 920 that tapers toward its distal end. The tongue member 920 is located between two flexible and elastic fingers 922, 924 and spaced from each finger. Each of the fingers 922, 924 terminates into a tang 926.

As seen in FIGS. 54 and 58, the rotatable cover 806 includes a circular base 928 and a side wall 930 extending around the base 928 and perpendicularly from the base 928. A recess 932 is formed in the center of the base 928 and extends from the base 928 in the same direction as the side wall 930. The recess 932 is defined by a bottom wall 934 and side wall 936 that slopes inwardly toward the bottom wall 934. An aperture 938 is formed in the bottom wall 934 of the recess 932.

As seen in FIG. 63, a reflector 940 is attached by any suitable way to the inner side 939 of the base 928 and extends radially from the side wall 936 of the recess 932 to the side wall 930. The reflector 940 includes support legs 942 that extend from the reflecting dish 944 to the base 928. Alternatively, instead of the reflector a generally triangular shaped piece of reflective foil may be attached by any suitable way such as adhesive to the underside of the base. The reflector 940 is positioned between a pair of plastic light shields 946 that are also attached to the inner side 939 of the base 928. The light shields 946 extend radially from the side wall 936 of the recess 932 and also depend forward from the inner side of the base 928 a distance equal to the height of the side wall 936 as seen in FIG. 58. The light shields 946 may be integrally formed in one piece with the cover 806 by plastic injection molding. The light shields 946 help secure the reflector 940 via a friction fit and prevent or shield the light reflected by the reflector 940 from escaping out of the area defined by the reflecting dish 944 and light shields 946.

With reference to FIGS. 53 and 60A and 60B, upper and lower flange portions 948, 950 are integrally formed in one piece with the cover 806 by plastic injection molding and extend outwardly from the distal end of the side wall 930. Triangular shaped stiffeners 952 are attached at the junction of the side wall 930 and flange portions 948, 950 to provide additional support. A notch 954 is formed in the upper flange for receiving a looped end 956 (FIG. 53) of a resilient elastomeric band 958. The notch 954 defines a hooked end 960 of the upper flange portion 948. The flange portions 948, 950 include stiffening ribs 962, 964, respectively, to provide additional support. Stiffening ribs 966, 968 (FIG. 58) are provided on opposite rear and front sides of the hooked end 960 to provide additional support to the hooked end 960.

A female part 970 of the clip 918 is integrally formed in one piece with the lower flange 950 by plastic injection molding and extends radially outwardly from the side wall 930. The female part 970 generally includes a main body 972, a socket 974 (FIGS. 60A and 60B) through the main body 972 for receiving the male part 916, and openings 976 (FIGS. 55 and 56) for receiving the tangs 926. The female part 970 receives the male part 916 to removably connect the paddle 808 to the rotatable cover 806. When the male part 916 is inserted into the female part 970, the tangs 926 extend partially through the openings such that the proximal ends of the tangs 926 engage the main body 972 to prevent removal of the male part 916 from the female part 970. To remove the male part 916 from the female part 970, the flexible tangs 926 are squeezed by the fingers of a user or otherwise moved toward each other a sufficient distance to disengage the tangs 926 from the main body 972, and then the male part 916 is moved out of the socket 974. To mount the male part 916 into the female part 970, the tangs 926 are squeezed toward each other a sufficient distance to allow them to be inserted in the socket 974. After insertion, the squeezing force is released so that the tangs 926 extend partially through the openings 976 to allow the proximal ends of the tangs 926 to engage the main body 972 to prevent removal of the male part 916 from the female part 970. In another arrangement, reversal of parts may be implemented in which the male part may be form on the lower flange and the female part may be formed on the top end of the paddle. When the paddle 808 is connected to the cover 806, the paddle 808 is fixed with respect to the cover 806 so that paddle 808 moves or rotates during rotation of the cover 806.

The cover 806 is removably and rotatably mounted to the pivot axle assembly 834 and covers the rear compartment 846. In particular, when the cover 806 is mounted to the pivot axle assembly 834, the barbs 840 of the fingers 836 extend through the aperture 938 and slidably engage the outer surface of the bottom side 934 of the recess 932 at their proximal ends as depicted in FIG. 55. Also, when the cover 806 is mounted to the pivot axle assembly 834, the rear sidewall 842 of the mounting ear 816 is inserted into the cover 806 such that side wall 930 of the cover 806 surrounds the rear side wall 840 as best seen in FIGS. 60A, 60B, and 62. The cover 806 pivots or rotates about an axis 978 (FIGS. 56 and 62) with respect to the mounting ear 816 with the barbs 840 sliding along the outer surface of the bottom side 934 of the recess 932 during the rotation. As seen in FIGS. 60A and 63, the cover 806 may assume a first position with respect to the mounting ear 816 in which the longitudinal axes of the transmitter and receiver light pipes 852, 854 are aligned over the reflecting dish 944 of the reflector 940. In this position, the infrared light (indicated by the arrows of FIG. 63) emitted by the light emitting diode transmitter 874 goes through the transmitter light pipe 852 and is reflected by the reflecting dish 944. This reflected light passes through the receiver light pipe 854 and is received by the infrared transistor receiver 876. In response to receiving the reflecting light, the receiver 876 causes the RF transmitter 880 to output a signal to the remote device 878 and/or the controller 126 indicating that the salt in the brine tank needs to be replenished.

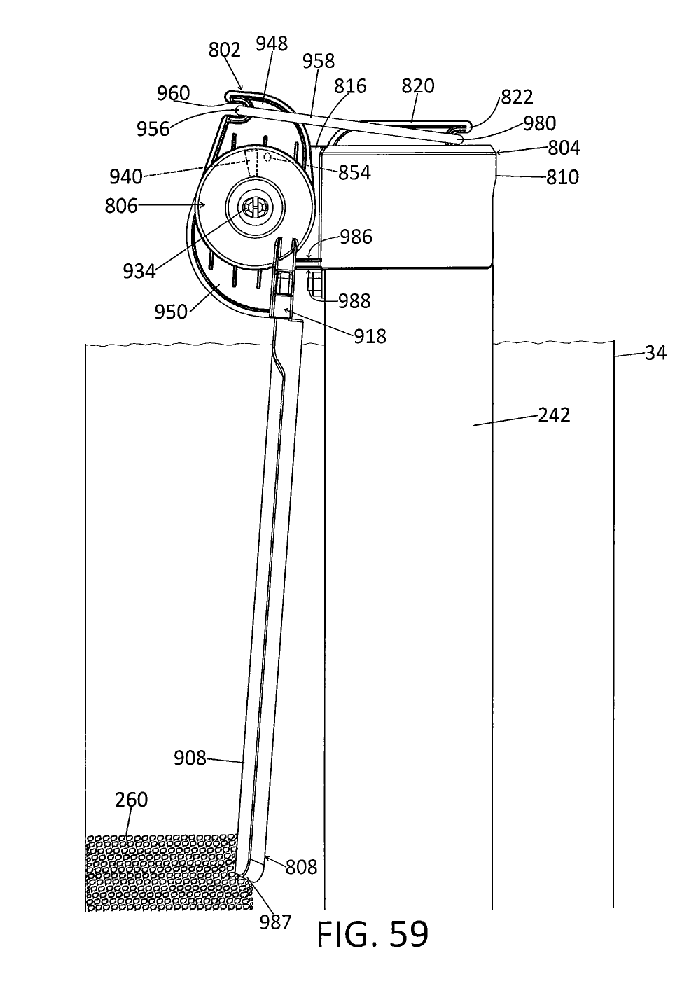

As seen in FIGS. 59 and 60B, the cover 806 may be located in a second position with respect to the mounting ear 816 in which the longitudinal axis of the receiver light pipe 854 is not aligned over the reflecting dish 944 of the reflector 940 (schematically indicated in FIG. 59) and thus, the infrared transistor receiver 876 does not receive the light reflected from the reflecting dish 944 emitted by the light emitting diode transmitter 874 through the transmitter light pipe 852. This second position indicates that the salt in the brine tank 34 does not need to be replenished. Alternatively, the second position may be such that the locations of the light pipes are reversed such that the transmitter light pipe 852 is not aligned over the reflecting dish 944 of the reflector 940 so that the infrared light emitted by the light emitting diode transmitter 874 through the transmitter light pipe 852 is not reflected by the reflecting dish 944 and thus the reflected light is not received by the infrared transistor receiver 876. Alternatively, the second position may be such that neither the transmitter light pipe 852 nor the receiver light pipe 854 is aligned over the reflecting dish 944.

To remove the cover 806 from the pivot axle assembly 834, the barbs 840 are squeezed by the fingers of a user or otherwise moved toward each other a sufficient distance to disengage the barbs 840 from the bottom side 934 of the recess 932, and the barbs 840 and fingers 836, 838 are then moved out of the aperture 938. To mount the cover 806 to the pivot axle assembly 834, the barbs 840 are moved by squeezing them toward each other until they have sufficient clearance to extend through the aperture 938. After extending through the aperture 938, the squeezing force is released to allow the barbs 840 to move away from each other so that they can slidably engage the outer surface of the bottom side 934 of the recess 932 at their proximal ends. In another arrangement, a reversal of parts may be implemented with respect to the cover and elements on the front face of the mounting ear. For example, the printed circuit board, light emitting diode transmitter 874, infrared transistor receiver 876, RF transmitter 880, and light pipes 852, 854 may be mounted to the cover 806, and the reflector 940 and light shields 946 may be attached to the rear face 830 of the mounting ear 816.

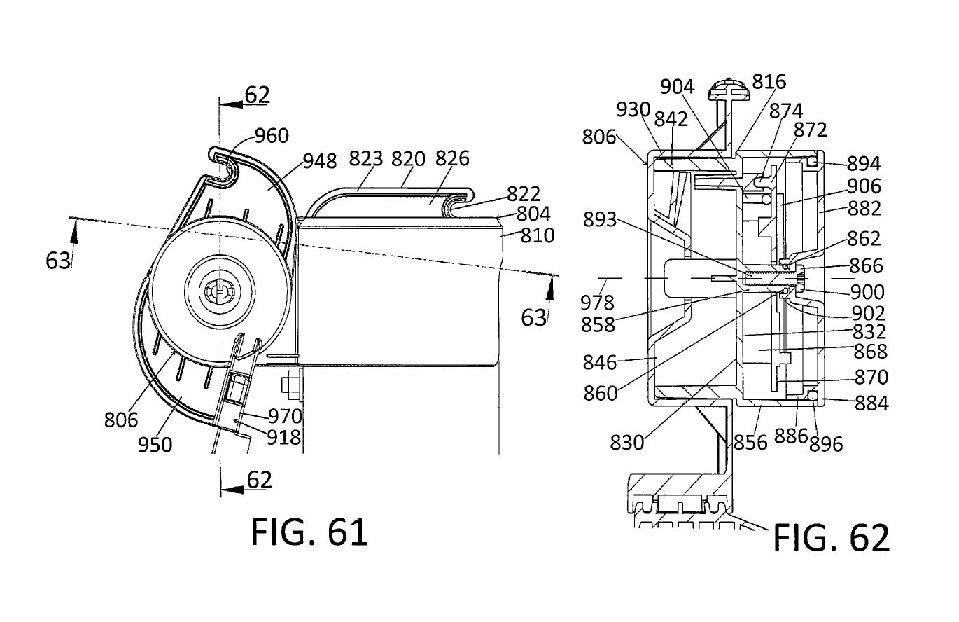

As see in FIGS. 53, 55, 56, and 59, the elastic band 958 is secured at one end to the nose 822 (FIG. 61) of the hook member 820 and secured at the other end to the hooked end 960 of the upper flange portion 948. In particular, the elastic band 958 may be in the form of a closed loop in which one looped end 980 of the elastic band 958 is inserted around and engages the nose 822 of the hook member 820 and the other looped end 956 is inserted around and engages the hooked end 960 of the upper flange portion 948. When the elastic band 958 is secured to the hook member 820 and the hooked end 960 of the upper flange portion 948, the biasing force of the elastic band 958 pulls or urges the upper flange portion 948 toward the riser tube 242 (absent a larger opposing force). This action rotates the cover 806 (which is fixed with the upper flange portion 948) in the clockwise direction (as viewed in FIG. 53) until the upper flange portion 948 engages upper stop members 982, 984 integrally formed in one piece with the cap as view in FIG. 60A. This places the cover 806 in the first position. The elastic band 958 is made of an elastomeric material that is durable and able to withstand deterioration from the brine in the brine tank 34. The material of elastic band 958 is resistant to ultraviolet light. Other biasing devices such as a corrosion resistant spring maybe used instead of the elastic band.

As seen in FIGS. 55, 60A, 60B, and 63, the cap 810 is mounted on top of the riser tube 242. Specifically, the cap 810 slides over and receives the top of the riser tube 242 so that the inner surface of the cap 810 is in frictional engagement with the riser tube 242. As best seen in FIG. 55, the brine line 146 (shown in phantom lines) is routed through the notch 818. To remove the apparatus 802 from the riser tube 242, a user grasps the top portion 804 and lifts the cap 810 off of the top of the riser tube 242.

When the assembled apparatus 802 is not mounted to the riser tube 242 and with no outside force pushing against the side 908 of the paddle 808, the biasing force of the elastic band 958 biases the cover 806 and paddle 808 in the first position. When the apparatus 802 is mounted to the riser tube 242 and the salt level is above the bottom 987 of the paddle 808, the force of the salt 260 bears against the side 908 of the paddle 808 and is sufficient to overcome the biasing force of the elastic band 958 to push the paddle 808 counterclockwise (as viewed in FIGS. 60B and 59) and towards the riser tube 242 to the second position as seen in FIG. 59. Since the paddle is fixed to the cover 806, the force of the salt 260 also rotates the cover 806 counterclockwise to the second position such that the upper flange portion 948 moves out of contact with the upper stop members 982, 984. Lower stop members 986, 988 (FIG. 60B) integrally formed in one piece with the side wall 814 of the cap 810 engage the female part 970, as seen in FIG. 60B, to prevent further counterclockwise rotation of the cover 806 and paddle 808 should the force from the salt 260 in the brine at a certain level be at a magnitude to move the female part 970 against the lower stop members 986, 988. In the second position, the longitudinal axis of the receiver light pipe 854 is not aligned over the reflecting dish 944 of the reflector 940 as seen in FIGS. 59 and 60B. Thus, the infrared transistor receiver 876 does not receive the light reflected from the reflecting dish 944 emitted by the light emitting diode transmitter 874 through the transmitter light pipe 852. This second position indicates that the salt 260 in the brine tank does not need to be replenished. It should be noted that salt 260 is not located on the side 914 opposite the side 908 of the paddle 808, so that there is no counteracting force resisting the force of the salt 260 bearing against the side 908 that would prevent the cover 806 from rotating to the second position.

As seen in FIGS. 53, when the salt level goes below the bottom 987 of the paddle 808, no force acts on the side 908 of the paddle 808 to push the paddle 808 towards the riser tube 242. Thus, the biasing force of the elastic band 958 pulls or urges the upper flange portion 948 toward the riser tube 242 and rotates the cover 806 and the paddle 808 in the clockwise direction back to the first position in which the upper flange portion 948 engages the upper stop members 982, 984 (FIG. 60A). In this first position, the longitudinal axes of the transmitter and receiver light pipes 852, 854 are aligned over the reflecting dish 944 of the reflector 940 as seen in FIGS. 60A and 63. In this position, the infrared light (indicated by the arrows of FIG. 63) emitted by the light emitting diode transmitter 874 goes through the transmitter light pipe 852 and is reflected by the reflecting dish 944. This reflected light is passed through the receiver light pipe 854 and is received by the infrared transistor receiver 876. In response to receiving the reflecting light, the receiver 876 causes the RF transmitter 880 to output a signal to the remote device 878 and/or the controller 126 indicating that the salt in the brine tank needs to be replenished.

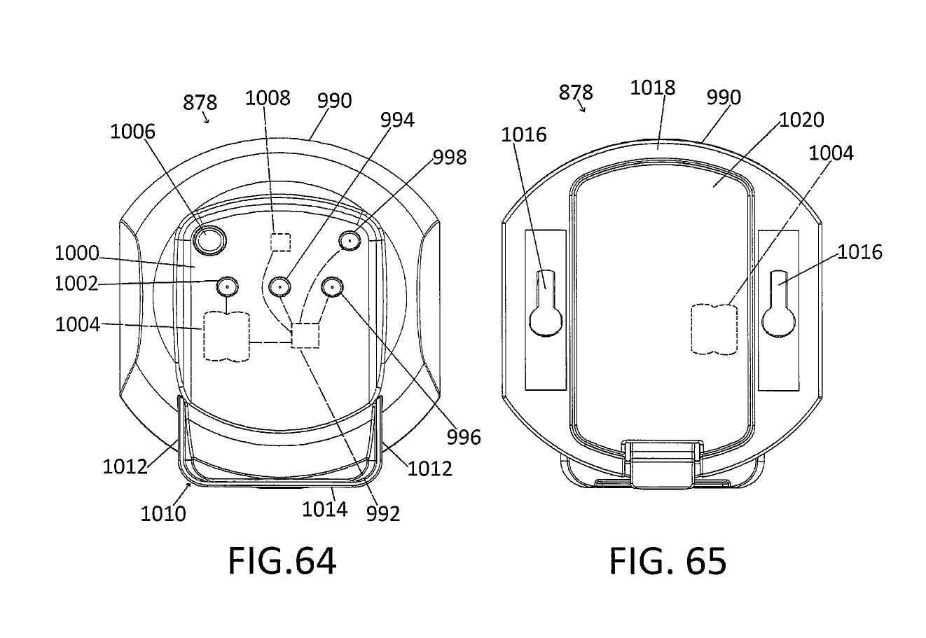

The remote device 878 may be a personal computer, laptop, iPad®, or a handheld device such as a cell phone, iPod® or any other suitable device that can wirelessly communicate with the optical sensor. An exemplary remote device 878 is shown in FIGS. 64 and 65. This remote device 878 comprises a housing 990 that houses a receiver 992 (schematically indicated in FIG. 64) that receives the signal from the RF transmitter 880 of the optical sensor 872. Referring to FIG. 64, the receiver 992 is electrically connected to first, second, and third lights 994, 996, 998 provided on a front panel 1000 of the housing 990. The first light 994 is illuminated when the receiver 992 receives the signal from the RF transmitter 880 that salt in the brine tank 34 needs to be replenished. The second light 996 is illuminated when the receiver 992 does not receive the signal from the RF transmitter 880, which illumination indicates that salt does not need to be added. The third light 998 illuminates to indicate that the receiver 992 is operating properly and does not illuminate to indicate that it is not operating properly. Alternatively, the third light 998 may illuminate to indicate that the receiver 992 is not operating properly and not illuminate to indicate that it is operating properly. A fourth light 1002 may be electrically connected to a battery 1004 that powers the remote device 878. The battery 1004 is electrically connected to the receiver 992. The fourth light 1002 illuminates when the power of the battery 1004 is low. The lights may be of any suitable type such as light emitting diodes. A push button 1006 may also be provided on the front panel 1000 of the housing 990.

The push button 1006 may be electrically connected to an audible alarm 1008 such as a buzzer. The audible alarm 1008 may be electrically connected to the receiver 992. When the audible alarm 1008 is activated due to, for example, that the salt needs to be replenished, the push button 1006 may be pushed to silence the alarm 1008 if desired. The push button 1006 may also be pushed to run a check routine to ensure that the receiver 992 or other components are operating properly. A u-shaped support stand 1010 is pivotally connected to the housing 990 to support the remote device 878 in a free standing manner. The stand 1010 includes opposite legs 1012 that are pivotally connected to the housing 990 at their free ends and a bight member 1014 that rest on a supporting surface. The remote device 878 also includes wall mounted slots 1016 provided on the rear portion 1018 of remote device 878 as seen in FIG. 65. The slots 1016 are configured to securely receive screws mounted on a wall or other structure to allow the remote device 878 to be mounted to the wall or other structure. The remote device also includes a battery compartment 1020 that houses the battery 1004.

Alternatively or in addition, the remote device 878 may include a display screen that can display a message such as “ADD SALT” or any other message indicating that the salt is low and needs to be replenished. The audible device 1008 may be configured to output verbal messages such as a message indicating that the salt needs to be replenished. The remote device may be wirelessly connected to the internet via a WIFI connection or hard wired to the internet. Also, if the RF transmitter 880 transmits the signal to the controller 126, the controller 126 may cause a light on the control module 124 to illuminate or cause a display screen on the control module to display a message indicating that the salt is low and needs to be replenished. Also, upon receiving the signal, the controller 126 may cause an audible alarm on the control module 124 to be activated to output a verbal message or sound indicating that the salt is low and needs to be replenished.

The top portion 804 and elements integrally formed with the top portion 804 are integrally molded together in one piece by plastic injection molding. The plastic material in which the top portion 804 and elements integrally formed with the top portion 804 is made of may be any suitable type that is resistant to the brine solution and ultraviolet light. Similarly, the paddle 808 and elements integrally formed with the paddle 808 are integrally molded together in one piece by plastic injection molding. The plastic material in which the paddle 808 and elements integrally formed with the paddle 808 is made of may also be any suitable type that is resistant to the brine solution and ultraviolet light. Also, the cover 806 and elements integrally formed with the cover 806 are integrally molded together in one piece by plastic injection molding. The plastic material in which the cover 806 and elements integrally formed with the cover is made of may also be any suitable type that is resistant to the brine solution and ultraviolet light. The lid 882 and screw 866 may also be made of plastic material that is resistant to the brine solution and ultraviolet light. This feature allows for ease of assembly of the apparatus 802 and reduces the number of parts needed to make the apparatus 802. The apparatus 802 of this exemplary embodiment is also in general relatively easy to assemble and mount to the riser tube 242.

Alternative actuating devices or sensors may be used instead of the optical sensor to indicate that the salt needs to be replenished upon actuation. For example, a microswitch such as the microswitch 268 shown in FIG. 14 may be mounted in the rear compartment 846 to the rear face 830 of the mounting ear 816 and be actuated by a tab or other part of the rotatable cover 806 engaging the push button 266 to send a signal to the remote device 878 or controller 126 indicating that the salt needs to be replenished. Other actuating devices or sensors may include a mercury switch mounted to the rotatable cover 806 such that when the mercury switch is tilted upon rotation of the cover 806, the switch sends a signal to the remote device 878 or controller 126 indicating that the salt needs to be replenished. Other actuating devices or sensing systems may also include capacitive sensing systems and inductive sensing systems.

Other actuating devices or sensors may also include Hall effect sensor(s) that may be used in conjunction with a magnet, which would be positioned on the rotatable cover 806. The position of the magnet would be sensed by the Hall effect sensor upon rotation of the cover between the first and second positions. For example, the Hall effect sensor would sense that the magnet is in the vicinity of the Hall effect sensor when in the first position. Upon sensing this condition, the Hall effect sensor would then cause the RF transmitter 880 to output a signal to the remote device 878 and/or the controller 126 indicating that the salt in the brine tank needs to be replenished.

The operation of the exemplary water softener 30 will now be discussed. Referring to FIG. 1, the control valve 36 is in the service position in which the untreated water inlet orifice 274 is in fluid communication with the top opening 54 of the resin tank 32, and the distribution tube 55 of the resin tank 32 is in fluid communication with the treated water outlet orifice 276. The brine valve 140 is in the closed position blocking fluid from entering or exiting the brine tank 34. In this closed position, the upper end of the valve stem 148 is located adjacent the trailing end 182 (in the counterclockwise direction as shown in FIG. 10) of the cam projection 180 and is therefore not engaged by the cam projection 180. In this position, the push button 214 (shown in FIG. 8) is not in the recess 184 and depressed by the body 186 of the base 174 of the cam so that the microswitch 210 causes a signal to be sent to the controller 126 indicating that the brine valve 140 is in the closed position. In the service position, the piston 84 (shown in FIG. 1) is in a position to allow treated water to exit the outlet orifice 276. Thus, untreated water flows from the untreated water inlet orifice 274 through the resin tank 32 and then through the distribution tube 55 to the outlet orifice 276 of the valve body 56 and to a treated water line 40.

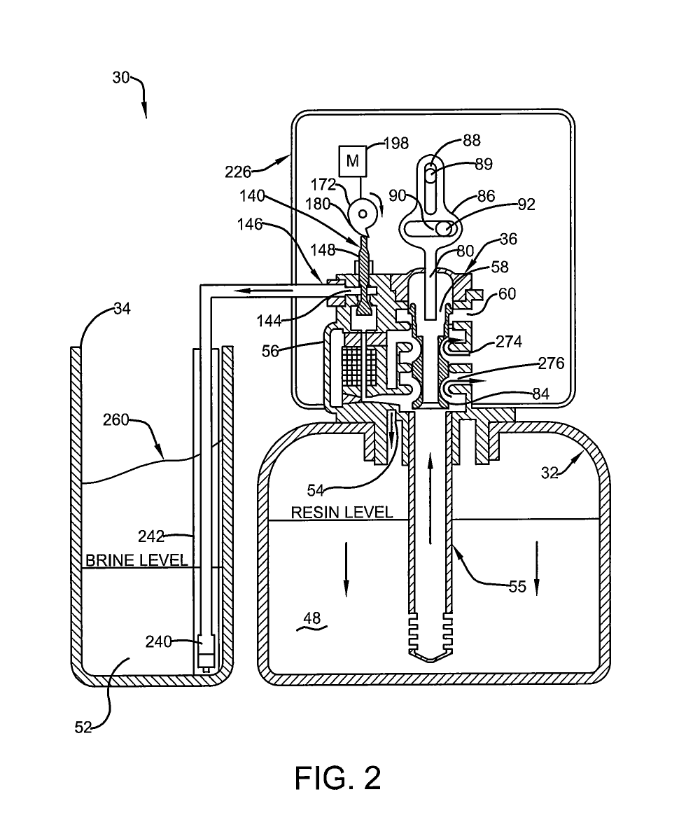

When the system determines that the ion exchange capacity of the resin bed 48 will be exhausted in a designated period, a regeneration cycle may commence. This decision may be based on the time since the last regeneration cycle and/or sensed usage and/or other factors. To begin a regeneration cycle, the motor 102 for the piston 84 causes the piston 84 to move to the fill position shown in FIG. 2. Also, the motor 198 for the brine valve 140 causes the cam 172 to rotate clockwise until the cam projection 180 engages and moves the valve stem 148 down to open the valve 140 and allow fluid communication with the brine port 144 and the brine tank 34. In this position, the untreated water inlet orifice 274 remains in fluid communication with the top opening 54 of the resin tank 32, and the distribution tube 55 is now in fluid communication with both the treated water outlet orifice 276 and the brine port 144. Thus, treated water flows to both the treated water outlet orifice 276 and into the brine tank 34 thereby filling the brine tank 34 with treated water to dissolve some of the particles such as salt in the brine tank 34, thereby forming regenerate solution 52. In this position too, the push button 214 is extended into the recess 184 so that the microswitch 210 causes a signal to be sent to the controller 126 indicating that the brine valve 140 is in the open position.

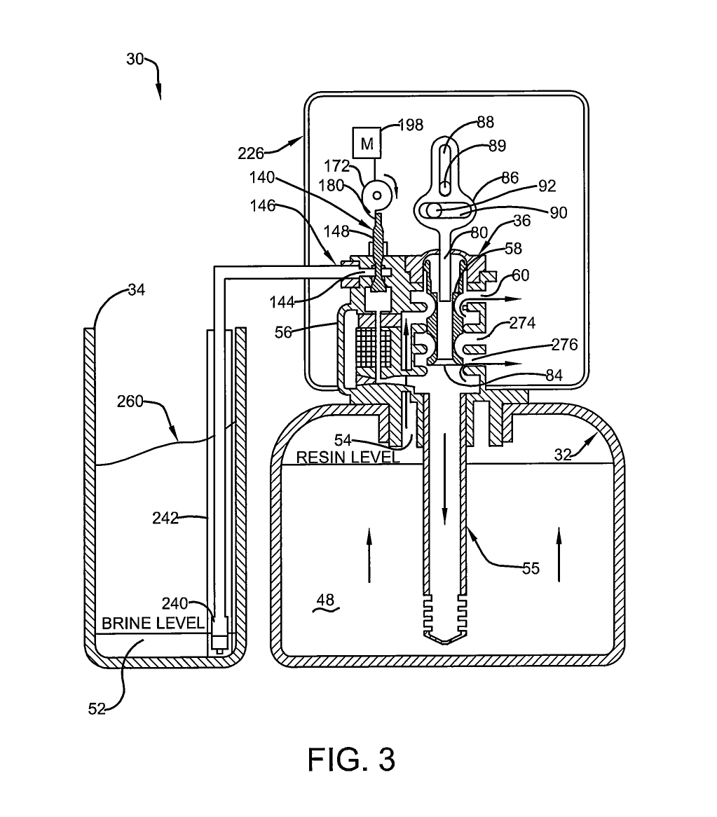

When the fill phase is complete, the motor 102 for the piston 84 causes the piston 84 to move to the backwash position shown in FIG. 3. Also, the motor 198 for the brine valve 140 causes the cam 172 to rotate clockwise until the cam projection 180 is disengaged from the valve stem 148 to place the brine valve 140 in the closed position to prevent fluid from flowing into or out of the brine tank 34. In this position, the top opening 54 of the resin tank 32 is in fluid communication with the drain port 60, and the untreated water inlet orifice 274 is in fluid communication with both the treated water outlet orifice 276 and the distribution tube 55. Thus, untreated water entering from the inlet orifice 274 flows both through the outlet orifice 276 to supply untreated water to the treated water line, and also through the distribution tube 55. The untreated water flows down through the distribution tube 55 and up through the resin bed 48 and out the drain port 60 to flush trapped particulate matter from the resin bed 48. In this position, the push button 214 (shown in FIG. 8) is not in the recess and is depressed by the cam so that the microswitch 210 causes a signal to be sent to the controller 126 indicating that the brine valve 140 is in the closed position.

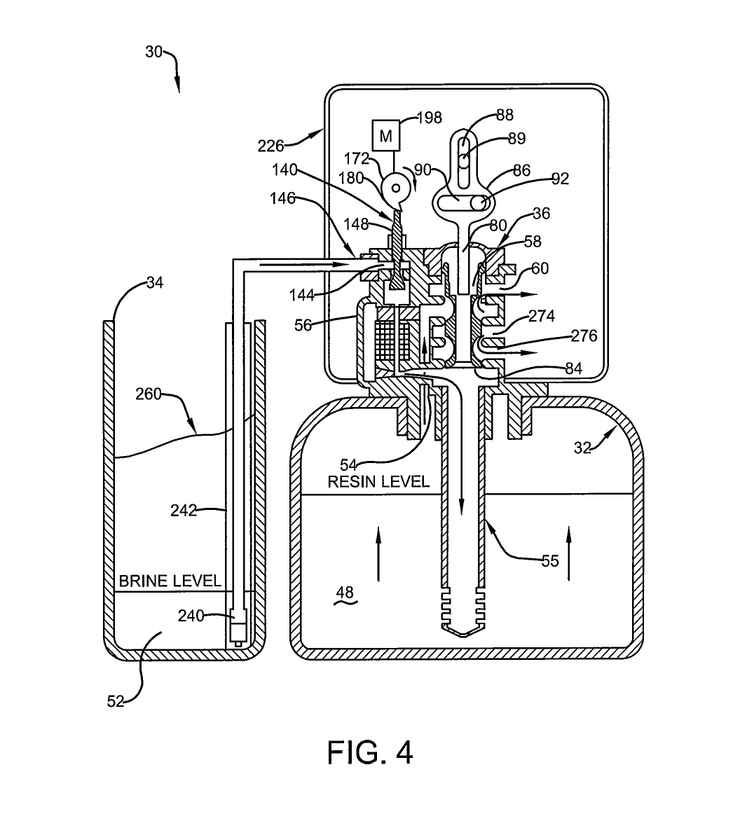

After the back wash phase, the motor 102 for the piston 84 causes the piston 84 to move to the regenerate position shown in FIG. 4. Also, the motor 198 for the brine valve 140 causes the cam 172 to rotate clockwise until the cam projection 180 engages and moves the valve stem 148 down to open the brine valve 140 and allow fluid communication with the brine port 144 and brine tank 34. In this position, the untreated water inlet orifice 274 is in fluid communication with the treated water outlet orifice 276, the brine port 144 is in fluid communication with the distribution tube 55, and the top opening 54 of the resin tank 32 is in fluid communication with the drain port 60. In this position, the pump 240 pumps brine 52 from the brine tank 34 through the brine port and through the distribution tube 55. The brine 52 goes down through the distribution tube 55 and then up through the resin bed 48 and then through the tank opening 54 to the drain port 60, thereby flushing the resin tank 32 with the regenerate solution to regenerate the resin bed 48 by replacing objectionable ions such as calcium ions in the exhausted resin bed 48 with less objectionable ions such as sodium ions. This operation is called upflow regeneration since the brine 52 flows first through the distribution tube 55 and then up through the resin bed 48 and the top opening 54 of the resin tank 32 and then to the drain port 60. In this position too, the push button 214 is extended so that the microswitch 210 causes a signal to be sent to the controller 126 indicating that the brine valve 140 is in the open position.

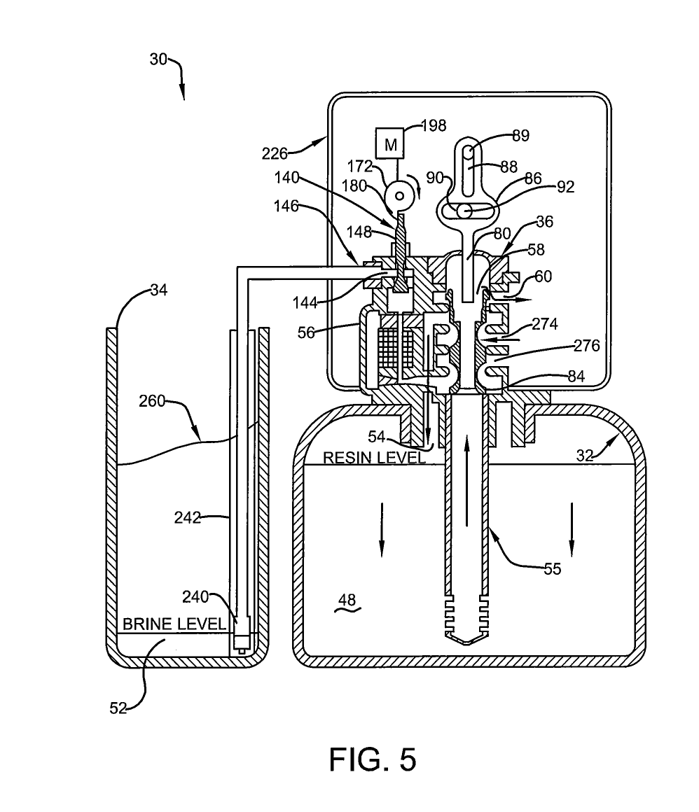

After the regeneration phase of the cycle is complete, the motor 102 causes the piston 84 to move to the rapid rinse position seen in FIG. 5. Also, the motor 198 for the brine valve 140 causes the cam 172 to rotate clockwise until the cam projection 180 is disengaged from the valve stem 148 to place the brine valve 140 in the closed position to prevent fluid from flowing into or out of the brine tank 34. In this position, the untreated water inlet orifice 274 is connected to the treated water outlet orifice 276 and the top opening 54 of the resin tank 32. The distribution tube 55 is connected to the drain port 60, thereby rinsing the resin tank 32 with untreated water to remove the regenerate solution 52 from the resin tank 32. The resin bed 48 is now fully-regenerated and ready to resume water treatment. In this position too, the push button 214 (shown in FIG. 8) is depressed so that the microswitch 210 causes a signal to be sent to the controller 126 indicating that the brine valve 140 is in the closed position. The motor 102 for the piston 84 then causes the piston 84 to move back to the service position and the motor 198 for the brine valve 140 causes the brine valve 140 to be in the service position as shown in FIG. 1 to resume normal operation of the water softener.

In another exemplary embodiment, brine is supplied to the resin bed 48 in a manner that greatly increases the efficiency of regeneration. In this exemplary embodiment, the resin bed 48 is only backwashed periodically on spaced intervals instead of every regeneration cycle. For example, the resin bed 48 may be backwashed every fifth regeneration cycle. This interval for the back wash may vary depending on the pretreatment of the untreated water. This periodic backwash allows the resin bed 48 to be more efficient, since it is not disturbed by a backwash cycle each time it is regenerated.

In this exemplary embodiment, the cycle begins with the brine line being opened and the brine tank 34 being filled with an amount of untreated water to make a minimum amount of saturated brine that would match the theoretical amount of saturated brine that would regenerate the given amount of resin if very high efficiency levels were achieved. After several hours of saturation have elapsed, the brine is pumped by the pump 240 into the bottom of the resin tank 32 to slowly displace the existing water around the resin bed 48 with brine that is immediately being diluted by the treated water. The brine is allowed to reside around the resin bed 48 for a period of time to commence the ion exchange process. The controller 126 then operates the components of the water softener to cause a controlled amount of treated water to flow into the brine tank 34 that will be immediately pumped into the resin tank 32 before it can dissolve any amount of salt. As the brine enters the resin bed area it will completely surround the resin bed 48 with a now diluted brine that is diluted to the most effective concentration for an efficient regeneration. A greatly shortened final rinse is then initiated to remove the transfer byproducts. The water is reduced because the free board area above the resin is not contaminated with calcium and brine as it is in the previously mentioned brining method. This also contributes to a reduced water use.

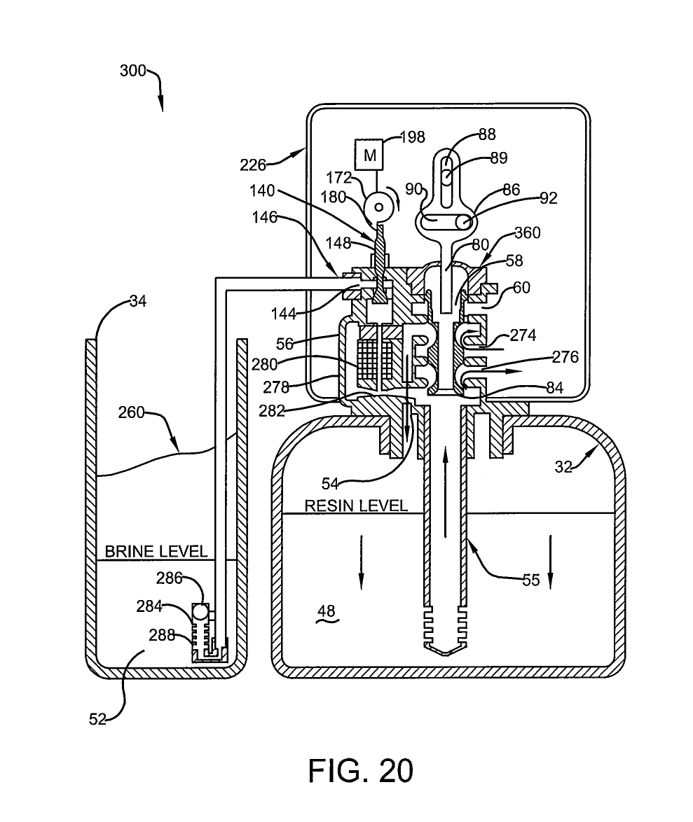

In another exemplary embodiment, a venturi type injector 278 may be used instead of the pump to draw brine from the brine tank 34 into the resin tank 32. Such an arrangement is shown in FIG. 20-24, which illustrate the operation of another example embodiment of a water softener 300. In this exemplary embodiment, the same reference numbers are used for elements that are similar in construction and function as that of the water softener 30 of the previous embodiment. In particular, the injector 278 is provided in the control valve 360. The injector 278 includes a control valve 280 and venturi nozzle 282 in which untreated water flows therethrough to draw brine from the brine tank 34 into the resin tank 32. The operation of this water softener is as follows. Referring to FIG. 20, the control valve 360 is in the service position in which the untreated water inlet orifice 274 is in fluid communication with the top opening 54 of the resin tank 32, and the distribution tube 55 of the resin tank 32 is in fluid communication with the treated water outlet orifice 276. The brine valve 140 is in the closed position blocking fluid from entering or exiting the brine tank 34. In this closed position, the upper end of the valve stem 148 is located adjacent the trailing end 182 (in the counterclockwise direction) of the cam projection 180 and is therefore not engaged by the cam projection 180. In this position, the push button 214 is not in the recess 184 and depressed by the body 186 of the base 174 of the cam 172 so that the microswitch 210 causes a signal to be sent to the controller 126 indicating that the brine valve 140 is in the closed position. In the service position, the piston 84 is in a position to allow treated water to exit the outlet orifice 276. Thus, untreated water flows from the untreated water inlet orifice 274 through the resin tank 32 and then through the distribution tube 55 to the outlet orifice 276 of the valve body 56 and to a treated water line 40 shown in FIG. 20.

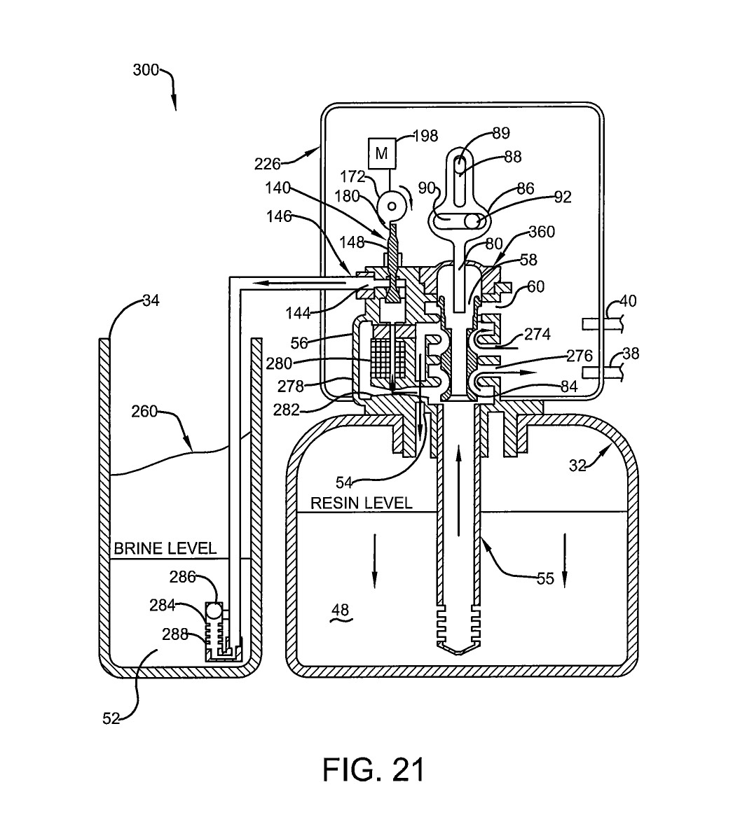

When the system determines that the ion exchange capacity of the resin bed 48 will be exhausted in a designated period, a regeneration cycle may commence. This decision may be based on the time since the last regeneration cycle and/or sensed usage and/or other factors. To begin a regeneration cycle, the motor 102 for the piston 84 causes the piston 84 to move to the fill position shown in FIG. 21. Also, the motor 198 for the brine valve 140 causes the cam 172 to rotate clockwise until the cam projection 180 engages and moves the valve stem 148 down to open the valve 140 and allow fluid communication with the brine port 144 and the brine tank 34. In this position, the untreated water inlet orifice 274 remains in fluid communication with the top opening 54 of the resin tank 32, and the distribution tube 55 is now in fluid communication with both the treated water outlet orifice 276 and the brine port 144. Thus, treated water flows to both the treated water outlet orifice 276 and into the brine tank 34 thereby filling the brine tank 34 with treated water to dissolve some of the particles such as salt in the brine tank 34, thereby forming regenerate solution 52. In this position too, the push button 214 is extended into the recess 184 so that the microswitch 210 cause a signal to be sent to the controller 126 indicating that the brine valve 140 is in the open position.

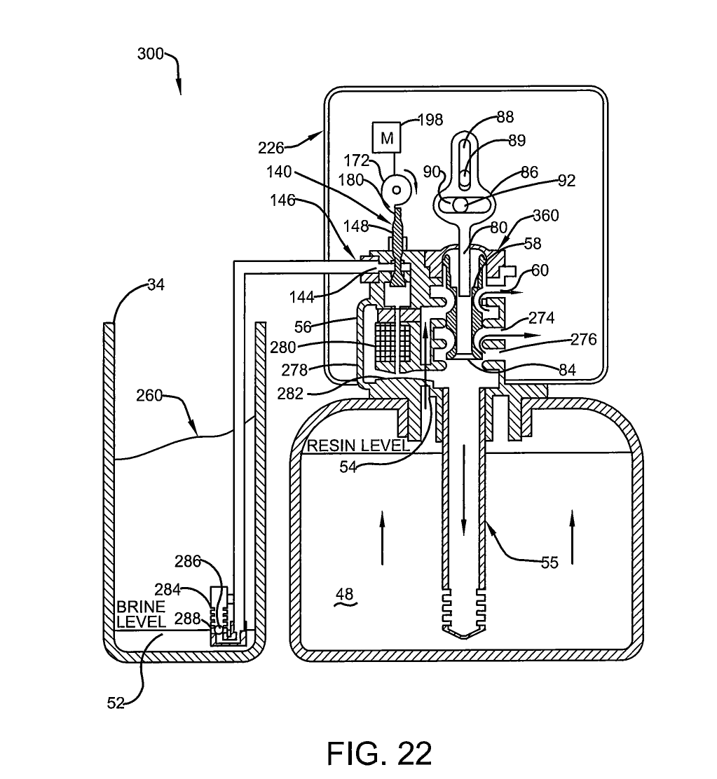

When the fill phase is complete, the motor 102 for the piston 84 causes the piston 84 to move to the backwash position shown in FIG. 22. Also, the motor 198 for the brine valve 140 causes the cam 172 to rotate clockwise until the cam projection 180 is disengaged from the valve stem 148 to place the brine valve 140 in the closed position to prevent fluid from flowing into or out of the brine tank 34. In this position, the top opening 54 of the resin tank 32 is in fluid communication with the drain port 60, and the untreated water inlet orifice 274 is in fluid communication with both the treated water outlet orifice 276 and the distribution tube 55. Thus, untreated water entering from the inlet orifice 274 flows both through the outlet orifice 276 to supply untreated water to the treated water line, and also through the distribution tube 55. The untreated water flows down through the distribution tube 55 and up through the resin bed 48 and out the drain port 60 to flush trapped particulate matter from the resin bed 48. In this position, the push button is not in the recess and is depressed by the cam so that the microswitch 210 causes a signal to be sent to the controller 126 indicating that the brine valve 140 is in the closed position.

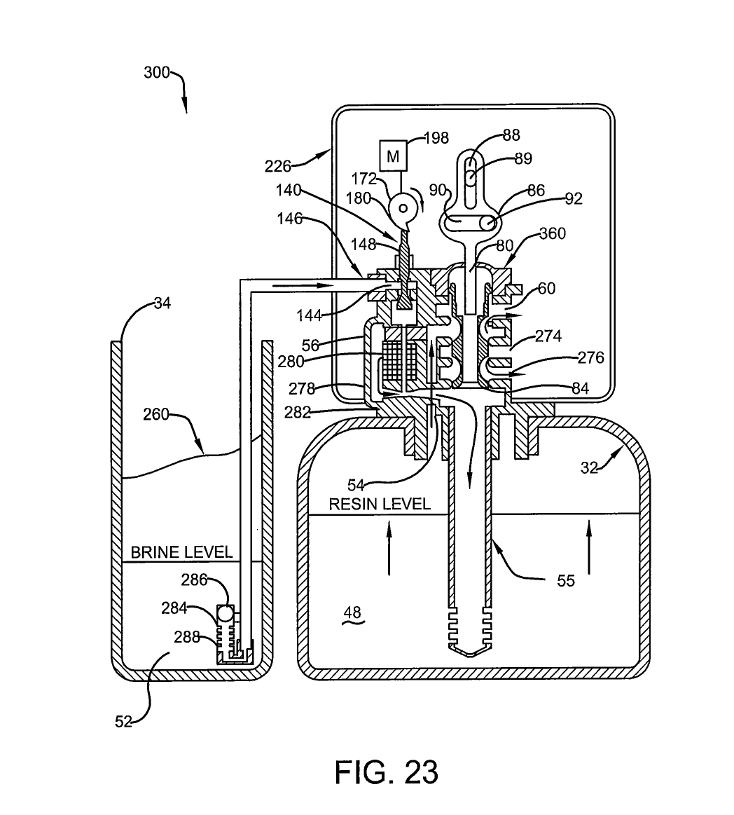

After the back wash phase, the motor 102 for the piston 84 causes the piston 84 to move to the regenerate position shown in FIG. 23. Also, the motor 198 for the brine valve 140 causes the cam 172 to rotate clockwise until the cam projection 180 engages and moves the valve stem 148 down to open the brine valve 140 and allow fluid communication with the brine port 144 and brine tank 34. In this position, the untreated water inlet orifice 274 is in fluid communication with the treated water outlet orifice 276, the brine port 144 is in fluid communication with the distribution tube 55 and untreated water inlet orifice 274, and the top opening 54 of the resin tank 32 is in fluid communication with the drain port 60. In this position, the untreated water enters the inlet orifice 274 and flows into injector control valve 280 and through the injector nozzle 282 to draw brine from the brine tank into the distribution tube 55.

The brine 52 goes down through the distribution tube 55 and then up through the resin bed 48 and then through the tank opening 54 to the drain port 60, thereby flushing the resin tank 32 with the regenerate solution to regenerate the resin bed 48 by replacing objectionable ions such as calcium ions in the exhausted resin bed 48 with less objectionable ions such as sodium ions. As discussed previously, this operation is called upflow regeneration since the brine 52 flows first through the distribution tube 55 and then up through the resin bed 48 and the top opening 54 of the resin tank 32 and then to the drain port 60. In this position too, the push button 214 is extended so that the microswitch 210 causes a signal to be sent to the controller 126 indicating that the brine valve 140 is in the open position.

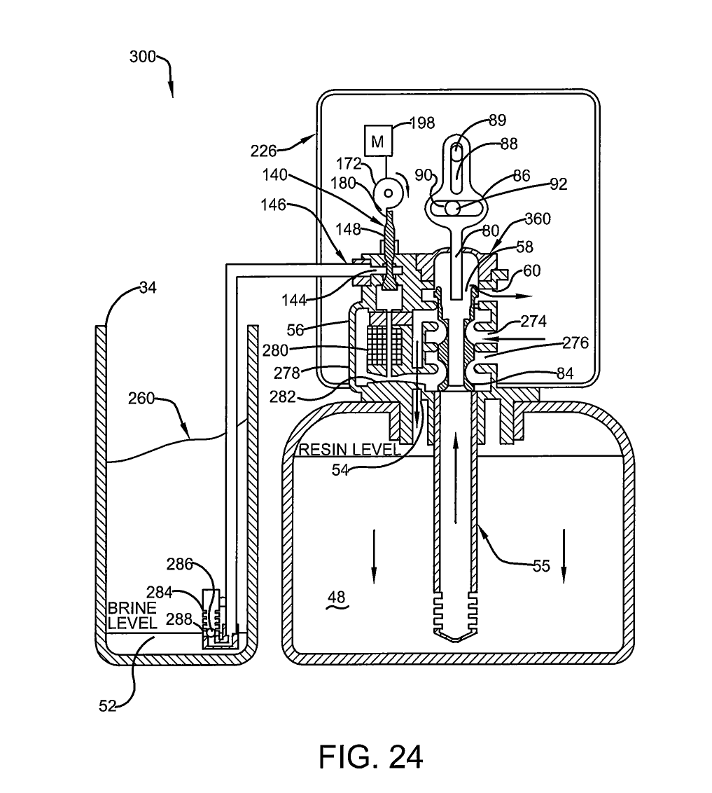

After the regeneration phase of the cycle is complete, the motor 102 causes the piston 84 to move to the rapid rinse position seen in FIG. 24. Also, the motor 198 for the brine valve 140 causes the cam 172 to rotate clockwise until the cam projection 180 is disengaged from the valve stem 148 to place the brine valve 140 in the closed position to prevent fluid from flowing into or out of the brine tank 34. In this position, the untreated water inlet orifice 274 is connected to the treated water outlet orifice 276 and the top opening 54 of the resin tank 32. The distribution tube 55 is connected to the drain port 60, thereby rinsing the resin tank 32 with untreated water to remove the regenerate solution 52 from the resin tank 32. The resin bed 48 is now fully-regenerated and ready to resume water treatment. In this position too, the push button 214 is depressed so that the microswitch 210 causes a signal to be sent to the controller 126 indicating that the brine valve 140 is in the closed position. The motor 102 for the piston 84 then causes the piston 84 to move back to the service position and the motor 198 for the brine valve 140 causes the brine valve 140 to be in the service position as shown in FIG. 20 to resume normal operation of the water softener. In the embodiment incorporating the venturi type injector, an air check arrangement 284 may be provided to indicate the brine level. The air check arrangement 284 may include a ball float 286 provided in a tube 288, which is in fluid communication with the brine line at the bottom of the brine tank 34.

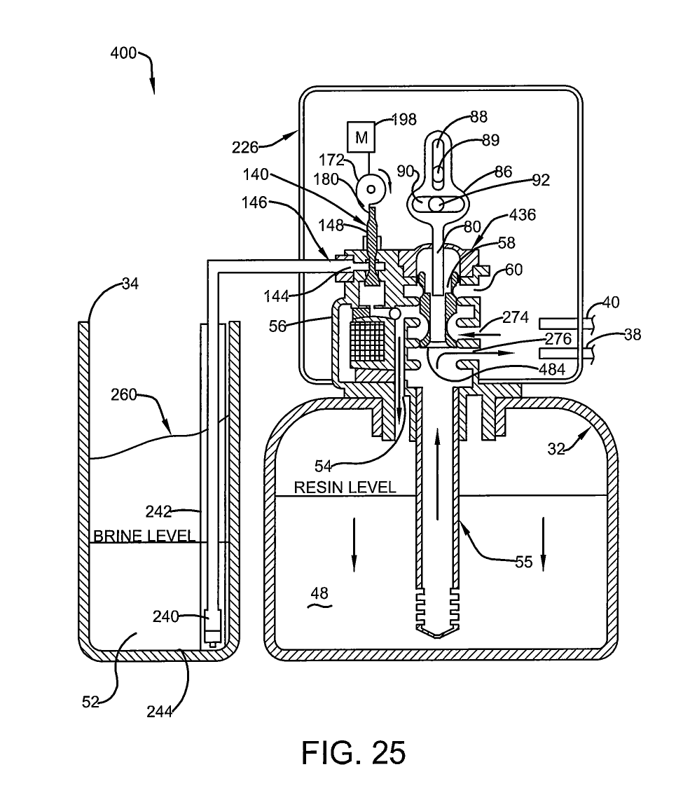

FIGS. 25-29 show another exemplary embodiment in which water softener 400 may be configured to incorporate downflow regeneration in which the brine 52 flows first down through the top opening 54 and the resin bed 48 and then up through the distribution tube 55 and then up through the resin bed 48 and the top opening 54 of the resin tank 32 and then to the drain port 60. In this exemplary embodiment the piston 484 is configured to be longer than that of the piston 84 of the previous exemplary embodiments. The same reference numbers are used for elements that are similar in construction and function as that of the water softener 30 of the previous embodiment.

The operation of the water softener 400 will now be discussed. Referring to FIG. 25, the control valve 436 is in the service position in which the untreated water inlet orifice 274 is in fluid communication with the top opening 54 of the resin tank 32, and the distribution tube 55 of the resin tank 32 is in fluid communication with the treated water outlet orifice 276. The brine valve 140 is in the closed position blocking fluid from entering or exiting the brine tank 34. In this closed position, the upper end of the valve stem 148 is located adjacent the trailing end 182 (in the counterclockwise direction) of the cam projection 180 and is therefore not engaged by the cam projection 180. In this position, the push button 266 is not in the recess 184 and is depressed by the body 186 of the base 174 of the cam so that the microswitch 210 causes a signal to be sent to the controller 126 indicating that the brine valve 140 is in the closed position. In the service position, the piston 484 is in a position to allow treated water to exit the outlet orifice 276. Thus, untreated water flows from the untreated water inlet orifice 274 through the resin tank 32 and then through the distribution tube 55 to the outlet orifice 276 of the valve body 56 and to a treated water line 40 (shown in FIG. 25).

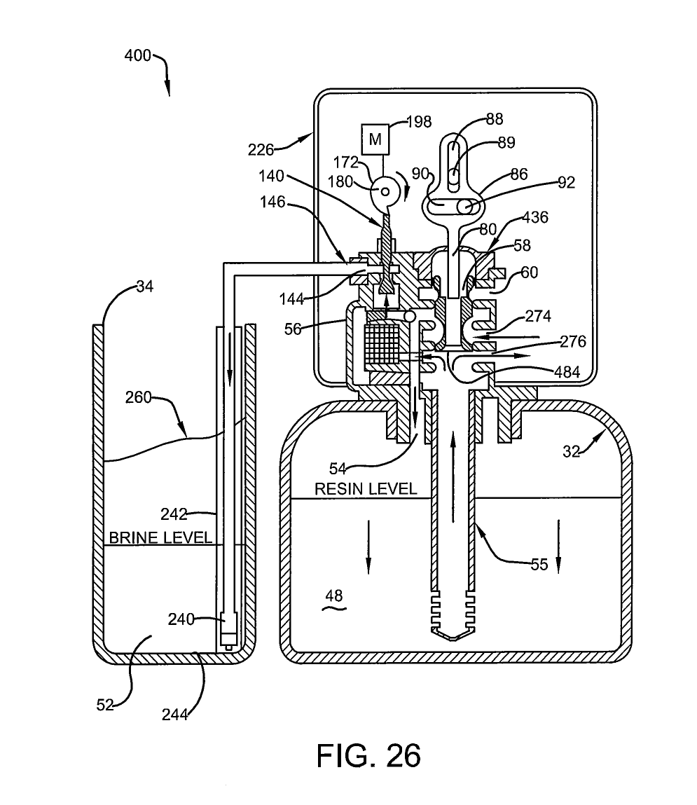

When the system determines that the ion exchange capacity of the resin bed 48 will be exhausted in a designated period, a regeneration cycle may commence. This decision may be based on the time since the last regeneration cycle and/or sensed usage and/or other factors. To begin a regeneration cycle, the motor 102 for the piston 484 causes the piston 484 to move to the fill position shown in FIG. 26. Also, the motor 198 for the brine valve 140 causes the cam 172 to rotate clockwise until the cam projection 180 engages and moves the valve stem 148 down to open the valve 140 and allow fluid communication with the brine port 144 and the brine tank 34. In this position, the untreated water inlet orifice 274 remains in fluid communication with the top opening 54 of the resin tank 32, and the distribution tube 55 is now in fluid communication with both the treated water outlet orifice 276 and the brine port 144. Thus, treated water flows to both the treated water outlet orifice 276 and into the brine tank 34 thereby filling the brine tank 34 with treated water to dissolve some of the particles such as salt in the brine tank 34, thereby forming regenerate solution 52. In this position too, the push button 214 is extended into the recess 184 so that the microswitch 210 causes a signal to be sent to the controller 126 indicating that the brine valve 140 is in the open position.

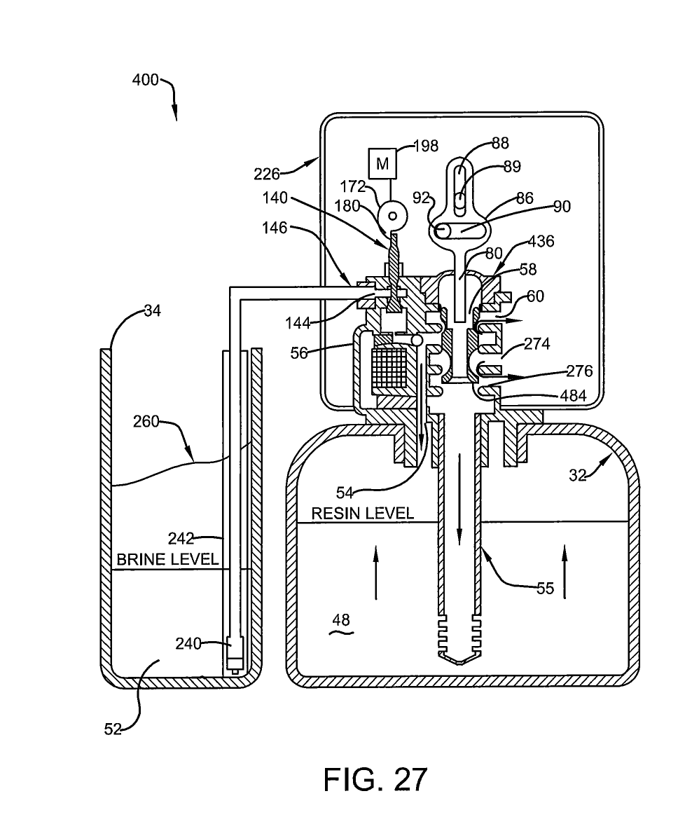

When the fill phase is complete, the motor 102 for the piston 484 causes the piston 484 to move to the backwash position shown in FIG. 27. Also, the motor 198 for the brine valve 140 causes the cam 172 to rotate clockwise until the cam projection 180 is disengaged from the valve stem 148 to place the brine valve 140 in the closed position to prevent fluid from flowing into or out of the brine tank 34. In this position, the top opening 54 of the resin tank 32 is in fluid communication with the drain port 60, and the untreated water inlet orifice 274 is in fluid communication with both the treated water outlet orifice 276 and the distribution tube 55. Thus, untreated water entering from the inlet orifice 274 flows both through the outlet orifice 276 to supply untreated water to the treated water line, and also through the distribution tube 55. The untreated water flows down through the distribution tube 55 and up through the resin bed 48 and out the drain port 60 to flush trapped particulate matter from the resin bed 48. In this position, the push button is not in the recess and is depressed by the cam so that the microswitch 210 causes a signal to be sent to the controller 126 indicating that the brine valve 140 is in the closed position.

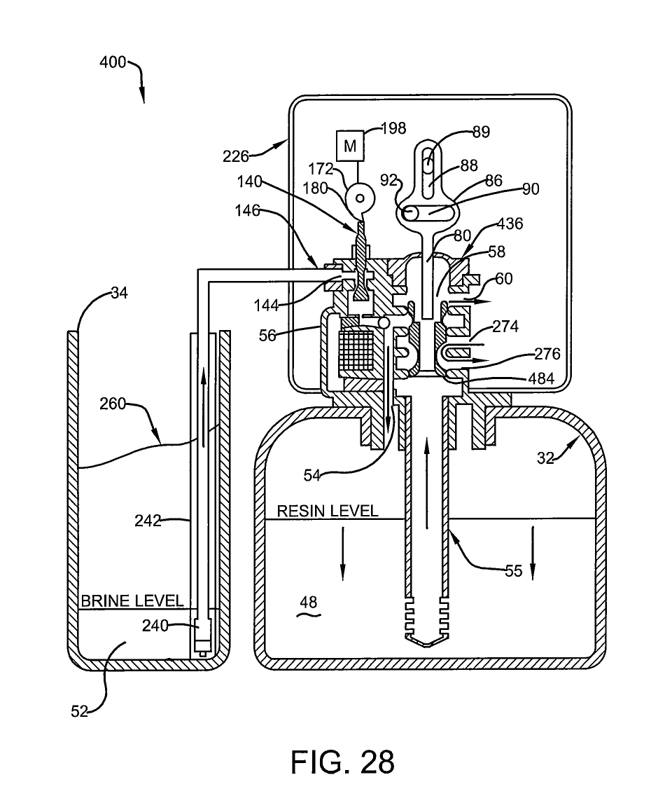

After the back wash phase, the motor 102 for the piston 484 causes the piston 484 to move to the regenerate position shown in FIG. 28. Also, the motor 198 for the brine valve 140 causes the cam 172 to rotate clockwise until the cam projection 180 engages and moves the valve stem 148 down to open the brine valve 140 and allow fluid communication with the brine port 144 and brine tank 34. In this position, the untreated water inlet orifice 274 is in fluid communication with the treated water outlet orifice 276, the brine port 144 is in fluid communication with the distribution tube 55, and the top opening 54 of the resin tank 32 is in fluid communication with the drain port 60. In this position, the pump 240 pumps brine 52 from the brine tank 34 through the brine port and through the distribution tube 55. The brine 52 goes down through the tank opening 54 and resin bed 48 and then up through the distribution tube 55 to the drain port 60, thereby flushing the resin tank 32 with the regenerate solution to regenerate the resin bed 48 by replacing objectionable ions such as calcium ions in the exhausted resin bed 48 with less objectionable ions such as sodium ions. This operation is called downflow regeneration since the brine 52 flows first through the distribution tube 55 and then up through the resin bed 48 and the top opening 54 of the resin tank 32 and then to the drain port 60. In this position too, the push button 214 is extended so that the microswitch 210 causes a signal to be sent to the controller 126 indicating that the brine valve 140 is in the open position.

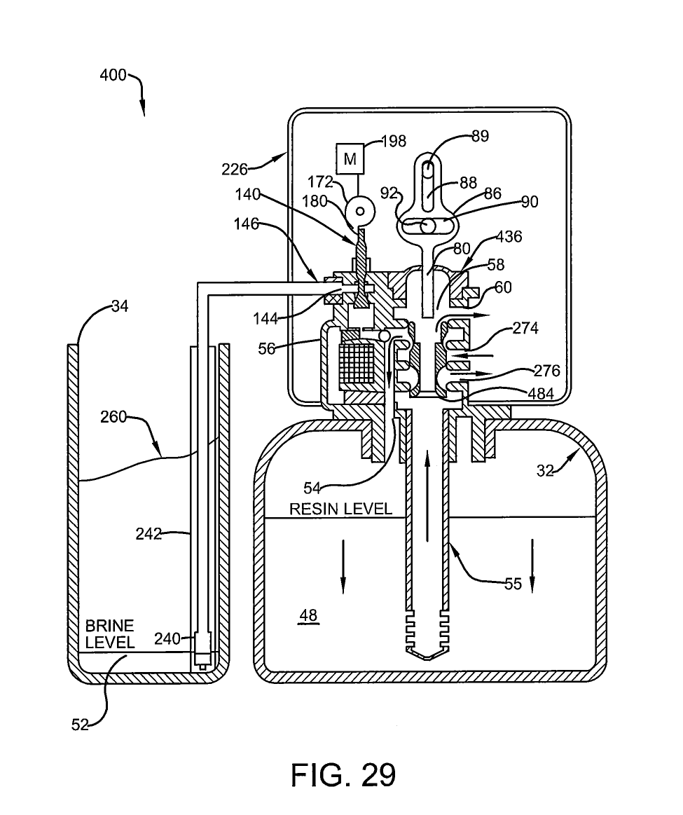

After the regeneration phase of the cycle is complete, the motor 102 causes the piston 84 to move to the rapid rinse position shown in FIG. 29. Also, the motor 198 for the brine valve 140 causes the cam 172 to rotate clockwise until the cam projection 180 is disengaged from the valve stem 148 to place the brine valve 140 in the closed position to prevent fluid from flowing into or out of the brine tank 34. In this position, the untreated water inlet orifice 274 is connected to the treated water outlet orifice 276 and the top opening 54 of the resin tank 32. The distribution tube 55 is connected to the drain port 60, thereby rinsing the resin tank 32 with untreated water to remove the regenerate solution 52 from the resin tank 32. The resin bed 48 is now fully-regenerated and ready to resume water treatment. In this position too, the push button 214 is depressed so that the microswitch 210 causes a signal to be sent to the controller 126 indicating that the brine valve 140 is in the closed position. The motor 102 for the piston 484 then causes the piston 484 to move back to the service position and the motor 198 for the brine valve 140 causes the brine valve 140 to be in the service position as shown in FIG. 25 to resume normal operation of the water softener. Alternatively, a venturi type injector such as that provided for the embodiment shown in FIGS. 20-24 may be used instead of the pump 240. In this alternative version, an air check arrangement such as that provided for the embodiment shown in FIGS. 20-24 may be provided to indicate the brine level.

Since the brine valve 140 is operated independently of the piston, the brine valve 140 may, in the open position, allow the brine tank 34 to be filled with treated water at any time prior to the regeneration phase. It also allows operation of the rapid rinse to clean any residual brine from the pump for the embodiment in which the pump is used. In another exemplary arrangement as shown in FIG. 13, the brine valve may be configured to be a three-way brine valve 340 in which it opens and closes an additional ambient air port 342 for injecting air into the control valve so as to facilitate drawing brine from the brine tank 34 or water into the brine tank 34. For example, the brine valve 340 may in a first position that closes the brine port 144 and the air port 342. The brine valve may be in a second position that opens both ports. The brine may be a third position that opens the brine port 144 and closes the air port 342, or a fourth position that closes the brine port 144 and opens the air port 342. The speed of the motor 198 may be controlled for the air releases.

For the embodiments with the pump 240, it should be noted that the pump 240 uses significantly less water to draw the brine from the brine tank 34 than that of the venturi type injector. In one example, the pump 240 may use only 4 gallons of water during the regeneration phase as opposed to 100 gallons of water which may be needed for a venturi type injector. In the embodiment in which the resin bed is backwashed periodically in spaced intervals, the amount of water may be reduced by ninety percent from that using the injector. This reduction is due in part to the fact that the amount of water that is needed when an injector pulls the brine through the resin is not required.

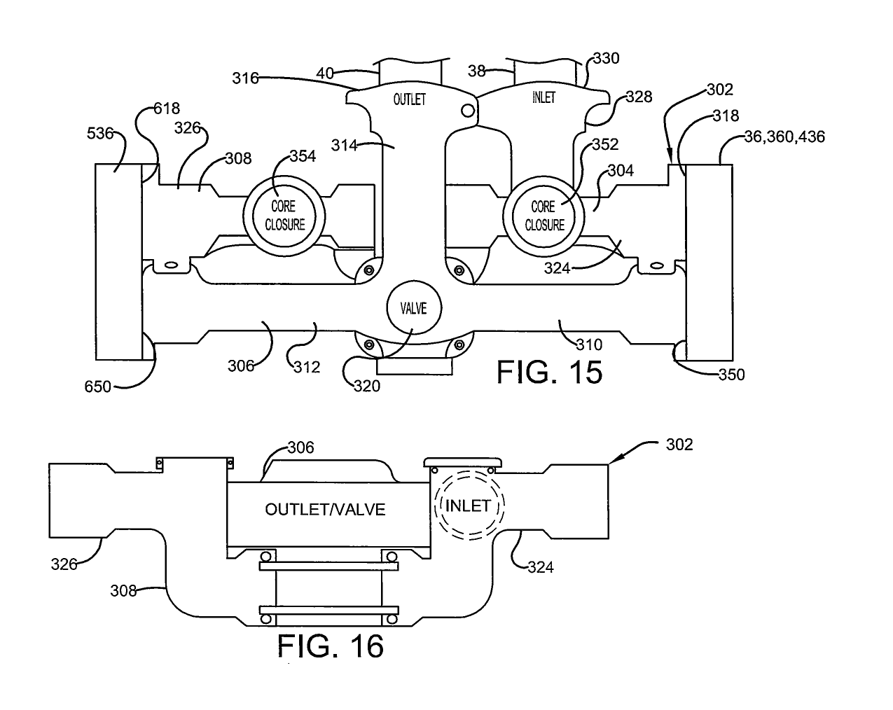

In a further embodiment, two or more of the previously described water softeners may be coupled together using a manifold 304. Referring to FIGS. 15 and 16, the manifold 304 may include a bypass valve assembly 302 that may be operatively mounted to the control valve 36, 360, or 436 and be in fluid communication with the untreated water inlet orifice 274 and treated water outlet orifice 276 located rearwardly from the valve body 56. The bypass valve assembly 302 may include knobs or other devices that can close the control valve 36 to permit the water to be bypassed for service or repair. The bypass valve assembly 302 may be configured to connect to first control valve 36, 360, or 436 and a second control valve 536 to the treated water line 40 and the untreated water line 38. The second control valve 536 may be similar to the first control valve except as discussed below. The second control valve 536 is operatively connected to another resin tank. Another brine tank is in fluid communication with the resin tank through the second control valve 536. The brine tank, resin tank and other elements of the water softener system for the second control valve may be similar in construction and/or function as that of the water softener system 30, 300 or 400 for the first control valve and thus will not be further described in the interest of brevity.

As shown in the top plan view of FIG. 15, the bypass valve assembly 302 includes an outlet flow portion 306 and an inlet flow portion 308. The outlet flow portion 306 includes first and second branches 310, 312 that merge into a main branch 314. The main branch 314 includes an outlet port 316 that is in fluid communication with the treated water line 40 for use in the home. The first branch 310 is in fluid communication with the treated water outlet port 350 of the first control valve. The second branch 312 is in fluid communication with the treated water outlet port 650 of the second control valve 536. A three-way valve 320 is provided at the junction of all of the branches 310, 312, 314 and is operative to control the flow of treated water from the outlet ports 350, 650 of the first and second flow control valves. In the first valve position, the treated water is allowed to flow from the outlet port 350 of the first control valve to the outlet port 316 of the main branch 314, but treated water from the outlet port 650 of the second control valve 536 is blocked or prevented from flowing from the outlet port 650 of the second control valve 536 to the outlet port 316 of the main branch 314. In the second valve position, the treated water is allowed to flow from the outlet port 650 of the second control valve 536 to the outlet port 316 of the main branch 314, but treated water from the outlet port 350 of the first control valve is blocked or prevented from flowing from the outlet port 350 of the first control valve to the outlet port 316 of the main branch 314. In the third valve position, the treated water from both outlet ports 350, 650 of the first and second control valves is prevented from flowing to the outlet port 316 of the main branch 314. The three-way valve 320 may be operated by an alternator motor 322 (FIG. 19) and controlled electronically by the controller 126 in the control module 124.

The inlet flow portion 308 includes first and second branches 324, 326 that merge into a main branch 328. The main branch 328 includes an inlet port 330 that is in fluid communication with the untreated water line 38. The first branch 324 is in fluid communication with the untreated water inlet port 318 of the first control valve. The second branch 326 is in fluid communication with the untreated water inlet port 618 of the second control valve 536. A first valve 352 is provided between the inlet port 318 of the first control valve and the inlet port 330 of the main branch 328. The first valve 352 is operative in an open position to allow untreated water from the untreated water line 38 to flow into the first control valve, and in a closed position to prevent untreated water from the untreated water line 38 from flowing into the first control valve. A second valve 354 is provided between the inlet port 618 of the second control valve 536 and the inlet port 330 of the main branch 328. The second valve 354 is operative in an open position to allow untreated water from the untreated water line 38 to flow into the second control valve 536, and in a closed position to prevent untreated water from the untreated water line from flowing into the second control valve 536. The first and second valves 352, 354 may include knobs or other devices to permit the valve to be turned by hand between their open and closed positions. The valves may be any suitable type such as a ball valve. Optionally, alternator motor(s) may control operation of the first and second valves 352, 354 as well as the three-way valve 320 and inflow valves of the manifold of the bypass valve assembly.

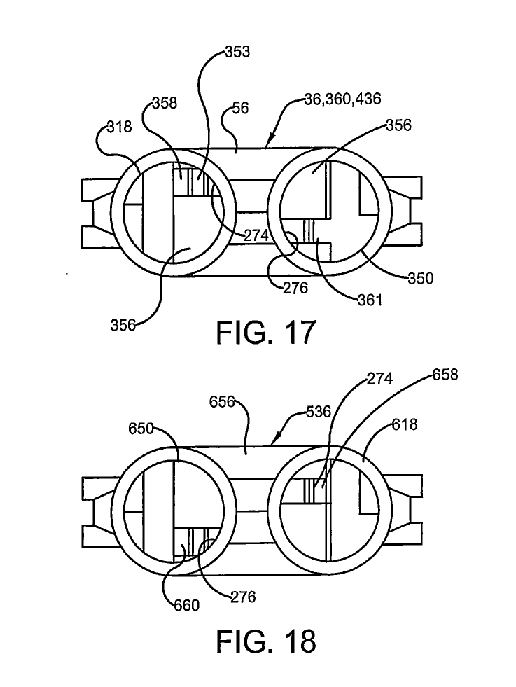

As seen in a side plan view in FIG. 16, the inlet flow portion 308 is routed underneath the main branch 314 (shown in FIG. 16) of the outlet flow portion 306. Alternatively, the main branch 314 of the outlet flow portion 306 may be routed underneath the inlet flow portion 308. As seen in FIGS. 17 and 18, the inlet and outlet ports 618, 650 of the second control valve 536 are in reverse locations to the inlet and outlet ports 318, 350 of the first control valve. This allows the outlet port 350 of the first control valve to align with the outlet port 650 of the second control valve 536 and the inlet port 318 of the first control valve to align with the inlet port 618 of the second control valve 536 so that the manifold can be easily mounted to the control valves. The process of reversing the inlet and outlet ports 618, 650 of the second control valve 536 is accomplished by reversing slots of its valve body 656 that are in fluid communication with inlet and outlet ports 618, 650 of the second control valve 536 and with inlet and outlet orifices 274, 276 of the interior of the valve body 656, after the molding the valve body.

In particular, FIG. 17 shows the inlet and outlet port 318, 350 of the first control valve. The valve body 56 includes a cavity 353 that is bounded by a wall 356. A first slot 358 is machined or cut out of the wall 356 at the upper end of the wall 356. The first slot 358 fluidly communicates with the inlet orifice 274, which is located upwardly from the outlet orifice 276, and the inlet port 318. A second slot 361 is machined or cut out of the wall 356 at the lower end of the wall 356. The second slot 361 fluidly communicates with the outlet orifice 276 and the outlet port 350. The first and second slots 358, 361 are vertically and horizontally spaced apart such that the first slot 358 is located higher than the second slot 361. The inlet port 318 is located left (as viewed in FIGS. 6 and 17 from the rear of the control valve) of the outlet port 350. FIG. 18 shows slots 658, 660 of the inlet and outlet ports 618, 650 of the second control valve 536. In this case, the inlet port 618 is now located right (as viewed in FIG. 18 from the rear of the control valve) of the outlet port 650. That is, the first slot 658 is machined or cut out of the wall 356 at the upper end of the wall 356 and fluidly communicates with the inlet orifice 274 and the inlet port 618. The second slot 660 is machine or cut out of the wall at the lower end of the wall and fluidly communicates with the outlet orifice 276 and the outlet port 650.

FIG. 19 shows an example embodiment of a control module 124 that includes a display 362 and function buttons 364 to operate one or more of the previously described water softeners. The control module 124 may include a mechanical indicator dial 366 that can be used to set the time of certain operations in the water softener. Alternatively, the control module 124 may include an electronic timer to set the time of certain operations of the water softener. An atomic clock signal receiver device (which sets the correct time via a received radio signal) 368 could be operatively connected to the timer for accurate timing and to allow adjustment of the time after a power loss or time change due to daylight savings. In another exemplary arrangement, the control module 124 may be remotely mounted to locations other than that of water softener. These remote locations may be in more convenient places for operation by a user. For example, the control module may be located in a garage or bath room of a house.

FIG. 19 also shows an electronic platform that can be incorporated with the control module. The platform may include sensors that may be connected to the control module to control the operation of the water softener(s) based on certain sensed conditions. For example, a remote moisture sensor 370 may be operatively connected to the control module 124. The control module 124 controls the control valves and three-way valve based on the sensed moisture. A moisture sensor 370 may be operatively connected to the brine tank 34 to detect moisture in the tank. The control module 124 could use the sensed data to determine when the filing or regeneration phase is occurring. The moisture sensor 370 may detect that the moisture level is low for a long period, which may indicate that the water softener is not operating correctly to fill the brine tank 34. A remote moisture sensor 370 may also be used to detect moisture coming from a broken pipe and transmit that data to the control module 124. The control module 124 would then operate the valves to prevent water from entering the water softener. For example, the controller 126 in the control module 124 may cause the piston to move to a standby position that prevents untreated water from entering the water softener. Alternatively or in addition, other types of sensors could be provided to detect broken water lines. The controller 126 also could detect power loss during the regeneration of the brine and use power from a battery 384 to cause motor 102 to move the piston to the standby position. Alternatively, a salt sensor may be operatively connected to the brine tank to detect the salt level in the brine tank. The salt sensor may be operatively connected to the controller 126 to determine when the brine tank is being filled or being emptied in response to the salt sensor.

The exemplary control module 124 may be operatively connected to a user remote device 372 as schematically illustrated in FIG. 19 that allows a user to shut off the water to the water softener system when they go on vacation or operate the control valve(s) to temporarily bypass the water softener. The control module 124 may be operatively connected to a smart grid 374 associated with an electric company. The control module 124 may be connected to an internet interface 376 to allow access and control of the water softener by a user over the internet. The control module 124 may also be operatively connected to telemetry systems that provide information in which the control module 124 uses to control the water softener. As illustrated in FIG. 19, the control module 124 may operate to control the motors of the first and second control valves connected to the bypass valve assembly in a manner that continues the supply of treated water to the household even, for example, during the regeneration, rapid rinse, or back wash phases of one of the water softeners associated with one of the control valves or at any other time that the water softener is not operative to supply treated water to the household. In particular, the control module 124 may be operatively connected to a leading slave board 378, which is operatively connected to the piston motor 102 and brine valve motor 198 of the first control valve 36. The control module 124 may be operatively connected to a lagging slave board 380, which is operatively connected to the piston motor 102 and brine valve motor 198 of the second control valve 536. The alternator motor 322 is operatively connected to the leading slave board 378.

In operation, the first control valve 36 is operative to allow operation of its associated water softener. When the control module 124 receives data that the water softener is about to enter the one of the phases in the regeneration cycle (e.g. regeneration, rapid rinse, or back wash), the control module 124 sends a control signal to the second control valve 536 to place it in the service position. This data may come from a flow meter or the moisture or other sensors. Alternatively, the data may come from the timer that causes the regeneration cycle to operate at a predetermined time. The control module 124 also sends a control signal via the leading slave board to the alternator motor 322 to control the three-way valve 320 to place it in the position to prevent treated water from first control valve 36 from flowing into the treated water line 40 but allow treated water from the second control valve 536 to flow into the treated water line 40. When the regeneration cycle of the water softener associated with the first control valve 36 is complete and the first control valve 36 is in the service position, the control module 124 sends a control signal via the leading slave board 378 to the alternator motor 322 to control the three-way valve 320 to place it in the position to prevent treated water from the second control valve 536 from flowing into the treated water line 40 but allow treated water from the first control valve 36 to flow into the treated water line 40. The control module 124 may be connected to the above-mentioned components shown in FIG. 19 by a hard wire connection 381 or wireless connection 382. The wireless technology may be a Zigby, Bluetooth, or Near Field Communication (NFC).

The functions of the controller described herein may be implemented using computer executable instructions (e.g. whether software or firmware) operate to execute in one or more processors. Such instructions may be resident on and/or loaded from computer readable media or articles of various types into the respective processors. Such computer executable software instructions may be included on and loaded from one or more articles of computer readable media such as firmware, hard drivers, solid state drives, flash memory devices, CDs, DVDs, tapes, RAM, ROM and/or other local, remote, internal, and/or portable storage devices placed in operative connection with the described system and other systems described herein.

Water softener systems may use large amounts of water and salt to regenerate the resin bed. This additional amount of water and salt adds to the cost of operating the water softener system and also the wasted brine is sent down in the drain, which may be bad for the environment. In addition, consumer and regulatory agencies are demanding that water softeners use less water and salt.

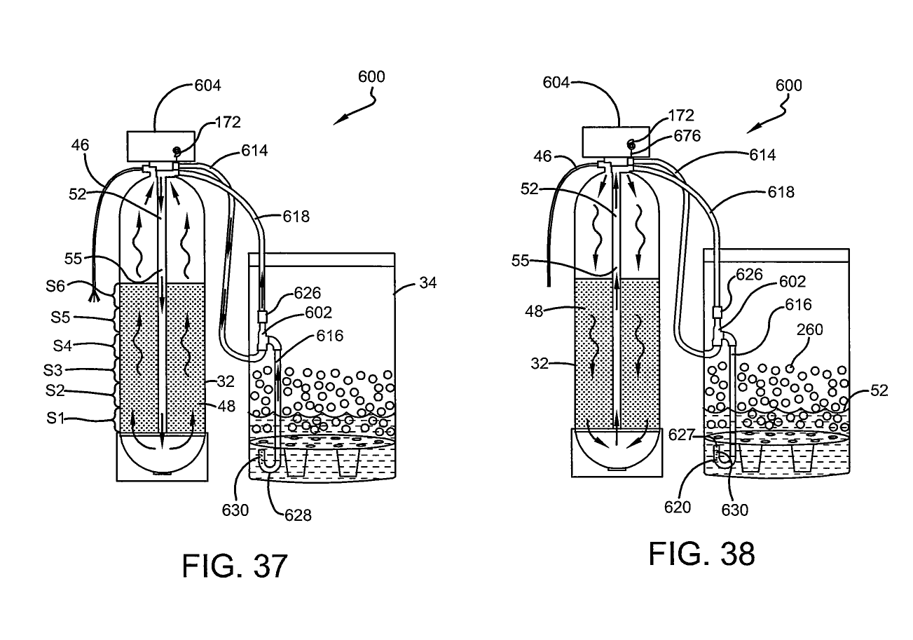

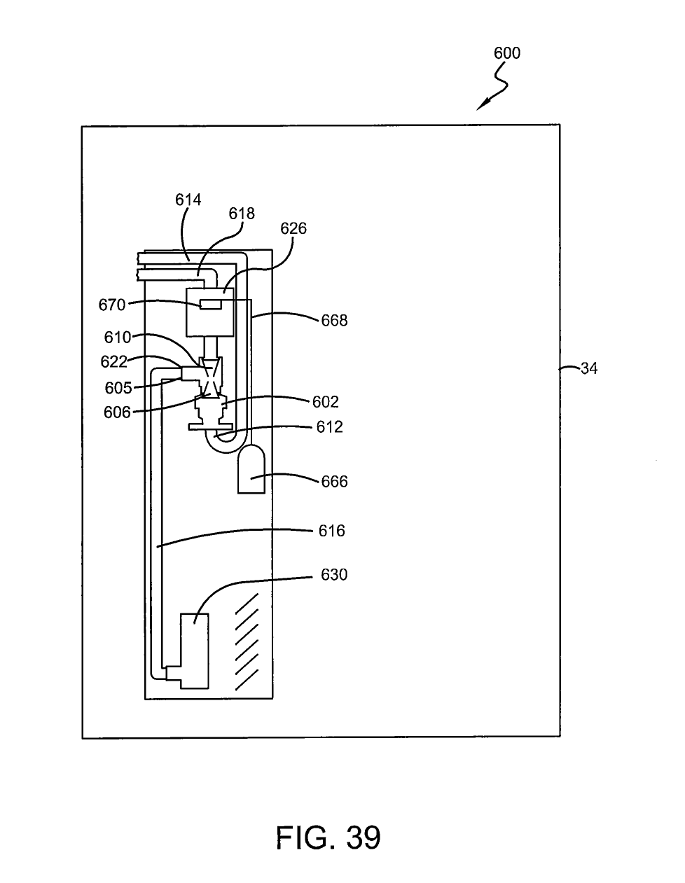

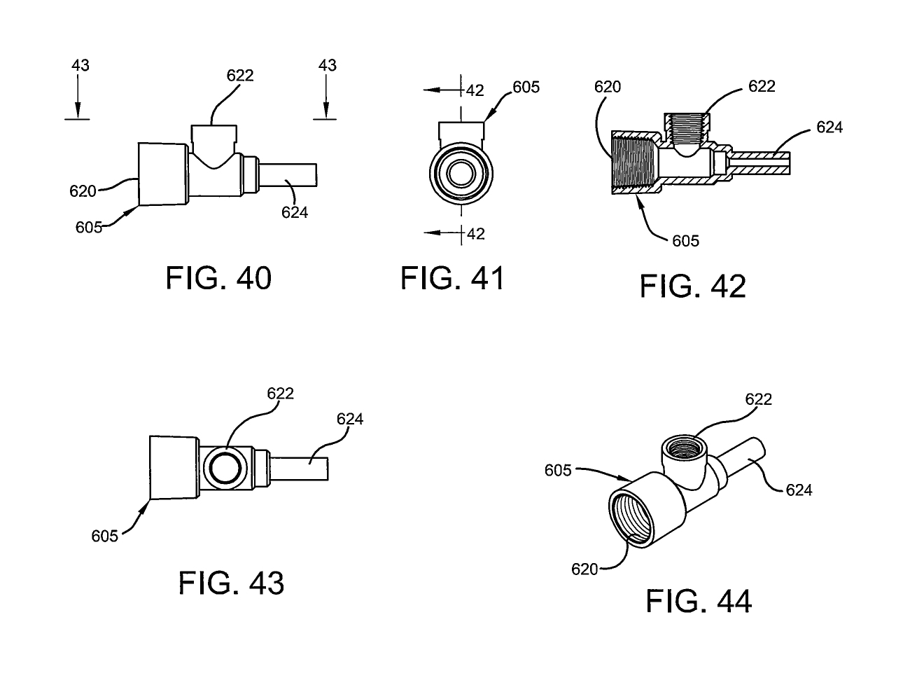

FIGS. 37 and 38 show another exemplary embodiment of a water softener system that can reduce the amount of water and salt needed to regenerate the resin bed. In this exemplary embodiment, the same reference numbers are used for elements that are similar in construction and function as that of the water softener 30 of the previous embodiment. Referring to FIGS. 37-39, this water softener 600 includes a venturi type injector assembly 602 to push the brine from the brine tank 34 to the control valve 604. The control valve 604 is similar to the control valve 36 except for that discussed below. The venturi injector assembly 602 is located in the brine tank 34. As seen in FIGS. 39-44, the injector assembly includes a nozzle body 605, an injector nozzle 606, a threaded opening or port 622, and a throat 610. As depicted in FIG. 39, the injector nozzle 606 is fluidly connected to an outlet end 612 of a drive water line 614. The port 622 is fluidly connected to one end of a J-shaped brine pick up tube 616. The throat 610 is fluidly connected to a brine line 618. As depicted in FIGS. 40-44, the nozzle body 605 includes threaded openings 620 and 622 for threaded connection with their respective drive water line 614 and brine pick up tube 616. The injector nozzle 606 is securely received in the nozzle body at the threaded opening 620. The nozzle body 605 is configured to receive different sizes of injector nozzles therein. The outlet opening 624 of the nozzle body 605 is received by a safety valve 626 (FIGS. 37-39) provided in the brine line 618.

As seen in FIGS. 37-38, the other end 627 of the pick up tube 616 is immersed into the brine such that bight portion 628 of the pick up tube 616 tube is at the lowest point of the brine tank 34. An air check arrangement 630 may be provided in the end 627 to indicate the brine level. The air check arrangement 630 may include a ball float provided in the pick up tube 616 that moves between the bight portion 628 and the end 627 based on the brine level of the brine tank 34.

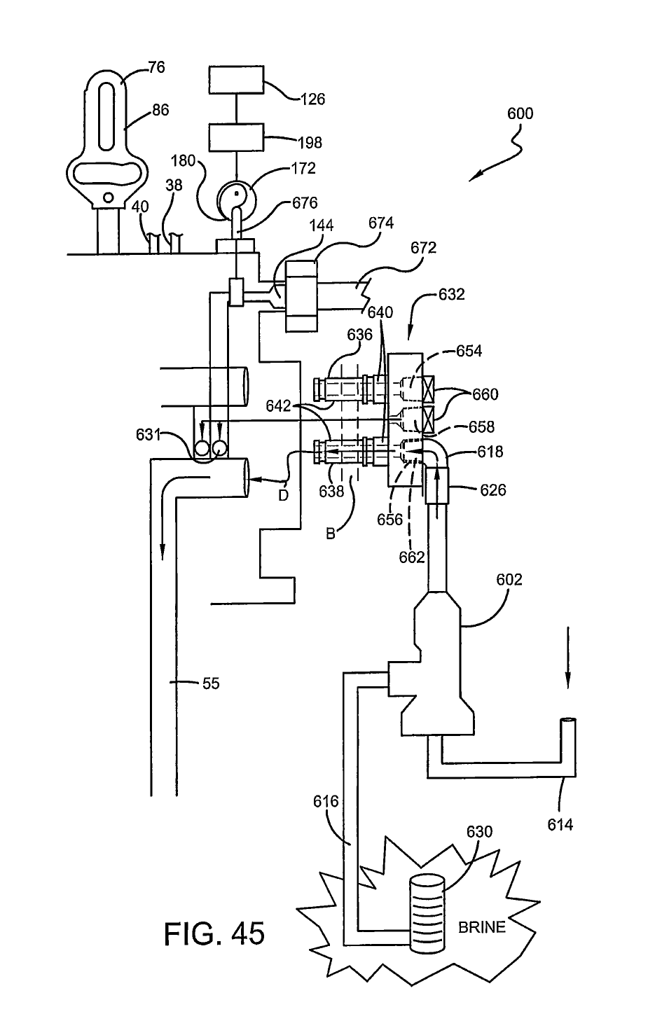

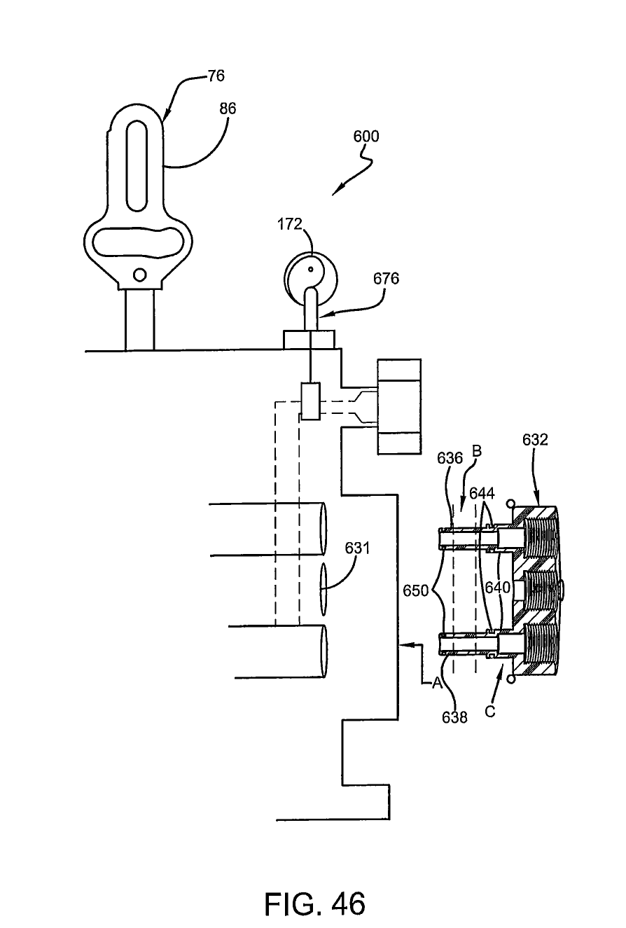

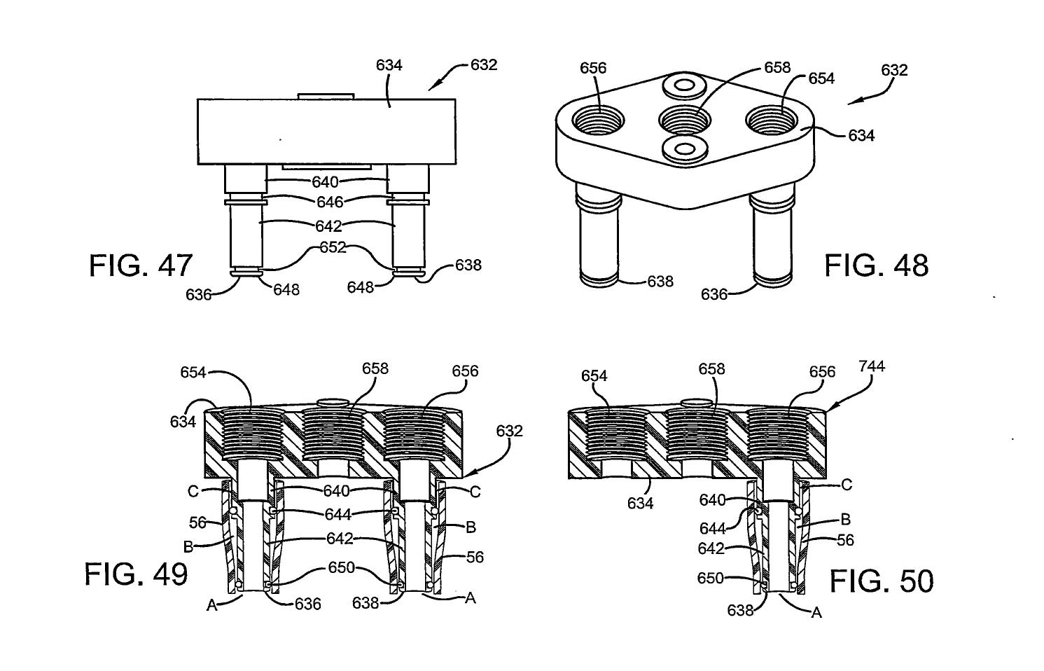

The inlet end of the drive water line 614 is fluidly connected to an outlet 631 (FIG. 45) of the control valve 604. The outlet 631 is in fluid communication with a fluid passage B defined by the valve body 56 and a body cover 632 (see FIGS. 45-47). In particular, the body cover 632 is mounted to the control valve 604 below the external port 144 as seen in FIGS. 45 and 46. Referring to FIGS. 47-49, the body cover 632 is made of plastic and molded in one piece. The body cover 632 includes a base 634 and two tubular finger like projections that define a first port 636 and a second port 638, respectively. Each projection is divided into first and second sections 640, 642. The first section 640 is located adjacent the base 634 of the body cover 632. The second section 642 is adjacent the first section 640. The second section 642 has an outer diameter that is less than the outer diameter of the first section 640.

Referring to FIG. 49, the outer surface of the first and second sections 640, 642 in combination with the valve body 56 define a first passageway C and a second fluid passageway B, respectively (also schematically indicated by the dash lines in FIG. 46). A first O-ring 644 is inserted into a circumferential groove 646 (FIG. 47) formed in the projection at the junction of the first and second sections 640, 642 to seal the first and second fluid passageways C, B from each other. A third fluid passageway or zone A is located adjacent a distal end 648 of the projection. A second O-ring 650 is inserted into a circumferential groove 652 formed in the distal end 648 to seal the second passageway B and third fluid passageway A from each other. The base 634 includes first, second, and third threaded openings 654, 656, 658. The first threaded opening 654 is in fluid communication with the first port 636. The second threaded opening 656 is in fluid communication with the second port 638.

The third threaded opening 658 may be plugged by a plug 660 (FIG. 45) to prevent fluid flowing therethrough or remain unplugged to allow fluid to flow therethrough depending on the application. The first port 636 may be plugged by a plug 660, threadily inserted into the first opening 654, to prevent flowing through the first port 636 or remained unplugged to allow fluid to flow through the first port 636 depending on the application. The second port 638 may be plugged by a plug 660, threadily inserted into the second opening 656, to prevent flowing through the second port 638 or remained unplugged to allow fluid to flow through the second port 638 depending on the application. In this embodiment, the third opening 658 and the first port 636 are each plugged by a plug 660, and the second port 638 is unplugged as seen in FIG. 45.

As previously mentioned, the drive water line 614 is in fluid communication with fluid passageway B. The brine line 618 is fluidly connected at one end to the second opening 656 via a threaded fitting 662. The other end of the brine line 618 is fluidly connected to the throat 610 of the injector assembly 602 as previously mentioned. Referring to FIG. 39, the safety valve 626 provided in the brine line 618 closes when the fluid level in the brine tank 34 reaches a predetermined high level due to, for example, a failure of a control valve. The closing of the safety valve 626 prevents the flow of fluid in the brine tank 34 into the resin tank 32 and thus prevents a flooded room in a home where the water softener is located. In particular, the safety valve 626 includes a float 666 that is attached to a lever 668. The lever 668 is attached to a valve part 670. Movement of the lever 668 moves the valve part 670 between a valve open position and valve closed position. When the liquid level in the brine tank 34 increase to a predetermined level, the float 666 will move upward which in turn moves the lever 668 to move the valve part 670 to the valve closed position, which closes the safety valve 626.

Referring to FIG. 45, an untreated water line 672 is fluidly connected to injector 674. The injector 674 is located at the external port 144 of a water valve 676. The water valve 676 is provided in a bore 142 (FIG. 6) of the valve body 56 that fluidly communicates with the external port 144 connected to the water line 672. The water valve 676 is of similar construction and design as the brine valve 140 of the previous embodiments except that in this exemplary embodiment it is being used to control the flow of untreated water from the untreated water line 672 to the venturi injector assembly 602. This untreated water is used to drive the venturi injector assembly 602 to draw brine from the brine tank 34 into the resin tank 32. The water valve 676 is operated to move between the open and close positions to permit pulses of water to flow from the untreated water line 672 to the venturi injector assembly 602. In particular, initially the water valve 676 is in the closed position as shown in FIG. 38. When a determination is made by the controller 126 to regenerate the resin, the controller 126 is programmed to send a control signal to the motor 198 for the water valve 676 to cause the cam to rotate clockwise until the cam projection 180 engages and moves the valve stem 148 down to open the water valve 676 (FIG. 37) for a programmed predetermined time such as for two minutes or thirty seconds. The controller 126 may include a timer to start timing when the control signal is sent.

With the water valve 676 opened, the drive water can flow from the untreated water line 672 through the port 144 out of the outlet 631 and through the fluid passageway B to the drive water line 614. The drive water then flows into the nozzle 606 of the venturi injector assembly 602 and pulls or draws the brine through the nozzle 606 and mixes with the brine. The brine and drive water solution flows out of the throat 610 of the injector assembly 602 and through the brine line 618 and the second port 638. Then, as indicated by arrow D, the drive water and brine solution flow out of the second port and then through the distributor tube 55 to the bottom of the resin tank 32. After the controller 126 determines that the drive water and brine solution has flowed for the predetermined time, the controller 126 then sends a control signal to the motor 198 for the water valve to cause the cam 172 to rotate clockwise until the cam projection 180 is disengaged from the valve stem 148 to place the water valve 676 in the closed position for a predetermined time such as for two minutes or thirty seconds. With the water valve 676 in the closed position, drive water is prevented from flowing through the port 144 to the venturi injector assembly 602. Thus, no drive water and brine solution mix flows into the resin tank 32 for this predetermined time period. After the controller 126 determines that the predetermined time has lapsed, the controller 126 causes the water valve 676 to open to produce another pulse of drive water and brine solution and the valve open/close cycle repeats.

This process continues to produce subsequent pulses of drive water and brine solution until the air check in the brine tank 34 closes to indicate that there is no more brine. Alternatively, the process may stop after a predetermined time by the controller 126. The process may also stop when it is determined that the entire resin bed 48 just becomes charged with a predetermined amount of brine. This predetermined amount may be the amount of brine in the brine tank 34. The controller 126 may be programmed to cause valves to open for a predetermined amount of time during the filling phase to send a predetermined amount of treated water into the brine tank to mix with the salt to produce this predetermined amount of brine needed to just charge the resin bed 48. In essence, the predetermined amount of water sent to the brine tank 34 is the exact amount that will saturate the exact amount of brine needed to charge the resin bed 48.

Alternatively, a pump may be used instead of the injector assembly to draw the brine into the resin bed 48 at intermittent pulses. This exemplary embodiment is similar in structure and function as the exemplary embodiment shown in FIGS. 1-19 except for that discussed below. As previously mentioned, referring to FIG. 12, the brine tank 34 may include the pump 240 to pump out the brine or regenerate solution 52 (FIGS. 1-5 and 20-29) from the brine tank 34 to the resin tank 32. Specifically, the pump 240 is inserted into a riser tube 242 that extends upwardly from the bottom 244 of the brine tank 34. The pump 240 is located near the bottom 244 of the brine tank 34 and may be submersed into the brine solution 52. The pump 240 may be of any suitable type such as a gear pump or centrifugal pump. The line 146 (shown in FIG. 1) may comprise a flexible tube 246 that extends from the outlet of the pump 240 through the riser tube 242 and to the brine port 144 of the control valve 36 to transport the brine from the brine tank 34 to the resin tank 32 and also transports treated water from the resin tank 32 to the brine tank 34. A lid 256 covers the top of the brine tank 34. The pump 240 is electrically coupled via a power cord 243 to a controller 248 mounted on a printed circuit board 250 for controlling the output of the pump 240. The controller 248 and circuit board 250 may be provided in a control valve 252 that is mounted to the sidewall 254 of the brine tank. The controller 248 may also monitor the pump current to control when the water is at the air level. This controller 248 may be operatively connected to the control module 124 (shown in FIG. 7). Alternatively, the controller 126 of the control module 124 may be used instead of the controller 248 to control and monitor the pump 240.

In this alternative embodiment, the controller operates the pump 240 to draw the brine into the resin bed 48 at intermittent pulses. In operation, in the regeneration phase, the controller 126 sends a control signal to open the brine valve 140 and a control signal to operate the pump 240 for a predetermined time. After the predetermined time lapses, the controller 126 sends a control signal to close the brine valve 140 and to turn off the pump 240. After pump 240 is off for a predetermined time, the controller sends a control signal to open the brine valve 140 and to turn on the pump 240 and this cycle repeats itself. This process continues to produce subsequent pulses of brine solution until there is no more brine in the brine tank 34. Alternatively, the process may stop after a predetermined time by the controller 126. The process may also stop when it is determined that the entire resin bed 48 just becomes charged with a predetermined amount of brine. This predetermined amount may be the amount of brine in the brine tank. The controller 126 may be programmed to cause the valves to open for a predetermined amount of time during the filling phase to send a predetermined amount of water into the brine tank to mix with the salt to produce this predetermined amount of brine needed to just charge the bed. In essence, the predetermined amount of water sent to the brine tank 34 is the exact amount that will saturate the exact amount of brine needed to charge the resin bed 48. The service position for normal operation, fill phase, rapid rinse phase, and backwash phase (optional), are similar to the exemplary embodiment shown in FIGS. 1-19.

The operation of the water softener will now be discussed. Referring to FIG. 38, the control valve 604 is in the service position in which the untreated water inlet orifice 274 is in fluid communication with the top opening 54 of the resin tank 32, and the distribution tube 55 of the resin tank 32 is in fluid communication with the treated water outlet orifice 276 (see FIG. 1). The water valve 676 is in the closed position blocking fluid from entering the brine tank 34. In this closed position, the upper end of the valve stem 148 is located adjacent the trailing end 182 (in the counterclockwise direction) of the cam projection 180 and is therefore not engaged by the cam projection 180. In this position, the push button 214 is not in the recess 184 and depressed by the body 186 of the base 174 of the cam 172 so that the microswitch 210 causes a signal to be sent to the controller 126 indicating that the water valve 676 is in the closed position. In the service position, the piston 84 is in a position to allow treated water to exit the outlet orifice 276. Thus, untreated water flows from the untreated water inlet orifice 274 through the resin tank 32 and then through the distribution tube 55 to the outlet orifice 276 of the valve body 56 and to the treated water line 40.

When the system determines that the ion exchange capacity of the resin bed 48 will be exhausted in a designated period, a regeneration cycle may commence. This decision may be based on the time since the last regeneration cycle and/or sensed usage and/or other factors. To begin a regeneration cycle, the motor 102 for the piston 84 causes the piston 84 to move to a fill position shown in FIG. 2. Also, the motor 198 for the water valve 676 causes the cam 172 to rotate clockwise until the cam projection 180 engages and moves the valve stem 148 down to open the valve 676 and allow fluid communication with the port 144 and the brine tank 34. The distribution tube 55 is now in fluid communication with both the treated water outlet orifice 276 and the fluid passageway B. In this position, untreated water flows through the port 144 and down into the resin tank 32 where it is treated and up through the distributor tube 55 out of the outlet 631 and through the fluid passageway B. The treated water flows through the drive water line 614. Since in the fill position the flow path through the brine line 618 and the second port 638 is closed off, the resin tank 32 is pressurized so there is no pressure to flow the treated water through the brine line 618. Thus, the treated water flows through the venturi injector assembly 602 and through the pick up tube 616 to fill the brine tank 34 with treated water to dissolve some of the particles such as salt in the brine tank 34, thereby forming regenerate solution 52. In this position too, the push button 214 is extended into the recess 184 so that the microswitch 210 causes a signal to be sent to the controller 126 indicating that the water valve 676 is in the open position.

When the fill phase is complete, the motor 102 for the piston 84 causes the piston 84 to move to the regenerate position shown in FIG. 4. Also, the motor 198 for the water valve 676 causes the cam 172 to rotate clockwise until the cam projection 180 engages and moves the valve stem 148 down to open the water valve 676 and allow fluid communication with the brine port 144 and brine tank 34. The water valve 676 is opened and closed to send concentrated pulses of drive water and brine through the brine line 618 and into the resin tank 32 as previously mentioned.

Referring to FIG. 37, during the regeneration stage, the concentrated pulses of brine and water solution enter into the resin tank 32 via the distribution tube 55 and start recharging the resin bed 48 at the bottom of the bed. This saturates or recharges (i.e. replacing objectionable ions such as calcium ions with less objectionable ions such as sodium ions) only a few beads or particles in the resin bed at a time to create an efficient ion exchange. Since the beads at the bottom of the resin bed 48 are first fully recharged, subsequent pulses of brine will then saturate the next area or section of the resin bed 48 upwardly adjacent the bottom section. For example, a first pulse may recharge the first or bottom section S1, and then a second pulse may recharge a second section S2 above the bottom section S1, and then a third pulse may recharge a third section S3 above the second section S2. A fourth pulse may recharge a fourth section S4 above the third section S3, and then a fifth pulse may recharge a fifth section S5 above the fourth section S4, and then a sixth pulse may recharge the top or final sixth section S6 above the fifth section S5.

Thus, a subsequent pulse of brine saturates the next section of the resin bed 48 upwardly adjacent the most recently recharged section. Subsequent sections of the resin are recharged and saturated by pluses in this progressive manner until the top section of the resin bed 48 is saturated and fully recharged so that the entire resin bed is fully recharged. The number of sections may vary depending on the pulse amount and resin bed configuration, resin tank, speed or flow rate of the brine flow, or other factors. During the process, the water in the resin tank 32 is displaced and pulsed to the drain port 60 and through the drain line 46 as each section of the resin bed is recharged. However, the brine does not mix with the water above the charged portion of the resin bed 48 during saturation of each section. Thus, that water still may be used for rinsing or flushing.

In essence, the intermittent pulses of brine injected into the bottom of the resin bed just displaces the water around the resin beads with brine. This action also lifts the bed of the resin and reclassifies the bed strata. This in turn expands the bed to open up exchange sites. However, since there is no constant velocity flow of brine, there is no chance of slippage when the bed fluidizes. The pause between pulses furthers the kinetic motion due to gravity, with the bed gently settling back to the bottom of the resin tank 32. Also, during the administration of the brine pulses, both the contact time and the kinetic motion are provided by the gentle raising and settling of the resin bed 48. No pre backwash cycle is needed to reclassify or recharge the resin bed because the up flow pulses perform that function.

After the resin bed 48 is fully recharged, the water valve 676 remains open. Since the brine in the brine tank 34 is empty, only the drive water flows from the brine line 618 into the resin tank 32 and is used to slowly rinse the resin bed 48.

After the regeneration and slow rinse phase of the cycle is complete, an optional back wash phase may be initiated. In this phase, untreated water flows down through the distribution tube and up through the resin bed 48 and out the drain port 60 to flush trapped particulate matter from the resin bed 48. The untreated water may enter from the inlet orifice 274 and flows both through the outlet orifice 276 to supply untreated water to the treated water line and also through the distribution tube 55. In this example, the water valve 676 would be closed. Alternatively, the water valve may be opened and the control valve may be configured to allow the untreated water from the port 144 to flow through the distribution tube and up through the resin bed and out the drain port.

After the regeneration and slow rinse phase or optional backwash is complete, the motor 102 causes the piston 84 to move to the rapid rinse position as seen in FIG. 5. Also, the motor 198 for the water valve 676 causes the cam 172 to rotate clockwise until the cam projection 180 is disengaged from the valve stem 148 to place the water valve 676 in the closed position to prevent fluid from flowing into the brine tank 34. In this position, the untreated water inlet orifice 274 is connected to the treated water outlet orifice 276 and the top opening 54 of the resin tank 32. The distribution tube 55 is connected to the drain port 60, thereby rinsing the resin tank 32 with untreated water to remove the regenerate solution 52 from the resin tank 32. The resin bed 48 is now fully regenerated and ready to resume water treatment. In this position too, the push button 214 is depressed so that the microswitch 210 causes a signal to be sent to the controller 126 indicating that the water valve 676 is in the closed position. The motor 102 for the piston 84 then causes the piston 84 to move back to the service position and the motor 198 for the water valve 676 causes the water valve 676 to be in the service position as shown in FIG. 1 to resume normal operation of the water softener. It has been shown that the water softener in this exemplary embodiment may reduce the amount of water needed to regenerate by 70% and may reduce the amount of salt needed to regenerate by 50%.

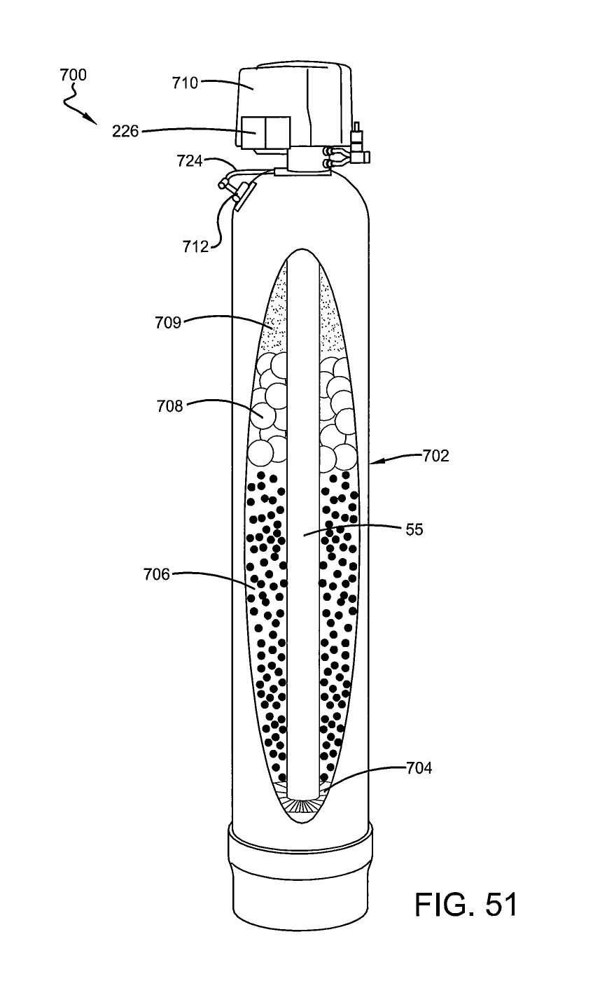

FIGS. 50-52 show an exemplary embodiment of a water treatment system 700 that uses oxidation and filtration in which contaminants are first oxidized so that they can be removed by filtration. In this exemplary embodiment, the same reference numbers are used for elements that are similar in construction and function as that of the water softener 30 of the previous embodiment. As seen in FIG. 51, the water treatment system 700 includes a generally enclosed tank 702. The interior of the tank 702 includes a flow distributor plate 704 that supports a filtration media 706 supported upon the distributor plate 704. The filtration media 706 may include any suitable media that can filter and remove contaminants such as iron, magnesium, or sulfur. Sorbing structures which are in the shape of balls 708 are provided in the tank on top of the filtration media 706. These mass transfer balls 708 provide aeration and attract iron and other contaminants in the water and enhance removal of the iron and contaminants from the untreated water. The oxidation zone in the tank 702 includes a pocket or head of air 709 located in an upper area of the tank above the balls 708. A control valve 710 is mounted to the top of the tank 702 and is similar in construction and function as the control valve 36 except for that discussed below.

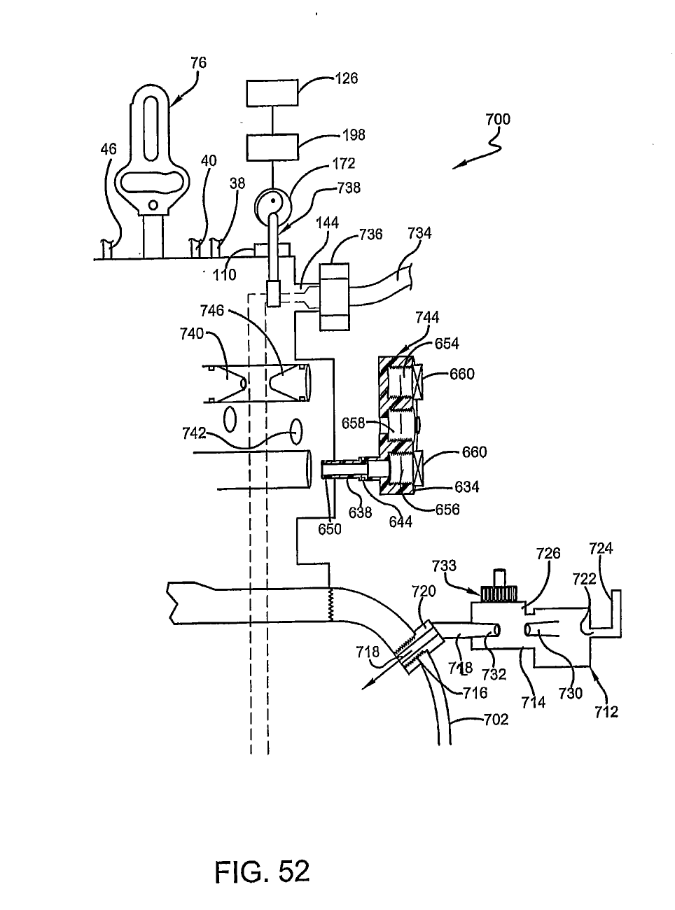

A venturi type air injector nozzle assembly 712 is provided to introduce air into the tank 702. As depicted in FIG. 52, the air injector assembly 712 includes an external body 714 and a threaded fitting 716. The threaded fitting 716 is threadily fastened into a threaded opening 718 near the top of the tank 702. An elastomeric seal 720 is fastened on the exterior surface of the tank 702 and seals any openings between the air injector assembly 712 and the tank 702. The body 714 is located outside of the tank 702 and is in fluid communication with the interior of the tank 702. The body 714 includes a nozzle port 722 for receiving a drive water line 724. The body 714 further includes an air port 726 through which air can enter into the body 714 and the tank 702. The body 714 includes an outlet port 728 that is fluidly connected to the fitting 716. A venturi nozzle 730 is provided in the nozzle port 722 and a throat portion 732 is provided in the outlet port 728. A check valve 733 is provided in the air port 726. The flow of water through the nozzle causes air to be drawn into the water through the air port from a source of air such as ambient air. In other arrangements the air source may include a source of compressed air or other oxygen containing gas.

A liquid chlorine line 734 for supplying liquid chlorine from a source is fluidly connected to an injector 736. Alternatively, the line 734 may supply other types of suitable sterilizing disinfectant liquids. These may include for example hydrogen peroxide, Oxyclean™ liquid, or other disinfectant sterilizing liquid. The injector 736 is located at the external port 144 of a sterilizer valve 738. The sterilizer valve 738 is provided in a bore 142 (FIG. 6) of the valve body 56 that fluidly communicates with the external port 144 connected to the liquid chlorine line. The sterilizer valve 738 is of similar construction and design as the brine valve 140 of the previous embodiments except that in this exemplary embodiment it is being used to control the flow of liquid chlorine from the liquid chlorine line 734 into the tank 702. This liquid chlorine is used to sterilize and disinfect the filtration media 706 and other substances in the interior of the tank 702.

The sterilizer valve 738 is operated to move between an open position to allow liquid chlorine from the line 734 to flow into the tank 702 and a closed position to block liquid chlorine flow from the line 734 into the tank 702. In particular, initially the sterilizer valve 738 is in the closed position as shown in FIG. 52. When a determination is made by the controller 126 to flow the liquid chlorine into the tank 702, the controller 126 is programmed to send a control signal to the motor 198 for the sterilizer valve 738 to cause the cam 172 to rotate clockwise until the cam projection 180 engages and moves the valve stem 148 (FIG. 4) down to open the sterilizer valve 738 for a programmed predetermined time. The controller 126 may include a timer to start timing when the control signal is sent. A venturi type nozzle injector 740 may be used to provide the motive force to draw the liquid chlorine into the tank 702. The venturi injector 740 is provided in the control valve 710 and is driven by the untreated water. The flow of water through the nozzle causes the liquid disinfectant to be drawn into the flowing water. One example, of such a venturi injector would be like that shown FIGS. 20-24.

With the sterilizer valve 738 opened, the liquid chlorine can flow from the liquid chlorine line 734 through the port 144 through the venturi injector 740 and down into the tank 702 for the predetermined time. After the controller 126 determines that the liquid chlorine has flowed for the predetermined time, the controller 126 then sends a control signal to the motor 198 for the sterilizer valve 738 to cause the cam 172 to rotate clockwise until the cam projection 180 is disengaged from the valve stem 148 to place the sterilizer valve 738 in the closed position.

An outlet 742 in fluid communication with the inlet orifice 274 to the untreated water line 38 is also in fluid communication with the third threaded opening 658 of a body cover 744. As seen in FIG. 50, the body cover 744 is similar in function and construction to that of the body cover 632 of FIGS. 47-49 except that the first port 636 is removed. Thus, the same reference numbers will be used on FIGS. 50 and 52 that correspond with the similar elements on FIGS. 45-49. In this embodiment, plugs 660 are threadily inserted into the first and second threaded openings 654, 656 to plug them up. The drive water flows out of the outlet 742 and then out of the third threaded opening 658 and into the drive water line 724. The drive water then flows through nozzle 730 of the air injector assembly 712 and the flow through the nozzle draws air through the air port 726 and throat 732 and they both flow into the tank 702.

In operation, a cycle begins with the control valve 710 in the service position in which the untreated water inlet orifice 274 is in fluid communication with the top opening 54 of the tank 702, and the distribution tube 55 of the tank 702 is in fluid communication with the treated water outlet orifice 276 (see FIG. 1). The sterilizer valve 738 is in the closed position blocking the liquid chlorine from entering the tank 702. In this closed position, the upper end of the valve stem 148 is located adjacent the trailing end 182 (in the counterclockwise direction) of the cam projection 180 and is therefore not engaged by the cam projection 180. In this position, the push button 214 is not in the recess 184 and depressed by the body 186 of the base 174 of the cam 172 so that the microswitch 210 causes a signal to be sent to the controller 126 indicating that the sterilizer valve 738 is in the closed position. In the service position, the piston 84 is in a position to allow treated water to exit the outlet orifice 276. Thus, untreated water flows from the untreated water inlet orifice 274 and into the tank 702. The untreated water passes through the pocket of air 709 and is oxidized as it travels through the head of air. The untreated water also travels through the aeration and sorbing balls 708, which enhance removal of the iron and other contaminants from the untreated water. The oxidized matter is subsequently filtered out of the filtration media 706. The water then passes through the filtration media 706 and flows up through the distribution tube 55 to the outlet orifice 276 of the valve body 56 and to the treated water line 40.

When a determination is made by the controller 126 to operate an air induction cycle due to, for example, most of the air being used for oxidation, first the piston 84 is moved by the motor 102 to a position so that the top opening 54 of the tank 702 is in fluid communication with the drain port 60. In this position, any residual air is removed from tank 702. The motor operates in a creeper mode to cause the piston 84 to move very slowly to slowly open the drain port 60 so that the air is released very slowly. After the air is removed, the piston 84 is moved to decompress the tank 702 to draw air. The piston 84 is also moved so that untreated water can flow to the venturi injector 740. The sterilizer valve 738 is placed in the open position. The piston 84 is also moved to a position in which the untreated water can flow through nozzle 746 of the venturi injector 740 to draw the liquid chlorine from the line 734 and through the venturi injector 740 and into the tank 702 to sterilize the elements in the interior of the tank 702. The sterilizer valve 738 is then moved to a closed position after a predetermined time.

The piston 84 then moves into a downflow rinse time period and then to a position where there is no flow into the tank for a predetermined time. This allows more contact time with the liquid chlorine for enhanced oxidation. Then, a backwash cycle is performed, the motor 102 for the piston 84 causes the piston 84 to move to the backwash position shown in FIG. 3. Also, the motor 198 for the sterilizer valve 738 causes the cam 172 to rotate clockwise until the cam projection 180 is disengaged from the valve stem 148 to place the sterilizer valve in the closed position to prevent fluid from flowing into the tank 702. In this position, the top opening 54 of the tank 702 is in fluid communication with the drain port 60, and the untreated water inlet orifice 274 is in fluid communication with both the treated water outlet orifice 276 and the distribution tube 55. Thus, untreated water entering from the inlet orifice 274 flows both through the outlet orifice 276 to supply untreated water to the treated water line 40, and also through the distribution tube 55. The untreated water flows down through the distribution tube 55 and up through the filtration media 706 and out the drain port 60 to backflush trapped particulate matter from the filtration media 706. It also flushes the air 709 out of the tank 702 through the drain port 60 and then drain line 46. In this position, the push button 214 (shown in FIG. 8) is not in the recess and is depressed by the cam so that the microswitch 210 causes a signal to be sent to the controller 126 indicating that the sterilizer valve 738 is in the closed position.

After the backwash phase of the cycle is complete, the motor 102 causes the piston 84 to move to the rapid rinse position (see FIG. 5). In this position, the untreated water inlet orifice 274 is connected to the treated water outlet orifice 276 and the top opening 54 of the tank 702. The distribution tube 55 is connected to the drain port 60, thereby rinsing the tank 702 with untreated water.

Then, an air induction cycle is performed. The motor 102 for the piston 84 then causes the piston 84 to move so that the tank 702 is decompressed and the drain port 60 and drain line 46 is opened. The piston 84 is moved such that untreated water from the inlet orifice 274 flows through the outlet 742 and opening 658 and into the drive water line 724. The check valve 733 is open to allow air to enter the air injector assembly 712. The drive water flows through the nozzle 730 to draw air through the air port 726 and the air and drive water combine to travel through the throat 732 and through the fitting 716 and opening 718 and into the tank 702. The untreated water also flows into the top opening of the tank 702 from the control valve 710. The water flows from the bottom of tank 702 up through the distribution tube 55 and out the drain port 60. As water flows out of the drain port 60, the tank 702 is being filled with air from the air injector assembly 712. This is continued until the water is substantially drained from the interior of the tank 702 and the volume of the tank not occupied by the filtration media 706 is filled with air. After this occurs, the check valve 733 automatically closes to prevent air from escaping from the tank 702. Then, the control valve 710 moves to the service position for normal filtration operation. Since the air is injected directly into the tank 702 and bypasses the control valve 710, fouling is reduced in the control valve.

When air is injected into the tank 702 to oxidize the iron / sulfur before the untreated water flows through the filter media 706, the air is oxidized resulting in ferrous oxide or iron oxide being produced in the upper area of the tank 702 above the filter media 706 in the lower area of the tank. Since the control valve 710 is mounted on the top of the tank 702 and extends into the upper chamber, the piston 84 and seals 96 associated with the piston 84 of the control valve 710 are exposed to the head of compressed air 709. These seals 96 are durable when wet, since they are designed to be exposed to water in the water softener systems 30, 300, 400, and 600 of the previous embodiments. However, when the seals 96 are exposed to the compressed air and iron during the operation mode of the water treatment system 700, the oxidation can cause the seals to dry out and harden causing premature wear and tear. Further, the iron particles from the iron oxide adhere to the seals 96 and the piston forming sludge and/or crust. Such low conditions can cause the seals 96 to be fused to the piston 84, resulting in the piston 84 sticking to the seals 96, which inhibits the piston's normal sliding movement through the seals. This condition also creates more load on the motor and drive gears to separate the piston 84 from the seals 96. The sticking and unsticking of the piston 84 to the seals 96 may also tear and/or remove pieces of the seals 96 and inhibit their sealing performance. Thus, these seals 96 may need to be changed often if the control valve 710 is mounted to the top of the tank 702 in a water treatment system 700 that uses oxidation and filtration to treat the water if the valve interior is generally exposed to air.

In addition, the compressed head of air 709 in the pocket in the upper area may cause air to back flow into the untreated water line 38 that supplies untreated water from the water source such as a well. This backflow of air can cause “coughing’ or “spitting” in the water lines. A check valve may be provided in the untreated water line 38 that supplies untreated water to the upper chamber of the tank 702 to prevent the back flow of air. However, the check valve will also be exposed to the compressed air and iron such that the iron particles adhere to the check valve and cause the check valve to develop sludge and/or crust up. This condition restricts the flow of water coming into the upper chamber of the tank 702 and also causes the check valve to fail to prevent the air from back flowing into the water lines.

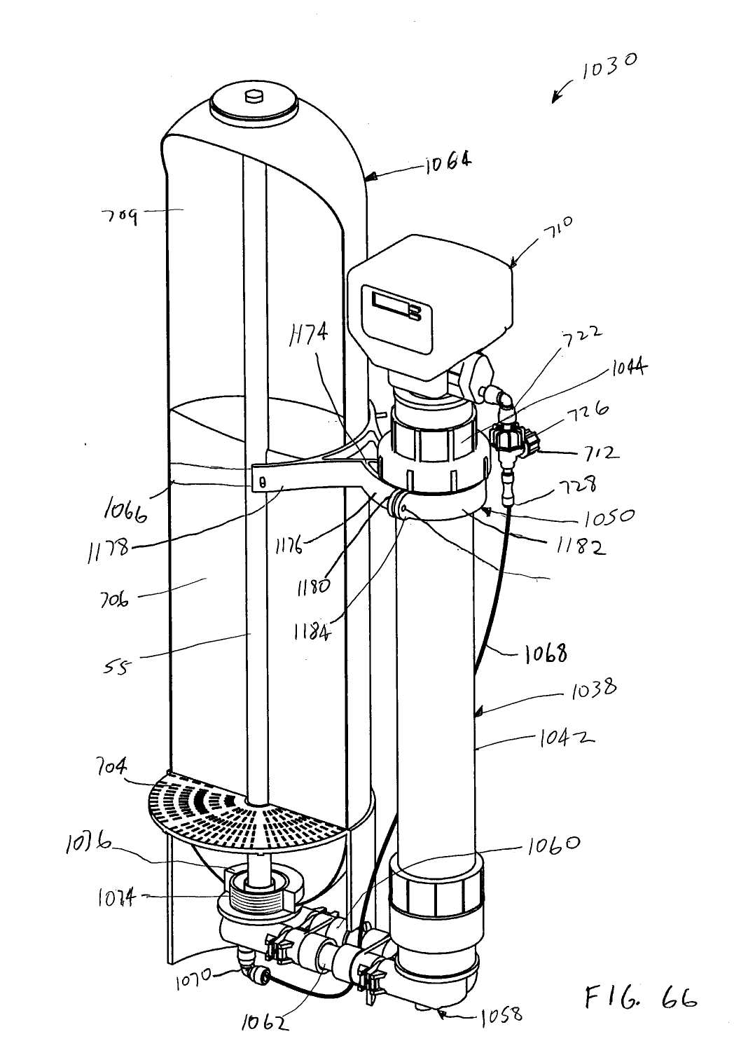

FIG. 66 shows an exemplary embodiment of a water treatment system 1030 that reduces these problems of premature failure of the seals 96 and check valve and the seals 96 being fused to the piston 84. The water treatment system 1030 is similar to the water treatment system 700 except for that discussed below. Thus, in this exemplary embodiment, the same reference numbers are generally used for elements that are similar in construction and function as that of the water treatment system 700 of the previous embodiment. As seen in FIG. 66, the water treatment system 1030 includes the control valve 710. The control valve is located away from the top of the tank 1064 and in a manner so that the seals 96 of the piston 84 generally remain wetted and in water and not simultaneously exposed for extended periods to the compressed air and iron. Exposure to air does not occur during the exemplary filtering operation. The tank 1064 is similar to the tank 702 of the previous embodiment except for that described below.

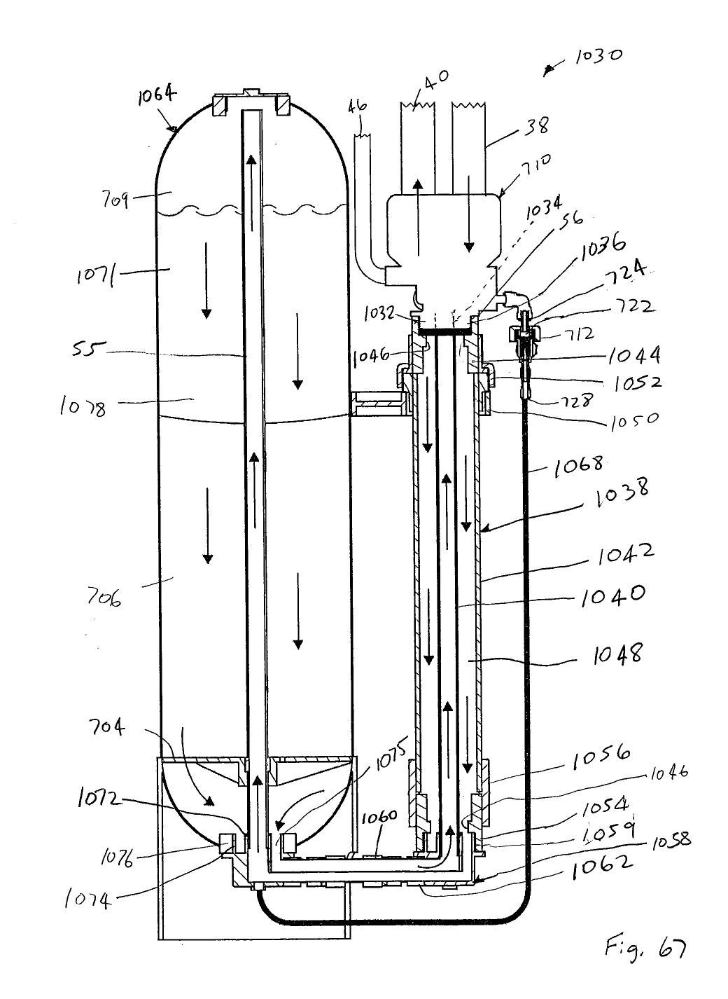

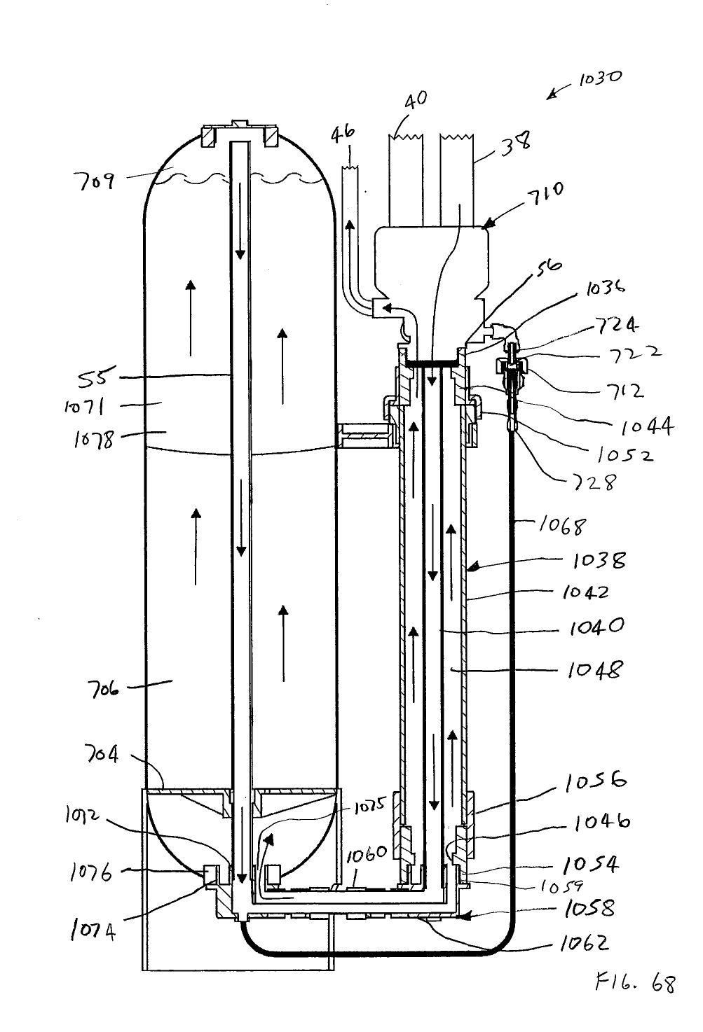

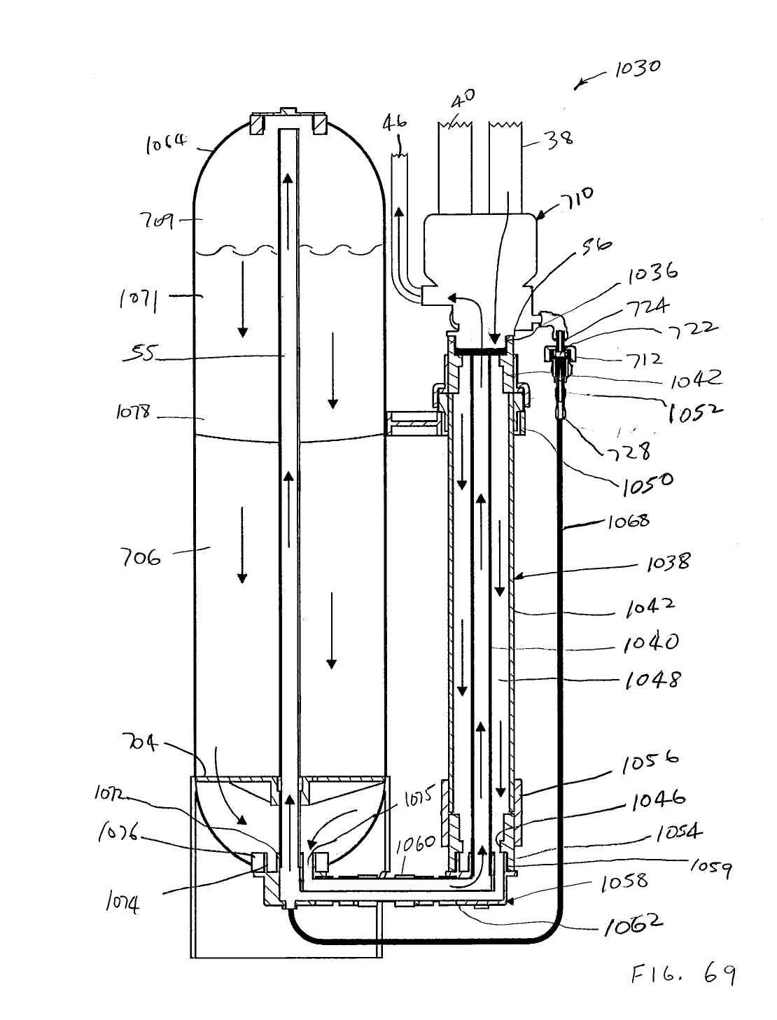

The control valve 710 includes the untreated water inlet orifice 274, the treated water outlet orifice 276, and drain port 60. The drain port 60 is operatively connected to the drain line 46. The untreated water inlet orifice 274 is operatively connected to the untreated water line 38. The treated water outlet orifice 276 is operatively connected to the treated water line 40. Referring to FIG. 67, the control valve 710 includes a valve body 56. The valve body 56 includes a plurality of passages and external ports in open communication with the exterior of the valve body. The valve body 56 includes internal orifices that open into the central cavity or bore 58 (FIG. 6) of the valve body 56. The central bore 58 is in fluid communication with a lower port 1032, which is formed in one piece with the valve body 56. The lower port 1032 includes an inner tube 1034 that is surrounded by a concentric outer tube 1036. The outer tube 1036 has a threaded external surface.

The water treatment system 1030 further comprises a riser assembly 1038. The riser assembly 1038 includes a central inner pipe 1040 that is surrounded by a concentric outer pipe 1042. The diameter of the inner tube 1034 and inner pipe 1040 are smaller than the diameter of their respective outer tube 1036 and outer pipe 1042. A threaded upper female coupling 1044 is rigidly secured to the upper end of the riser assembly 1038. The upper female coupling 1044 includes an integral step 1046 that extends inwardly from the inner surface of the upper female coupling 1044 and circumferentially around the interior of the upper female coupling 1044. The valve body 56 is mounted on and fluidly connected to the riser assembly 1038. In particular, the outer tube 1036 of the lower port 1043 threadily engages the upper female coupling 1044 such that the lower end of the outer tube 1036 securely seats on the step 1046. In this position, the inner tube 1034 is in fluid communication with the inner pipe 1040 and the outer tube 1036 is in fluid communication with the outer pipe 1042. The seal 59 is operatively connected to the inner pipe 1040 and the inner tube 1034 to seal them from the outer tube 1036 and outer pipe 1042, thereby preventing fluid flowing through the inner tube 1034 and inner pipe 1040 from escaping into the outer passageway 1048 defined by the inner pipe 1040 and inner tube 1034 and outer pipe and outer tube. The seal 57 is operatively connected to the outer pipe 1042 and the outer tube 1036 to seal them together, thereby preventing fluid flowing through the outer passageway 1048 from escaping.

A lower threaded female coupling 1054 is rigidly secured to the lower end of the riser assembly 1038 by a connector fitting 1056. The lower female coupling 1054 includes an integral step 1046 that extends inwardly from the inner surface of the lower female coupling 1054 and circumferentially around the interior of the lower female coupling 1054. A u-shaped pipe assembly 1058 is fluidly connected to the lower female coupling 1054. The pipe assembly 1058 has a first end 1059 that is threadably secured to the lower female coupling 1054 and abuts against the underside of the step 1046. The pipe assembly 1058 includes first and second conduits 1060, 1062. The inner pipe 1040 extends into the first conduit 1060 and is in fluid communication with the first conduit 1060. A seal may be provided to seal the first conduit 1060 and inner pipe 1040 to each other. The second conduit 1062 is in fluid communication with the outer passageway 1048. The second conduit 1062 is in fluid communication through a tube fluid port with the distribution tube 55 of the tank 1064. The distribution tube extends downward into an end 1072 of the second conduit 1062. The tube terminates in the upper area of the tank with a tube opening configured to be within an air pocket when the air pocket is present. The first conduit 1060 is in fluid communication with the bottom of the tank 1064. The piping assembly 1058 may include threaded pipe section 1074 that surrounds and is concentric with the tank end 1072 of the second conduit 1062. The threaded pipe section 1074 and the end 1072 are radially spaced from each other to define an outer passageway 1075 which serves as a lower tank fluid port. The threaded pipe section 1074 threadily engages a connector 1076 to support and seal the pipe section 1074 to the tank 1064.

The external ports of the control valve 710 are fluidly connected to the untreated water line 38, treated water line 40, drain line 46, air injector assembly 712, and inner and outer pipes 1040, 1042 of the riser assembly 1038. The drain port 60 provided at the valve body 56 is in fluid communication with the central bore 58 and drain lines 46. As shown in FIG. 6, the central bore 58 is configured to slidingly receive a piston assembly 76 and a seal assembly 78. The piston assembly 76 includes a piston rod 80, rod retainer 82 and piston 84. A retaining plate 86 is integrally formed in one piece with the piston rod 80. The seal assembly 78 includes a plurality of seals 96 that are fixed to the valve body 56 at locations that, upon their engagement with the piston 84, seal the orifices from other orifices. The piston 84 axially moves through the annular resilient seals 96 when the piston 84 is moved up or down to selected certain positions to place the various fluid passages and orifices of the valve in fluid connection.

As previously mentioned, the interior of the tank 1064 includes a distributor plate 704 that supports filtration media 706 placed upon the distributor plate 704. The distributor plate serves as a water diffuser for distribution of water flow when the tank and filter media are backflushed. The filtration media 706 may include any suitable media that can filter and remove contaminants such as iron, magnesium, or sulfur. Aeration or sorbing structures such as balls 708 (FIG. 51) may be provided in the tank on top of the filtration media 706. Theses mass transfer balls 708 attract iron and other contaminants in the water and enhance removal of the iron and contaminants from the untreated water. As depicted in FIGS. 67-70, water 1071 is provided between the filtration media and compressed air. The oxidation zone in the tank 702 includes the pocket of compressed air 709 located above the water and balls 708. The water 1071 prevents the compressed air from reaching the bottom of the tank 1064 and hence the second conduit 1062 of the pipe assembly 1058. The distribution tube 55 extends from the bottom of the tank 1064 to near the top of the tank 1064.

The exemplary riser assembly 1038 is operatively attached to the tank 1064 by a clamp 1050. The clamp may be a double C clamp as seen in FIG. 66. Specifically, the clamp 1050 includes a one piece base 1174 that has first and second c-shaped end portions 1176, 1178 that are oriented horizontally and face away from each other. The first c-shaped portion 1176 includes flanges 1180 integrally formed at the free ends of the first c-shaped end portion 1176. The first c-shaped portion 1176 surrounds and receives a portion of the riser assembly 1038. The clamp 1050 includes a c-shaped member 1182 with flanges 1184 integrally formed at the free ends of the c-shaped member 1182. The c-shaped member 1182 surrounds and receives the remaining portion of the riser assembly 1038. The c-shaped member 1182 is fastened to the first c-shaped portion 1176 to support the riser assembly 1038, control valve 710, female coupling 1054, pipe assembly 1058, and other related elements to the tank 1064. This is accomplished by aligning and abutting associated pairs of flanges against each other and fastening a screw, bolt or other fastening to them. An upper connector fitting 1052 is connected to the clamp 1050, riser assembly 1038, and upper female coupling 1044 to help further secure the upper female coupling 1044 to the riser assembly 1038.

The second c-portion 1178 of the clamp surrounds and receives a portion of the tank 1064. A rubber strap or seal 1066 (FIG. 66) may be attached to the opposite ends of the second c-portion 1178 of the clamp 1050 and fit around the remaining portion of the tank 1064 to secure the tank 1064 to the clamp 1050. The strap 1066 is strong and flexible and will expand or contract in response to the tank 1064 expanding or contracting. Thus, unlike a metallic band, the rubber strap 1066 is soft and flexible so as to not cause damage to the fibers of the tank 1064. The clamp 1050 may be formed of metal such as steel, plastic, or any other suitable material.

The venturi nozzle type air injector assembly 712 is provided to inject air into the tank 1064. As depicted in FIG. 52, the air injector assembly 712 includes the external body 714 and an outlet port 728. In this embodiment, the outlet port 728 is fluidly connected to a hose 1068, which is in turn fluidly connected to an elbow fitting 1070 as depicted in FIG. 66. The elbow fitting 1070 is fluidly connected to the end of the pipe assembly 1058 connected to the bottom of the tank 1064. The elbow fitting 1070 is in fluid communication with the second conduit 1062 and the interior area of the distribution tube 55. The body 714 is located outside of the tank 702 and is in fluid communication with the interior area 1078 of the tank 702. The body 714 includes the nozzle including the nozzle port 722 for receiving the drive water line 724. The nozzle port 722 is connected to an untreated water line port of the control valve. The body 714 further includes an air port 726 through which air can enter into the body 714 and eventually the tube and the tank 702. The body 714 includes an outlet port 728 that is fluidly connected to the fitting 716. With reference to FIG. 52, a venturi nozzle 730 is provided in the nozzle port 722 and a throat portion 732 is provided in the outlet port 728. A check valve 733 is provided in the air port 726.

Similar to the previous embodiment, the liquid chlorine line 734 for supplying disinfectant liquid such as chlorine from a source is fluidly connected to the injector 736 as seen in FIG. 52. Alternatively, the line 734 may supply other types of suitable sterilizing liquids. The injector 736 is located at the external port 144 of a sterilizer valve 738. The sterilizer valve 738 is provided in a bore 142 (FIG. 6) of the valve body 56 that fluidly communicates with the external port 144 connected to the liquid chlorine line. The sterilizer valve 738 is operated to move between an open position to allow liquid chlorine from the line 734 to flow into the tube and into the interior area of the tank 702 and a closed position to block liquid chlorine from the line 734 to flow into the tank 702.

As seen in FIGS. 66-70, the exemplary control valve 710 is positioned away from the top of the interior area 1078 of the tank 1064 which houses the compressed air during filtering operation. The entire piston 84 of the control valve is positioned so it is generally maintained wetted and exposed to liquid during operation, and is exposed to air only during the relatively short periods during an operating cycle in which air at the top of the tank is passed through the valve to exhaust the air from the tank. By maintaining the valve piston and seals in a wet condition at almost all times, oxidation of iron and other materials within the water is reduced within the valve. This reduces the formation of damaging sludge and crust which can cause valve failures.

In operation, an exemplary cycle begins with the control valve 710 in the service position as seen in FIG. 67 in which untreated water is filtered. In this condition, the untreated water inlet orifice 274 is in fluid communication with the outer passageway 1048 between the inner and outer tubes 1034, 1036, the outer passageway 1048 in the riser assembly 1038 between the inner and outer pipes 1040, 1042, the first conduit 1060, and the distribution tube 55. The bottom of the tank 702 is in fluid communication with the first conduit 1060, inner pipe 1040, inner tube 1034, and treated water outlet orifice 276 (see FIG. 1). The sterilizer valve 738 is in the closed position blocking the liquid chlorine from entering the tank 702. In this closed position, the upper end of the valve stem 148 is located adjacent the trailing end 182 (in the counterclockwise direction) of the cam projection 180 and is therefore not engaged by the cam projection 180. In this position, the push button 214 is not in the recess 184 and depressed by the body 186 of the base 174 of the cam 172 so that the microswitch 210 causes a signal to be sent to the controller 126 indicating that the sterilizer valve 738 is in the closed position. In the service position, the piston 84 is in a position to allow treated water to exit the outlet orifice 276. Thus, untreated water flows from the untreated water inlet orifice 274, through the outer passageway 1048, the second conduit 1062, and up through the tube opening of distribution tube 55. The untreated water passes outside the tube through the pocket of compressed air 709 at the top of the tank and contaminants in the water are oxidized as the water travels through the pocket of compressed air. The untreated water also travels downwardly through the sorbing balls 708, which enhance removal of the iron and other contaminants from the water. The oxidized matter is subsequently filtered out by the filtration media 706. The water then passes through the filtration media 706 and flows out through the lower tank fluid port at the bottom of the tank 1064. The filtered water than flows through the first conduit 1060, the inner pipe 1040, the inner tube 1034, and then through the outlet orifice 276 of the valve body 56 to the treated water line 40.

After filtration is ongoing for some time the oxygen in the compressed air is consumed through the chemical oxidation process. The determination to replenish the compressed air may be done through programmed operation of a controller such as controller 126. Such a determination may be made based on a programmed basis in response to certain factors or combinations of factors. For example, in some arrangements the controller may operate to make the determination on a timed basis based on elapsed time since the last time the air was replenished. In other arrangements, a flow meter may be used to measure the volume of treated water that has passed through the tank since the air was replenished, and replenish the air and filtration capabilities after a certain number of gallons.

In other arrangements sensors may be included in the air to measure the oxygen content. The sensing that the oxygen content has declined to a given level may be used as a threshold for the controller to operate to make a determination to cycle the system. In other arrangements the volume and/or pressure change in the air in the pocket at the top of the tank may be measured to detect reductions as oxygen in the air is consumed through oxidation. In still other arrangements sensors may be used to sense the level of oxidizable material in the water to determine a need to replenish the air. For example, sensing an increase in such material in the treated water leaving the tank will reflect a reduction in filter efficiency and a need to replenish the air. Alternatively or in addition, sensing the level of oxidizable contaminants in the incoming untreated water may be used to determine how long the system should be operated before the air should be replenished. Some controller embodiments may operate based on one or more such factors and other factors in making programmed determinations of a need to replenish the air at the top of the tank. Further in some exemplary embodiments controllers may consider factors such as water temperature, viscosity, hardness, surface tension and resistance to atomization in determining the concentration of oxygen needed to effectively treat the water. Of course these approaches are exemplary.

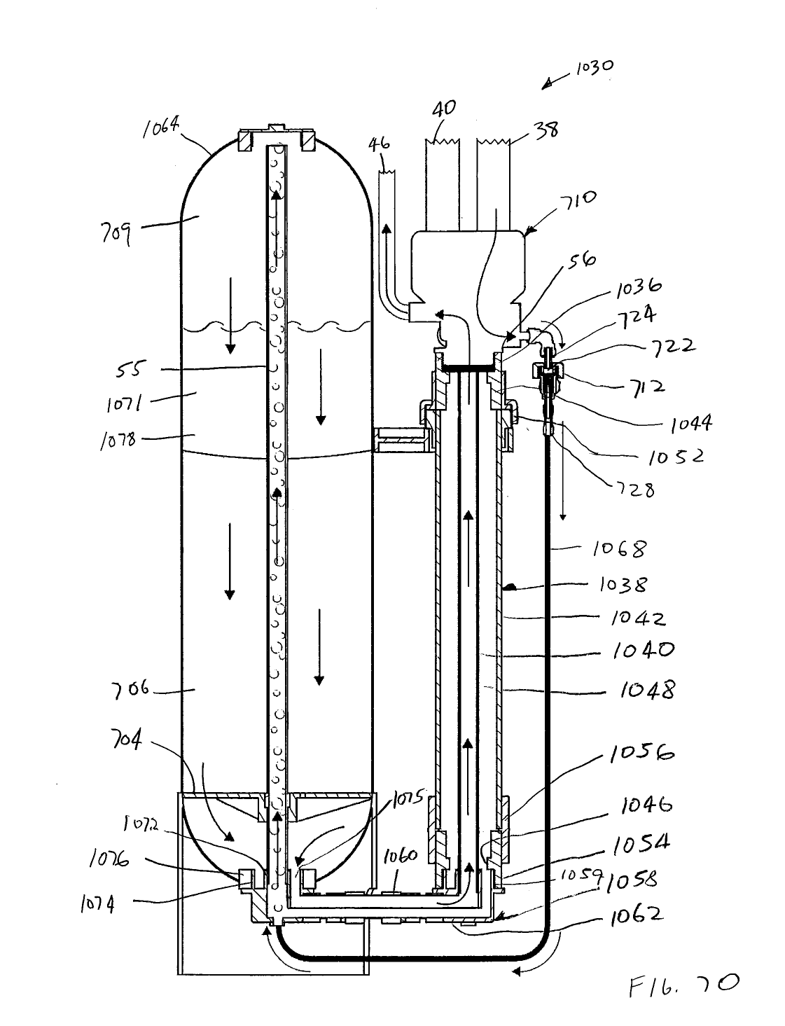

Upon a determination being made by the controller 126 to operate an air induction cycle, first the piston 84 is axially moved by the motor 102 to a position as represented in FIG. 68 so that the inner pipe and distribution tube are in fluid communication with the drain port 60. In this air release condition, any residual air is removed from the tank 1064. In the exemplary arrangement, the motor operates in a creeper mode to cause the piston 84 to move very slowly to slowly open the drain port 60 so that the air is released in a controlled manner. It is during this portion of the cycle that the internal valve components are exposed to air, and in this case the oxygen which could cause the formation of sludge and crust is largely depleted from the air that passes through the valve.

After the air is removed from the top of the tank, the piston 84 is moved to decompress the tank 1064 to draw air. The piston 84 is also axially moved so that untreated water from the water line 38 flows through the untreated water line port through the nozzle port 722. In this air introduction condition the drive water flows through the nozzle 730 to draw air through the air port 726 and throat 732 and they both flow through the tube 1068. Air is carried in the water upward through the distribution tube 55 and into the top of the tank 1064. The sterilizer valve 738 is also placed by the controller in an open position. The piston 84 is also axially moved to a position which corresponds to a disinfectant introduction condition where the untreated water can flow through nozzle 746 of the venturi injector 740 to draw from a source of liquid chlorine from the line 734 and through the venturi injector 740 from which the water and disinfectant move upwardly through the distribution tube 55 and into the tank 1064 to sterilize the elements in the interior area 1078 of the tank 1064. The sterilizer valve 738 is then moved to a closed position after a predetermined time or other programmed basis.

The piston 84 then moves into a down flow rinse configuration for a set time period and then to a position where there is no flow into the tank 1064 for a predetermined time. This allows more contact time with the liquid chlorine for enhanced oxidation. Then, a backwash cycle is performed. The motor 102 is controlled to cause the piston 84 to move to the backwash position represented in FIG. 68. In the backwash condition untreated water passes upward through the lower tank fluid port and the distributor plate to backwash the filter media. Also, the motor 198 for the sterilizer valve 738 causes the cam 172 to rotate clockwise until the cam projection 180 is disengaged from the valve stem 148 to place the sterilizer valve 738 in the closed position to prevent fluid from flowing into the tank 1064. As represented in FIG. 68, in this position, the distribution tube 55 is in fluid communication with the drain port 60. The untreated water inlet orifice 274 is in fluid communication with the inner tube 1034, the inner pipe 1040, the first conduit 1060, and outer passageway 1075. Thus, untreated water entering from the inlet orifice 274 flows through the inner tube 1034, the inner pipe 1040, the first conduit 1060, and outer passageway 1075 into the bottom of the tank 1064. The untreated water flows up the bottom of the tank through the lower tank fluid port and the filtration media 706 and then to the upper area of the tank. The water in the backwash flow enters the tube opening and flows down through the distribution tube 55 and out the drain port 60 to flush trapped particulate matter from the filtration media 706. It also flushes the air 709 that was introduced at the time of introducing the liquid chlorine out of the tank 702 through the drain port 60. In this position, the push button 214 (shown in FIG. 8) is not in the recess and is depressed by the cam so that the microswitch 210 causes a signal to be sent to the controller 126 indicating that the sterilizer valve 738 is in the closed position.

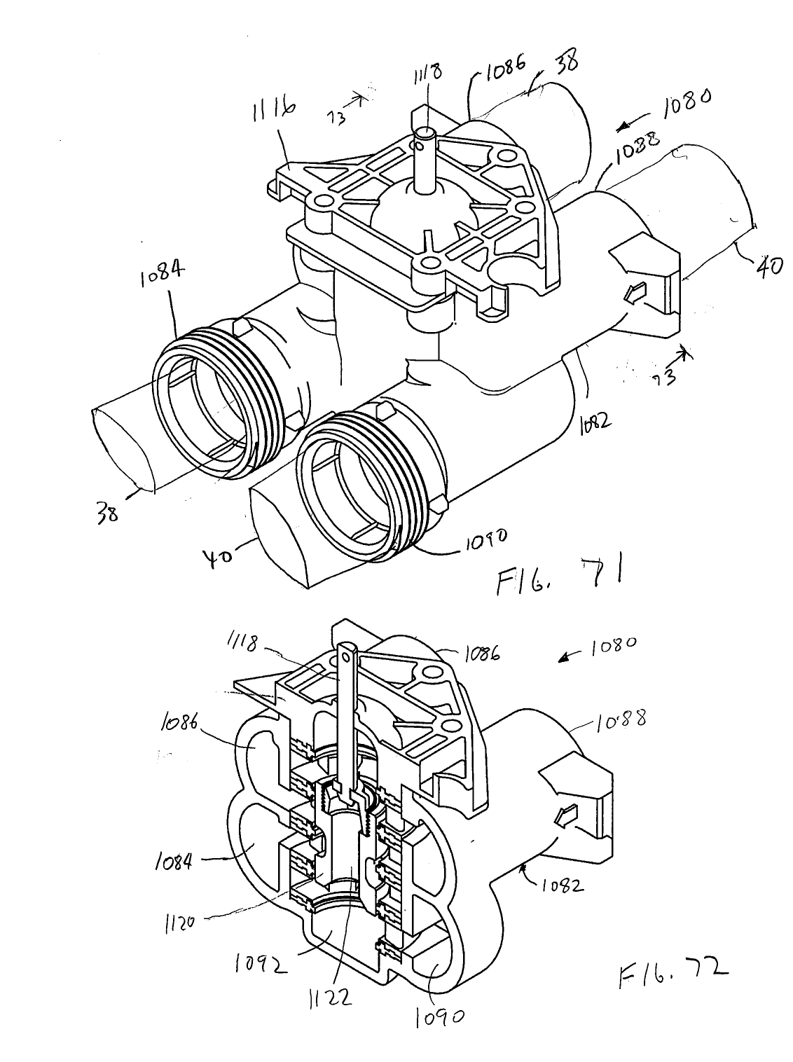

After the backwash phase of the cycle is complete, the motor 102 is controlled to cause the piston 84 to move to the rapid rinse position (see FIG. 69). In this position, the untreated water inlet orifice 274 is connected to the treated water outlet orifice 276. The untreated water inlet orifice 274 is also in fluid communication with the outer passageway 1048, second conduit 1062, and the distribution tube 55 of the tank 1064. Untreated water flows up and out of the opening of the distribution tube 55 and down inside tank 1064 through the filtration media 706, the outer passageway 1075, the first conduit 1060, the drain port 60 and to the drain line 46. This action rinses the tank 1064 and filtration media with untreated water.

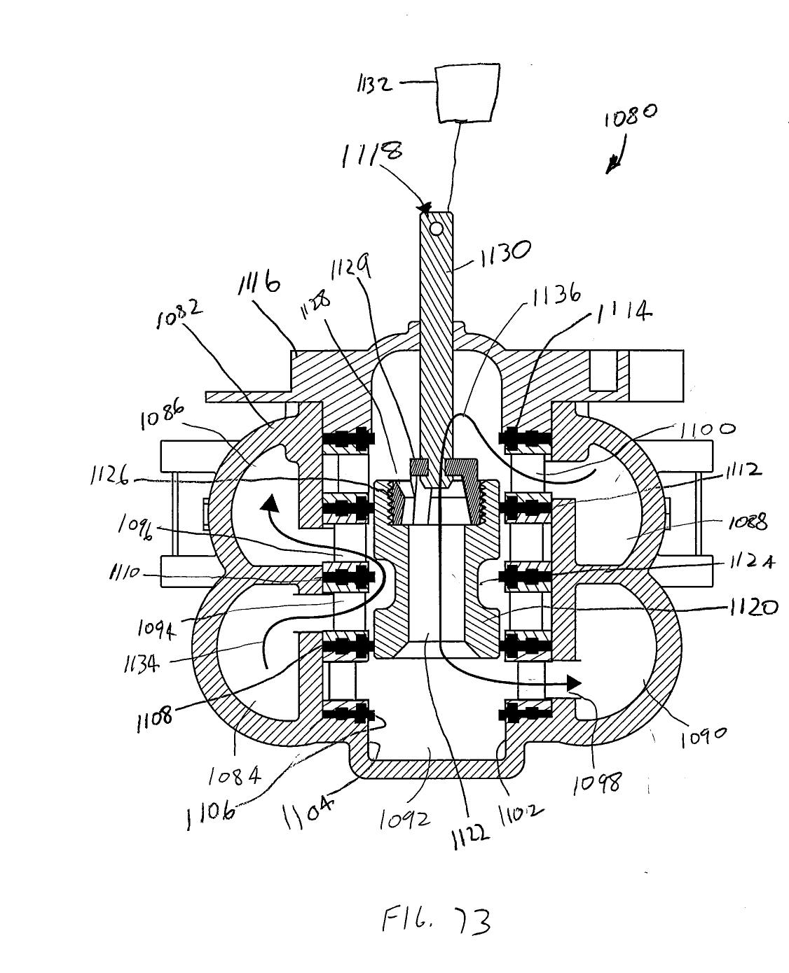

Then, an air introduction to form the air pocket in the tank is performed as represented in FIG. 70. The motor 102 is controlled to cause the piston 84 to move so that the tank 1064 is decompressed by having the drain port 60 and drain line 46 opened. The piston 84 is moved such that untreated water from the inlet orifice 274 flows through the outlet 742 and drain port or opening 658 (FIG. 52) and into the drive water line 724. The check valve 733 is open to allow air to enter the air injector assembly 712. Referring to FIGS. 52 and 66, the drive water flows through the nozzle 730 to draw ambient air through the air port 726. The air and drive water combine to travel through the throat 732 and through the tube 1068 and the second conduit 1062 and up through the distribution tube 55 into the top of the tank 1064. The air pocket accumulates at the top of the tank. The water flows down through the filtration media 706 to the bottom of tank 1064 and passes through the first conduit 1060, the inner pipe 1040, the inner tube 1034 and out the drain port 60. As water flows out of the drain port 60, the tank 1064 is being filled with air from the air injector assembly 712. This is continued until the water is substantially displaced from the interior area 1078 of the tank 1064 and the volume of tank 1064 not occupied by the filtration media 706 is filled with air. After this occurs, the check valve 733 automatically closes to prevent air from escaping from the tank 1064. Then, the control valve 710 is controlled responsive to the controller to move to the filter service position for normal filtration operation. In some alternative embodiments, the order of the configurations in the cycle can be changed if desired. For example, the air induction configuration could occur before the rinse cycle.

Since the incoming air is injected directly into the tank 1064 and bypasses the control valve 710, fouling due to the contaminants in the water being exposed to oxygen is reduced in the interior area of control valve 710. Also, since the components within control valve 710 such as the piston 84, seals 96, and other parts are almost always covered by water, the control valve 710 is less susceptible to wear because the ions entrained in the water do not oxidize in the interior of the valve. In the exemplary arrangement, water comes through the control valve 710 but gets oxidized in the tank 1064 and immediately is filtered and then flows back through the control valve 710. The control valve 710 is exposed to unoxidized iron or other ions in the untreated water or clean water. The interior of the control valve 710 is not exposed to the oxygen in air except during relatively short periods in the operating cycle when air is exhausted from the tank, and such air generally has the oxygen therein somewhat depleted. As shown in the embodiment, the control valve 710 is located outside of the tank 1064 and adjacent to the side of the tank 1064. This reduces the oxidation of contaminants that can occur within the valve and avoids damage to internal valve components.

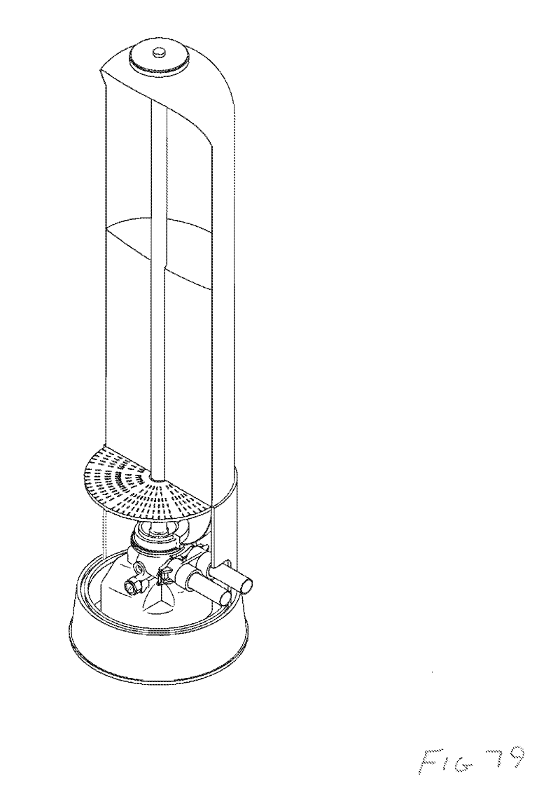

It should be noted that the control valve 710 may be located elsewhere relative to the air pocket at the top of the tank 1064 to limit exposure of internal components of the control valve 710 to oxygen. For example, FIG. 78 shows a control valve located away from the tank and connected thereto via flexible conduits. Flexible conduits can be used in lieu of the stand pipe arrangement of the exemplary embodiment previously described. FIG. 79 shows an alternative configuration where the control valve is located beneath the tank in a base structure. Locating the control valve within the base structure may be used to provide a more compact arrangement with the tank. Of course it should be understood that the arrangements shown are exemplary and in other embodiments other arrangements and configurations may be used.

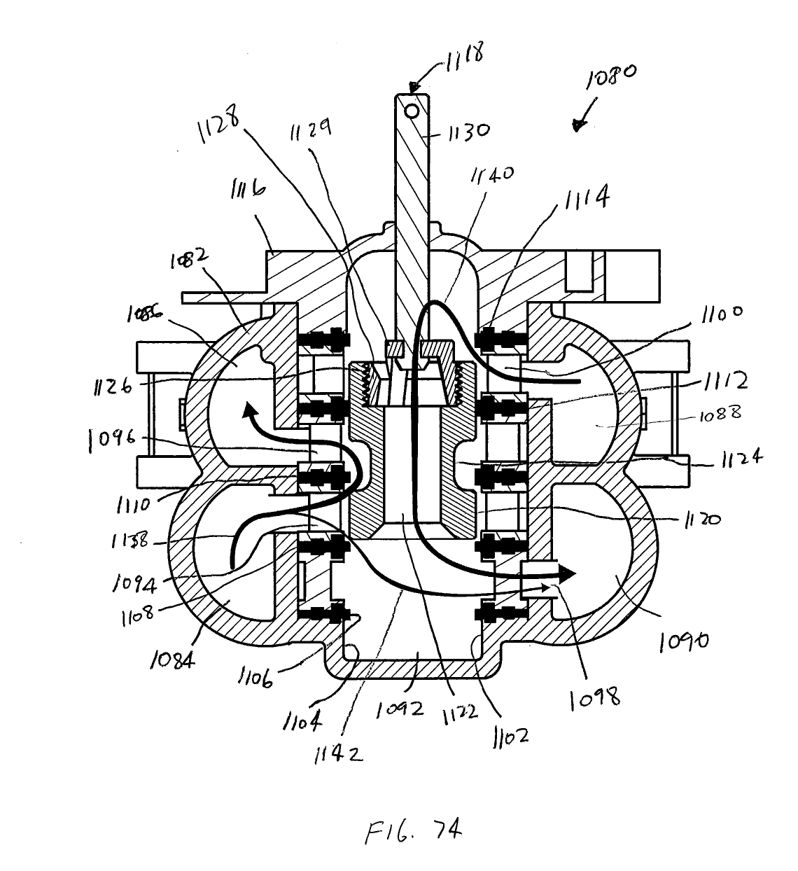

As previously mentioned, some water softener systems may include a bypass valve assembly 302 like that shown in FIGS. 15 and 16. The bypass valve assembly 302 includes the first and second valves 352, 354 that may include knobs or other manual actuation devices to permit the valve to be turned by hand between open and closed positions. Alternatively, motor(s) or solenoids may control operation of the first and second valves as well as the three way valve 320 and inflow valves of the manifold of the bypass valve assembly. In another exemplary embodiment, a water management valve assembly 1080 may be used as an alternative or in addition to the manual bypass valve assembly. In particular, as shown in FIGS. 71 and 72, the exemplary water management valve assembly 1080 includes a valve body 1082 that is generally made of plastic, metal or other suitable material. The valve body 1082 includes a threaded first inlet port 1084 and a first outlet port 1086 located on opposite sides of the valve body 1082. The valve body 1082 also includes a threaded second inlet port 1088 and a second outlet port 1090 located on opposite sides of the valve body 1082. The first inlet port 1084 is fluidly connected to the untreated water line 38 (schematically indicated in FIG. 71) at the upstream end of the untreated water line 38. The first outlet port 1086 is fluidly connected to the untreated water line 38 at the downstream end of the untreated water line 38. The second inlet port 1088 is fluidly connected to the treated water line 40 (schematically indicated in FIG. 71) at the upstream end of the treated water line 40. The second outlet port 1090 is fluidly connected to the treated water line 40 at the downstream end of the treated water line 40.

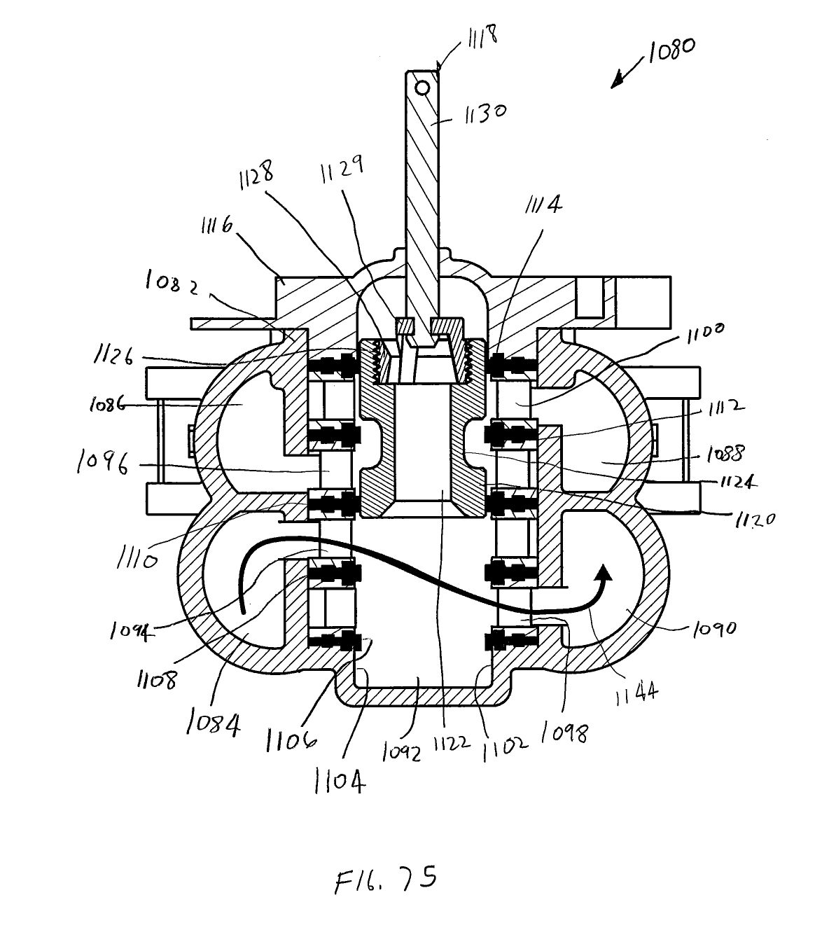

The water management valve assembly 1080 further includes a central bore 1092 (FIG. 72) that extends vertically through the center of the valve body 1082. Orifices 1094, 1096, 1098, and 1100 are formed in the side wall that defines the bore 1092. Referring to FIGS. 73-76, a first orifice 1094 is fluidly connected between the bore 1092 and the first inlet port 1084 thereby allowing fluid communication between them. A second orifice 1096 is located above the first orifice 1094 and is fluidly connected between the bore 1092 and the first outlet port 1086 thereby allowing fluid communication between them. A third orifice 1098 is fluidly connected between the bore 1092 and the second outlet port 1090 thereby allowing fluid communication between them. A fourth orifice 1100 is located above the third orifice 1098 and is fluidly connected between the bore 1092 and the first outlet port 1086 thereby allowing fluid communication between them.

Elastomeric seals are attached to the inner surface 1102 of the side wall 1104 of the valve body 1082 defining the bore 1092. The seals extend annularly around the side wall 1104 and are spaced axially from each other. In particular, a first seal 1106 is positioned at the bottom of the valve body 1082 as shown. A second seal 1108 is positioned above the first seal 1106 and located downwardly adjacent the first orifice 1094. A third seal 1110 is positioned above the second seal 1108 and located upwardly adjacent the first orifice 1094. A fourth seal 1112 is positioned above the third seal and located downwardly adjacent the fourth orifice 1100. A fifth seal 1114 is positioned in a spacer 1116 above the fourth seal 1112 and located upwardly adjacent the fourth orifice 1100.

The water management valve assembly 1080 also includes a piston assembly 1118. The piston assembly 1118 includes a hollow piston body 1120 and piston rod. The piston body has a central bore 1122 extending axially through the piston body 1120. An annular groove 1124 extends annularly around the piston body 1120. The piston body 1120 also includes a threaded circular female portion 1126 formed at its upper end. A threaded male member 1128 is attached by a clip portion 1129 of the male member 1128 or otherwise securely fastened to a piston rod 1130. The male member 1128 is threadily secured to the female portion 1126 of the piston body 1120. The piston rod 1130 may be operated by a drive 1132 such as a motor or solenoid to selectively move it axially upward and downward as shown in the bore 1092. For example, the arrangement may be similar to that of the piston assembly 76 shown in FIGS. 6 and 7. In this example, the piston assembly includes a retaining plate 86 integrally formed in one piece with the piston rod. The retaining plate 86 has a longitudinally extending upper slot 88 and a lower slot 90 that extends transverse to the upper slot 88. As shown in FIG. 7, a fastening device such as a screw 89 and washer 91 extends into the upper slot 88 and operatively mounts the retaining plate 86 to rear side 108 of a back plate 110. The lower slot 90 receives a projection 92 of a main gear 94.

The piston of assembly 1118 is controlled by an electric motor 102 (such as that shown in FIG. 7) or other suitable drive that reciprocates or moves the piston 1120 axially up and down through the bore of the valve body 56. The motor 102 may be a reversible DC motor or any type that has variable torque. Alternatively, the motor 102 may be an asynchronous AC motor or a stepper motor or other type of motor. The motor may be operated responsive to a remote device such as a controller or a remote computing device such as a cell phone. As seen in FIGS. 7 and 8, the motor 102 includes a casing 104 and a rotary output member such as a pinion 106. The pinion 106 includes teeth 112 (FIG. 8) that meshingly engage teeth 114 (FIG. 7) of the main gear 94. The exemplary motor 102 is controlled by a control module 124 that monitors the position and motion of the piston and controls the operation of the motor 102 based at least partially on the current position of the piston. Energization of the motor 102 rotates the pinion 106, which in turn rotates the main gear 94 to move the projection 92 up and down and along the lower slot 90. This action moves the retaining plate 86 or 486 and hence, piston rod axially up and down within the bore to place the piston at selected positions.

The selected positions of the piston body 1120 correspond to predetermined ratios of untreated water to treated water. For example, FIG. 73 shows the piston assembly 1118 in the service position. In this position, the piston body 1120 engages the second and fourth seals 1108, 1112. As represented by arrow 1134, the untreated water flows from the first inlet port 1084 through the first orifice 1094, the groove 1124, the second orifice 1096, and through the first outlet port 1086 where it eventually flows into the inlet port 318 or 618 of the control valve 36, 360, 436, or 536 to be treated. As represented by arrow 1136, the treated water flows from the outlet port 350 or 650 of the control valve 36, 360, 436, or 536 through the second inlet port 1088, the fourth orifice 1100, the area between the free ends of the clip 1129 of the male member 1128, and down through the bore 1122 of the piston body 1120. The treated water then flows through the third orifice 1098 and second outlet port 1090 of the water management valve assembly 1080 and through the treated water line 40. The untreated water is blocked from flowing through the first orifice 1094 and directly to the bore 1092, the third orifice 1098, the second outlet port 1090 and to the treated water line 40. This blockage is due to the piston body 1120 engaging the second seal 1108. Thus, in the service position there is no blending of water and untreated water.

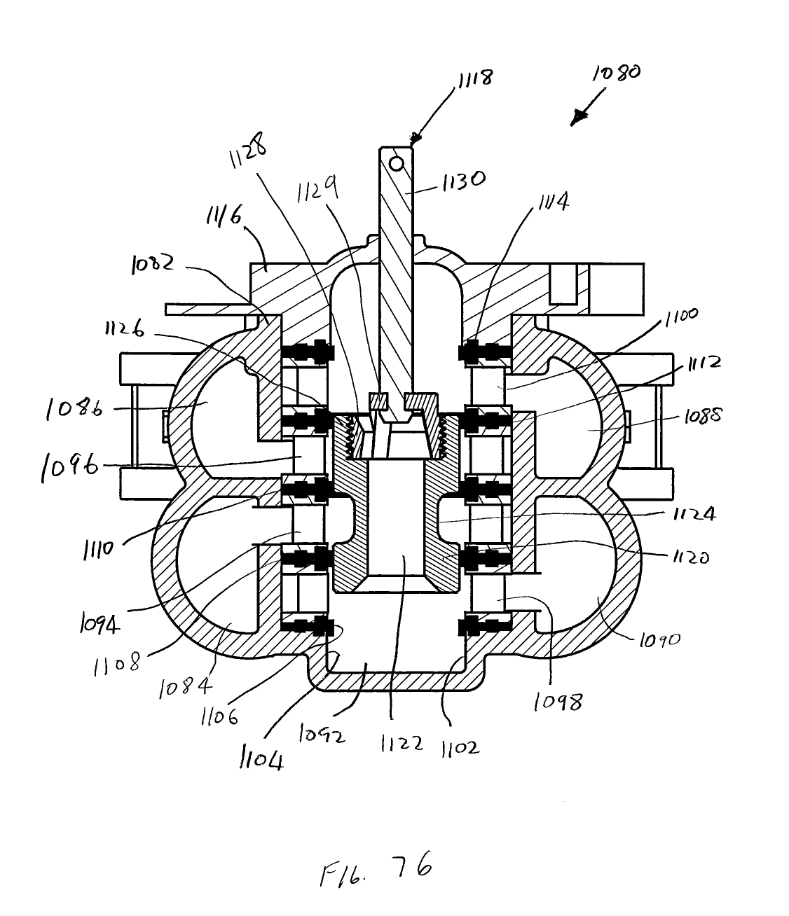

FIG. 74 shows the piston assembly 1118 in a hardness blend position. In this position, the piston body 1120 is moved axially upward as shown to allow small amounts of untreated water in the second outlet port 1090. In particular, the piston body 1120 engages the fourth seal 1112. As represented by arrow 1138, a first portion of the untreated water flows from the first inlet port 1084 through the first orifice 1094, the groove 1124, the second orifice 1096, and through the first outlet port 1086 where it eventually flows into the inlet port 318 or 618 of the control valve 36, 360, 436, or 536. The treated water flows from the outlet port 350 or 650 of the control valve 36, 360, 436, or 536 and into the second inlet port 1088. As represented by arrow 1140, the treated water flow through the fourth orifice 1100, the area between the free ends of the clip 1129 of the male member 1128, and down through the bore 1122 of the piston body 1120. The treated water then flows through the third orifice 1098 and the second outlet port 1090 of the water management valve assembly 1080. Due to the arrangement of the piston body 1120 to be spaced from the third seal 1110, a second portion of untreated water, as represented by arrow 1142, flows from the first inlet port 1084 through the first orifice 1094, central bore 1092 of the valve body 1082, third orifice 1098 and to the second outlet port 1090, where it is blended or combined with the treated water. The blended water flows through the treated water line 40. The piston body 1120 may be selectively moved axially upward away from the second seal 1108 or down towards the second seal 1108 to adjust the spacing between the second seal 1108 and piston body 1120, thereby adjusting the amount of untreated water flowing to the second outlet port 1090 and hence, the ratio of untreated water to the treated water line 40.

FIG. 75 shows the piston assembly 1118 in the bypass position. In this position, the piston body 1120 engages the third seal 1110 and fifth seal 1114. As represented by arrow 1144, all of the untreated water flows from the first inlet port 1084 through the first orifice 1094, central bore 1092 of the valve body 1082, third orifice 1098, the second outlet port 1090, and to the treated water line 40. The untreated water is blocked from flowing through the control valve 36, 360, 436, or 536 due to the third seal 1110 engaging the piston body 1120.

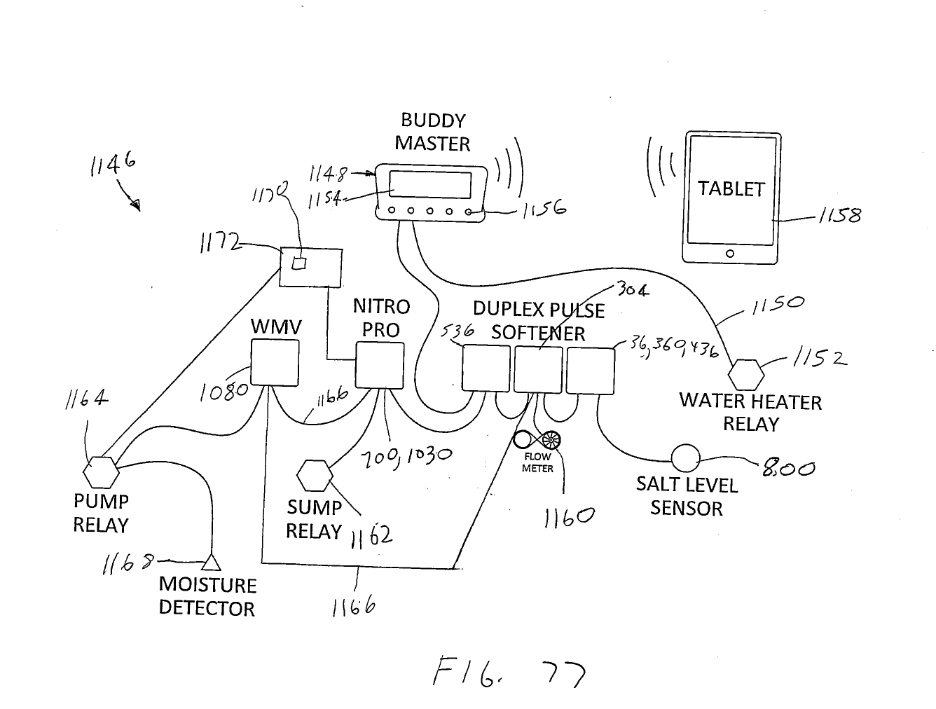

FIG. 76 shows the piston assembly 1118 in a shut off position. In this position, the piston body 1120 engages the third and fourth seals 1110, 1112 to block untreated water from the first inlet port 1084 from flowing into the inlet port 318 or 618 of the control valve 36, 360, 436, or 536. Only treated water from the control valve 36, 360, 436, or 536 can flow through the second inlet port 1088, fourth orifice 1100, central bore 1122 of the piston body 1120, third orifice 1098 and second outlet port 1090. Thus, in this position, the untreated water from the source of water such as a well is shut off to a facility, home or entity. Thus, the water management valve assembly 1080 allows the adjustment of the ratio of untreated water to treated water. For example, a user may desire that only untreated water or small amounts of treated water enter the second outlet to water the lawn. In another example, the user may want to totally shut off the water to a facility, home or building because it is going to be unoccupied or for other reasons.

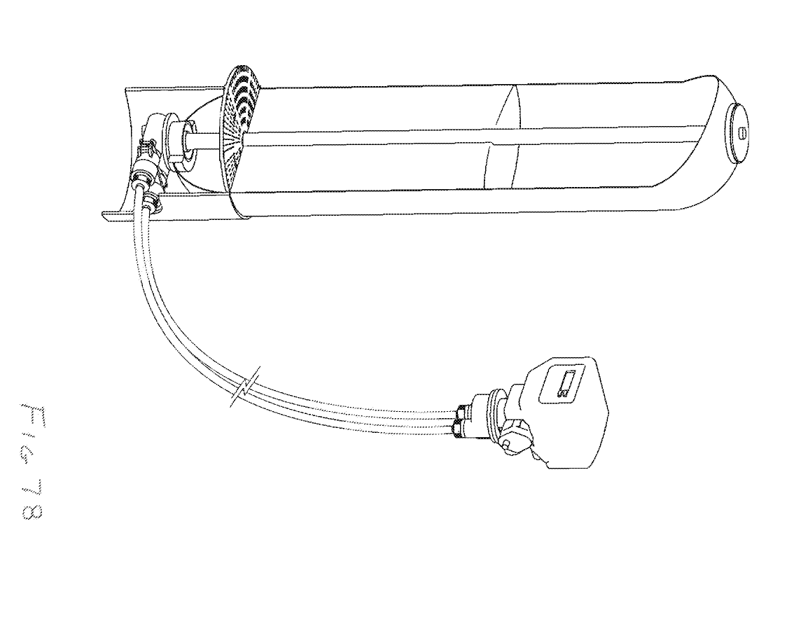

As previously mentioned, the motor can be controlled responsive to by a remote control device. The motor can also be energized by a switch or other drive on the control valve or water management valve assembly. FIG. 77 shows water management system 1146 according to another exemplary embodiment. In this embodiment, a master control module 1148 controls the functions of several devices. In this embodiment, the master control module 1148 is electrically wired via a bus 1150 to a water heater relay 1152 and dual water softeners. The dual water softeners may be similar to that shown in FIG. 15 that has the first control valve 36, 360, or 436 and the second control valve 536. Alternatively, one or both of the water softeners may be similar to water softener 600, which utilizes concentrated pulses of brine and water solution to regenerate the resin bed 48 in a respective resin tank 32. Alternatively, the master control module 1148 can be electrically coupled via hard wired or wirelessly to the water softener system 30, 300, 400, or 600 of the other embodiments that have a single control valve. Thus, in this exemplary embodiment, the same reference numbers are used for elements that are similar in construction and function as that of the control valves of the previous embodiments.

The master control module 1148 may include a display 1154 and function buttons 1156 to operate one or more of the previously described water softener devices. The master control module 1148 may include a mechanical indicator dial that can be used to set the time of certain operations carried out by the water softener(s). Alternatively, the control module 124 may include an electronic timer to set the times for certain operations of the water softener(s). An atomic clock signal receiver device (which sets the correct time via a received radio signal) 368 may be operatively connected to the timer for accurate timing and to allow adjustment of the time after a power loss or time change due to daylight savings. A remote device 1158 such as a cell phone, tablet, personal computer, Ipod®, Ipad®, laptop or other suitable device may communicate with the master control module 1148. The remote device 1158 may be used to control the functions of several devices. The remote control device 1158 may communicate with the master control module 1148 via wireless connection or alternatively, a wired connection. The master control module 1148 may include a transceiver or other suitable transmitter and receiver arrangement to receive signals from and/or transmit signals to the remote control device 1158. The remote control device 1158 may be remotely located at locations other than that of a water softener. These remote locations may be in more convenient places for operation by a user. For example, the remote control device 1158 may be located in a garage or bath room of a house. The remote control device 1158 may be wirelessly connected to the master control module 1148 through the internet via a WIFI connection or hard wired connected to the master control module 1148 through the internet. One or more routers and servers may be electrically coupled to the master control module 1148 and remote control device 1158 to help direct the control signals to the appropriate location.

The exemplary water management system may include the indicating arrangement 800 of the embodiment shown in FIGS. 53-65 to sense the level of salt in the brine tank 34. The indicating arrangement 800 may be electrically coupled to the water softener. A flow meter 1160 that measures the flow rate of water may also be electrically coupled to the water softener. The water treatment system 1146 may include the water treatment system 700 or 1030 that uses oxidation and filtration in which contaminants are first oxidized and/or sterilized so that they can then be removed by filtration. The outlet orifice 276 of the control valve of this water treatment system 700 or 1030 is fluidly connected via line 1166 to the first inlet port 1084 of the water management valve assembly 1080. The first outlet port 1086 of the water management valve assembly 1080 is fluidly connected via the line 1166 to the inlet 330 of the manifold 304. Alternatively, if one water softener is only used the first outlet port 1086 may be fluidly connected via line 1166 to the inlet orifice 274 of the control valve 36, 360, 436 of the water softener. The water treatment system 1146 may include a sump pump relay 1162 electrically coupled to the control valve of the water treatment system 700 or 1030. The water treatment system 1146 may also include a pump relay 1164 for a pump 1170 of a well 1172. The pump relay 1164 may be electrically coupled to the water management valve assembly 1080. The water treatment system 1146 may also include a moisture detector 1168 electrically coupled to the pump relay 1164.

The moisture detector 1168 detects water on a basement floor or other surface and sends a signal to the pump relay 1164 to shut off the well pump 1170 and sends a signal to the water management valve assembly 1080 to close the line 1166 so that untreated water does not flow into the water softeners. Upon detection of the water on the surface, the moisture detector 1168 would send a signal to the water heater relay 1152 via the master control module 1148 to turn off the hot water heater, so that the hot water heater does not burn up due to lack of water flowing into the hot water tank.

In operation, the pump 1170 operates to pump untreated water from the well 1172. This untreated water flows through the untreated water line 38 and into the inlet orifice 274 of the control valve of the water treatment system 700 or 1030. As represented in FIGS. 51 and 67, untreated water passes through the head of compressed air 709 and is oxidized as it travels through the head of compressed air. The untreated water also travels through the aeration and sorbing balls 708, which enhance removal of the iron and other contaminants from the untreated water. The oxidized matter is subsequently filtered out of the filtration media 706. The water then passes through the filtration media 706 and flows through the outlet orifice 276 of the valve body 56 to the water line 1166 (FIG. 77).

This oxidized water then goes through the first inlet port 1084 of the water management valve assembly 1080, which is fluidly connected to the line 1166, and out the second outlet port 1090. Referring to FIG. 15, the oxidized water then flows into the inlet 330 and then into the inlet port 318 of the first control valve 36, 360, 436. As previously mentioned, the water enters the resin tank 32 and passes through the resin bed 48. As the water passes through the resin, ions of calcium and other minerals in the water are exchanged with ions found in the resin, e.g., sodium, thereby removing objectionable ions from the water and exchanging them with less objectionable ions from the resin. When the three way valve 320 is in the first valve position, the treated water flows out the outlet orifice 276 of the first control valve and to the treated water line 40. The treated water also flows through the second inlet port 1088 and second outlet port 1090 of the water management valve assembly 1080.

The exemplary water management system 1146 may include one or more water storage tanks containing the water to pressurize the water to further allow the water to flow at the desired pressure. A user may operate the remote control device 1158 control the water treatment system 1146. The remote control device 1158 may be a cell phone that is wirelessly coupled to the master control module 1148. The master control module 1148 may receive signals from the moisture detector 1168, or flow meter 1160. The flow meter 1160 may send a signal to the master control module 1148 that represents the amount of water flowing through the control valves. The master control module 1148 may output this signal to the cell phone 1158, which may display the flow rate in text or graphical form on its display. A graphical interface may be displayed on the display of the cell phone to allow the user to control the functions of the elements of the water treatment system 1146 such as the water management valve assembly 1080, sump pump relay 1162, well pump relay 1164, or control valves.

For example, the user may see that the flow rate is very large even though no one is in the house associated with the water system. This may indicate that the toilet is leaking or that there is a break in one of the water pipes. The user may then touch an icon on the graphical interface or otherwise operate the cell phone 1158 to send a signal to the master control module 1148, which in turn sends a signal to the pump relay 1164 to shut down the well pump 1172 and also sends a signal to the water management valve assembly 1080 to place the piston assembly 1118 of the water management valve assembly 1080 in the shut off position to prevent water from entering the inlet 330 and flow into the control valves of the water softeners. Alternatively, the master control module 1148 may automatically send a signal to the pump relay 1164 to shut down the well pump 1170 and also send a signal to the water management valve assembly 1080 to place the piston assembly 1118 of the water management valve assembly 1080 in the shut off position to prevent water from entering the inlet 330 and flow into the control valves of the water softeners, in response to the flow meter detecting that the flow rate is above a predetermined level set by the user after he leaving the unoccupied house.

In response to the moisture detector 1168 detecting water on the basement floor, the moisture detector 1168 may send a signal to the master control module 1148 indicating the presence of water on the floor. The master control module 1148 may then send a signal to the cell phone 1158 to indicate visually on the display of the cell phone, audibly or other suitable indication on the cell phone of this condition. The user may then touch an icon on the interface or otherwise operate the cell phone 1158 to send a signal to the master control module 1148, which in turn sends a signal to the pump relay 1164 to shut down the well pump 1170 and also sends a signal to the water management valve assembly 1080 to place the piston assembly 1118 of the water management valve assembly 1080 in the shut off position to prevent water from entering the inlet 330 and flow into the control valves of the water softeners. Alternatively, the master control module 1148 may automatically send a signal to the pump relay 1164 to shut down the well pump 1170 and also send a signal to the water management valve assembly 1080 to place the piston assembly 1118 of the water management valve assembly 1080 in the shut off position to prevent water from entering the inlet 330 and flow into the control valves of the water softeners, in response to the moisture detector 1168 detecting water on the basement floor.

The sump pump relay 1162 may send a signal to the master control module 1148 that the power to run the sump pump is off. The master control module 1148 may then turn off a dehumidifier or any other machine which has water from that machine is draining into the well of the sump pump in response to this signal. The master control module 1148 may send a signal to the cell phone 1158 to notify the user of this condition. Alternatively, the master control module 1148 may just send a signal to cell phone 1158 and allow the user to touch an icon on the graphical interface or otherwise operate the cell phone 1158 to shut down the dehumidifier or other machine in which water from that machine is draining into the well of the sump pump.

The indicating arrangement 800 that senses the salt level in the brine tank 34 may send a signal to the master control module 1148 that the salt level needs to be replenished. For example, in response to receiving the reflecting light, the receiver 876 in the optical sensor 872 causes the RF transmitter 880 to output a signal to the master control module 1148 indicating that the salt in the brine tank 34 needs to be replenished. The master control module 1148 may then send a signal to the cell phone 1158 to indicate visually on the display of the cell phone 1158, audibly or other suitable indication to notify the user of this condition.

The user may operate the remote control device 1158 to operate the water management valve assembly 1080 to adjust the ratio of treat water to untreated water. For example, the user may touch an icon on the graphical interface of a cell phone 1158 that indicates the ratio of the flow of untreated water to treated water to be one to one. This action sends a signal to the master control module 1148 to operate the water management valve assembly 1080 to place the water management valve assembly 1080 in the position corresponding to that ratio. The three way valve 320 may be electrically coupled to the master control module 1148 and operated by the remote control device 1158 to place it in the first or second valve position in accordance with that previously mentioned.

It should be noted that alternatively, a solenoid valve could be used instead of the brine valve, water valve, or sterilizer valve. The solenoid valve would be powered by the controller 126. The controller 126 determines the open and closed position of the solenoid valve. The cam and microswitch would not be needed in this arrangement.

It is noted that several examples have been provided for purposes of explanation. These examples are not to be construed as limiting the hereto-appended claims. Additionally, it may be recognized that the examples provided herein may be modified or permutated while still falling under the scope of the claims.

Thus the exemplary embodiments achieve improved operation, eliminate difficulties encountered in the use of prior devices and systems, and attain the useful results described herein.

In the foregoing description, certain terms have been used for brevity, clarity and understanding. However, no unnecessary limitations are to be implied therefrom because such terms are used for descriptive purposes and are intended to be broadly construed. Moreover the descriptions and illustrations herein are by way of examples and the invention is not limited to the features shown and described.

Further in the following claims any feature described as a means for performing a function shall be construed as encompassing any means known to those skilled in the art as being capable of carrying out the recited function and shall not be deemed limited to the particular means shown or described for performing the recited function in the foregoing description or mere equivalents thereof.

It should be understood that language which refers to a list of items such as “at least one of A, B, or C” (example 1) means “at least one of A, B and/or C.” Likewise, it should be understood that language which refers to a list of items such as “at least one of A, B, and C” (example 2) means “at least one of A, B and/or C.” The list of items in example 2 is not required to include one of each item. The lists of items in both examples 1 and 2 can mean “only one item from the list or any combination of items in the list.” That is, the lists of items (in both examples 1 and 2) can mean only A, or only B, or only C, or any combination of A, B, and C (e.g., AB, AC, BC, or ABC).

The term “non-transitory” with regard to computer readable medium is intended to exclude only the subject matter of a transitory signal, per se, where the medium itself is transitory. The term “non-transitory” is not intended to exclude any other form of computer readable media, including but not limited to media comprising data that is only temporarily stored or stored in a transitory fashion. Should the law change to allow computer readable medium itself to be transitory signals, then this exclusion is no longer valid or binding.

Having described the features, discoveries and principles of the exemplary embodiments, the manner in which they are constructed and operated, and the advantages and useful results attained, the new and useful structures, devices, elements, arrangements, parts, combinations, systems, equipment, operations, methods, processes and relationships are set forth in the appended claims.

We claim:

1. Apparatus comprising:
a water treatment tank, wherein the tank includes
an enclosed interior area, wherein the interior area includes
an upper area, wherein the upper area is configured to house an air pocket,
a lower area, wherein filter media is positioned in the lower area,
a tube, wherein the tube extends vertically between the upper and lower areas, wherein the tube includes
a tube interior area,
a tube opening to the tube interior area, wherein the tube opening is in the upper area,
a lower tank fluid port, wherein the lower tank fluid port is in fluid connection with the interior area outside the tube and below a level of the filter media,
a tube fluid port, wherein the tube fluid port is fluidly connected to the tube interior area,
a fluid control valve, wherein the valve includes a body and a valve interior,
wherein the valve is configured when in a filter service condition to
receive into the valve interior untreated water including oxidizable contaminants,
cause untreated water to pass from the valve interior to the tube fluid port, wherein the untreated water is passed from the tube outlet through the air pocket to cause oxidation of contaminants, and through the filter media wherein the water is filtered,
receive filtered water into the valve interior that is passed from the lower tank fluid port, and
cause filtered water to be delivered from the valve,
wherein in the filter service condition the valve interior remains in a wetted condition.

2. The apparatus according to claim 1 and further comprising:
an air introduction line, wherein the air introduction line is in operative fluid connection with an air source and the tube fluid port,
wherein the air introduction line is configured to cause air from the air source to be delivered into the upper area through the tube opening.

3. The apparatus according to claim 2 and further comprising:
an air introduction nozzle, wherein the air introduction nozzle is in fluid connection with
the air introduction line,
the valve interior,
the air source, wherein the air source includes ambient air,
wherein the valve is operative to cause
untreated water to be passed from the valve interior and through the air introduction nozzle, and
air introduced into the untreated water through the air introduction nozzle to be passed into the upper area of the tank.

4. The apparatus according to claim 3 and further comprising:
a disinfectant introduction line, wherein the disinfectant introduction line is in operative connection with a disinfectant source, and the tube fluid port,
wherein the disinfectant introduction line is configured to cause disinfectant from the disinfectant source to be delivered into the upper area through the tube opening.

5. The apparatus according to claim 4 and further comprising:
a disinfectant introduction nozzle, wherein the disinfectant introduction nozzle is in fluid connection with
the disinfectant introduction line,
the valve interior,
the disinfectant source, wherein the disinfectant source includes liquid disinfectant,
wherein the valve is operative to cause
untreated water to be passed from the valve interior to the disinfectant introduction nozzle, and
disinfectant introduced into the untreated water through the disinfectant introduction nozzle to pass into the upper area of the tank.

6. The apparatus according to claim 5 and further comprising
sorbing structures located in the interior area of the tank, wherein the sorbing structures extend above the filter media, wherein the sorbing structures enhance oxidation of the oxidizable contaminants.

7. The apparatus according to claim 6 wherein the sorbing structures include sorbing balls.

8. The apparatus according to claim 6 and further comprising:
a distributor plate, wherein the distributor plate is in the lower area of the tank,
wherein the filter media is operatively supported on the distributor plate,
wherein the lower tank fluid port is below the distributor plate.

9. The apparatus according to claim 6
wherein the fluid control valve includes
a body, wherein the valve interior includes a generally cylindrical axially extending cavity extending in the body,
a generally cylindrical axially extending piston,
a plurality of axially spaced annular resilient seals configured to fluidly separate a plurality of fluid passages in the valve body,
wherein the piston is selectively axially movable in the cavity.

10. The apparatus according to claim 9
wherein the piston is axially positionable to cause the valve to be selectively in each of
the filter service condition,
an air release condition, wherein untreated water from the valve interior is passed into the lower tank fluid port and air and water from the upper portion is passed through the tube and the valve interior to a drain,
an air introduction condition, wherein untreated water is passed from the valve interior through the air introduction nozzle and the air introduction line,
a disinfectant introduction condition, wherein untreated water is passed from the valve interior through the disinfectant introduction line and disinfectant introduction nozzle to the upper area of the tank,
a backflush condition, wherein untreated water is passed from the valve interior through the lower tank fluid port, through the filter media and outwardly through the tube and the valve interior to the drain.

11. The apparatus according to claim 10 and further comprising:
a riser assembly, wherein the riser assembly is in operative supported connection with the tank,
wherein the riser assembly includes at least two generally vertically extending concentric fluid pipes, wherein at least one pipe is connected to the tube fluid port and wherein at least one pipe is fluidly connected to the lower tank fluid port,
and wherein the fluid control valve is mounted in supported connection with the riser assembly.

12. The apparatus according to claim 10 wherein the fluid control valve is mounted in operative supported connection with and vertically below the water treatment tank.

13. The apparatus according to claim 1 and further comprising:
a disinfectant introduction line, wherein the disinfectant introduction line is in operative connection with
the tube fluid port, and
a disinfectant introduction nozzle, wherein the disinfectant introduction nozzle is in fluid connection with the valve interior and a liquid disinfectant source,
wherein in a disinfectant introduction condition, the fluid control valve is operative to cause
untreated water to be passed from the valve interior to the disinfectant introduction nozzle,
disinfectant to be introduced into the untreated water, and
the disinfectant and the untreated water to pass into the upper area of the tank through the tube opening.

14. The apparatus according to claim 1 and further comprising
sorbing structures positioned in the interior area of the tank above the filter media.

15. The apparatus according to claim 1
wherein the fluid control valve includes
a body, wherein the valve interior includes a generally cylindrical axially extending cavity within the body,
a generally cylindrical axially extending piston,
a plurality of axially spaced annular resilient seals configured to separate a plurality of fluid passages in the valve body,
wherein the piston is selectively axially movable in the cavity.

16. Apparatus comprising:
a fluid control valve configured for use in connection with an enclosed filter tank, wherein the filter tank is operable to oxidize oxidizable contaminants in water and to filter such water,
wherein the filter tank includes an upper area that houses an air pocket, and a tube that extends in the tank and includes a tube opening in the upper area
wherein the filter tank includes a lower area, wherein the lower area houses filter media, and a lower tank fluid port in the lower area below the filter media,
wherein the fluid control valve includes
a body,
an axially extending cylindrical cavity within the body,
a cylindrical piston axially movable in the cavity,
a plurality of annular resilient seals in operative connection with the piston and the cavity,
a plurality of fluid passages in the body, wherein axial positioning of the piston is operative to cause such passages to be fluidly connected and fluidly separated within the valve,
wherein selectively positioning the piston is operative to cause
untreated water to be received into the valve through an untreated water port,
untreated water to be passed through at least one valve passage so as to be caused to be passed through the tube and into an air pocket in an upper area of the tank,
filtered water to be received from the lower tank fluid port and passed through at least one valve passage to a filtered water outlet port of the valve, wherein the plurality of seals remain wetted.

17. The apparatus according to claim 16
wherein selectively positioning the piston in the cavity is operative to cause
untreated water to be passed through at least one valve passage to an air introduction nozzle in operative connection with the tube, wherein air is accumulated in the air pocket in the upper area of the tank.

18. The apparatus according to claim 16
wherein selectively positioning the piston in the cavity is operative to cause
untreated water to be passed through at least one valve passage to a disinfectant introduction nozzle in operative connection with the tube,
wherein disinfectant is added to the upper area of the tank.

19. The apparatus according to claim 16
wherein selectively positioning the piston in the cavity is operative to cause
untreated water to be passed through at least one valve passage and to the lower tank fluid port, wherein the filter media is backflushed.

20. The apparatus according to claim 16
wherein selectively positioning the piston in the cavity is operative to cause
at least one valve passage to be in fluid connection with the tube outlet, wherein air from the upper area of the tank passes through at least one valve passage.
